(19) United States
(12) Patent Application Publication
(10) Pub. No.: US 2009/0227348 A1
(43) Pub. Date: Sep. 10, 2009

(54) Gaming Machine Permitting Player to Select Reels

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/391,000

(22) Filed: Feb. 23, 2009

Related U.S. Application Data
(60) Provisional application No. 61/034,374, filed on Mar. 6, 2008.
(60) Provisional application No. 61/034,386, filed on Mar. 6, 2008.
(60) Provisional application No. 61/034,399, filed on Mar. 6, 2008.

(51) Int. Cl. A63F 13/00

(52) U.S. Cl. 463/20

(57) ABSTRACT

Herein disclosed is a gaming machine, comprising: a memory for storing image data of a plurality of reels each having a plurality of symbols arranged thereon; a display for displaying the image data of a plurality of reels stored in the memory; an instruction input device for causing the outside to select one or more of the plurality of reels displayed by using the image data of the plurality of reels stored in the memory; and a controller for, by using the image data of the plurality of reels selected by the instruction input device, carrying out a slot game.

### CROSS REFERENCE TO RELATED APPLICATIONS

This application claims benefit of U.S. Provisional Application Nos. 61/034,374, 61/034,386 and 61/034,399 respectively filed Mar. 6, 2008, the entire contents of which are incorporated herein by reference.

### BACKGROUND OF THE INVENTION

1. Field of the Invention

The present invention relates to a gaming machine, and more specifically to a gaming machine which permits a player to select reels.

2. Related Art

Conventionally, in slot machines, a game is started when a player bets a certain amount of credits. Then, a plurality of reels on which a plurality of symbols are arranged start to rotate, and are stopped after a predetermined time elapses. As a result, a certain award is provided to the player based on a symbol combination which is displayed statically To improve monotonous displays, U.S. Pat. No. 6,517,433 discloses a slot machine in which a video display is disposed on an upper surface of rotatable reels, thus providing a video image with rendered effects including information regarding a game, which is superimposed on the reels to be associated with displays of the reels, and thereby producing effects that have new appeal in the game.

While the slot machine has improved visual representation by using a liquid crystal display or the like and controlling image data and the like by digital signals, the visual representation of such slot machines is lacking in surprises because the representation of image data using a liquid crystal display or the like has been very common in recent years.

In addition, regarding the reels in a slot machine, the symbols represented on the reels show no special originality and merely aligning regularly giving a similar impression for almost every gaming machine, thereby reducing the player's enjoyment. Furthermore, since alignment of a plurality of reels displayed on a display device and a alignment sequence depicted on a circumferential surface of each reel are fixed in advance, a player cannot reflect their own will thereon, and thus the player plays games with fixed reels and symbols, which may evoke a feeling of boredom.

The present invention has been developed in consideration of the above situation and an object thereof is to provide a gaming machine that can provide more surprises and greater enjoyment, and increase the interest in game playing while distinguishing itself from other models by reflecting the player s will on reels and symbols used in games with various rendered effects thereon.

### SUMMARY OF THE INVENTION

In accordance with one aspect of the present invention there is provided a gaming machine, comprising: a memory for storing image data of a plurality of reels each having a plurality of symbols arranged thereon; a display for displaying the image data of a plurality of reels stored in the memory; an instruction input device for causing the outside to select; one or more of the plurality of reels displayed by using the image data of the plurality of reels stored kin the memory; and a controller for, by using the image data of the plurality of reels selected by the instruction input device, carrying out a slot game.

In accordance with a first aspect of the present invention, there is provided a gaming machine, comprising: a memory for storing image data of a plurality of reels each having a plurality of symbols arranged thereon; a first display for displaying a first reel group by using part of the image data of the plurality of reels stored in the memory, said first reel group being selectable; a second display for displaying a second reel group used in a game by using part of the image data of the plurality of reels stored in the memory; an instruction input device for inputting an instruction from a player; and a controller for, by using the image data of the plurality of reels stored in the memory, carrying out the following processing of: (a) displaying the first reel group on the first display; (b) judging whether a reel replacement instruction has been inputted by the instruction input device; (c) replacing at least some reels of the first reel group displayed on the first display with other reels by using the image data of the plurality of reels stored in the memory if it is judged that the reel replacement instruction has been inputted by the instruction input device; (d) setting, in response to a setting instruction inputted through the instruction input device, as the second reel group, at least some reels of the first reel group displayed on the first display; and (e) displaying, as the second reel group, at least some reels of the first reel group displayed on the first display set in the processing (d), on the second display, and entering into a game.

According to the first aspect of the present invention, the gaming machine, carries out the processing of: (a) displaying the first reel group on the first display; (b) judging whether a reel replacement instruction has been inputted by the instruction input device; (c) replacing at least some reels of the first reel group displayed on the first display with other reels by using the image data of the plurality of reels stored in the memory if it is judged that the reel replacement instruction has been inputted by the instruction input device; (d) setting, in response to a setting instruction inputted through the instruction input device, as the second reel group, at least some reels of the first reel group displayed on the first display; and (e) displaying, as the second reel group, at least some reels of the first reel group displayed on the first display set in the processing (d), on the second display, and entering into a game, thereby enabling to provide more surprises and greater enjoyment, and increase the interest in game playing while distinguishing itself from other models by reflecting the player's will on reels and symbols used in games with various rendered effects thereon.

In accordance with a second aspect of the present invention, in a gaming machine, in addition to the feature of the first aspect, the controller carries out the processing of: displaying, in response to a symbol moving instruction inputted by the instruction input device, a plurality of symbols of corresponding reels of the first reel group rotating around a rotational axis of the first reel group on the first display.

According to the second aspect of the present invention, in a gaming machine, in addition to the feature of the first aspect, the controller carries out the processing of: displaying, in response to a symbol moving instruction inputted by the instruction input device, a plurality of symbols of corresponding reels of the first reel group rotating around a rotational axis of the first reel group on the first display. Therefore, since a player can select symbols displayed on the reel which the player uses in a game, the player's will can be reflected on the reels and symbols used in the game, which can increase the interest in game playing.

In accordance with a third aspect of the present invention, in the gaming machine, in addition to the feature of the first aspect, the controller carries out the processing of: moving, when the at least some reels are set and displayed as the second reel group on the second display n the processing (e), the at least some reels from a display area of the first display to a display area of the second display with rendered effects.

According to the third aspect of the present invention, in the gaming machine, in addition to the feature of the first aspect, the controller carries out the processing of: moving, when the at least some reels are set and displayed as the second reel group on the second display n the processing (e) the at least some reels from a display area of the first display to a display area of the second display with rendered effects, thereby enabling to provide more surprises and greater enjoyment.

In accordance with a fourth aspect of the present invention, in a gaming machine, :in addition to the feature of the first aspect, the instruction input device is a touch panel, provided as transparently covering the first display, for receiving an input by an pushing operation by the player, and receiving an instruction corresponding to a player's pushing location or a player's pushing direction.

According to the fourth aspect of the present invention, in addition to the feature of the first aspect, the instruction input device is a touch panel, provided as transparently covering the first display, for receiving an input by an pushing operation by the player, and receiving an instruction corresponding to a player's pushing location or a player's pushing direction, thereby enabling to easily reflect player's will on the reels and symbols used in the game as well as improving convenience for players.

In accordance with a fifth aspect of the present invention, a gaming machine, in addition to the feature of the first aspect, the part of the image data of the plurality of reels stored in the memory is generated by performing perspective transformation on the plurality of reels including the plurality of symbols with a plurality of points of view from virtual cameras set at respective predetermined points after texture mapping processing, and the controller carries out the processing of: displaying the first reel group in three dimensions with a point of view selectable from among the plurality of points of view by using part of the image data of the plurality of reels stored in the memory.

According to the fifth aspect of the present invention, the gaming machine, in addition to the feature of the first aspect, the part of the image data of the plurality of reels stored in the memory is generated by performing perspective transformation on the plurality of reels including the plurality of symbols with a plurality of points of view from virtual cameras set at respective predetermined points after texture mapping processing, and the controller carries out the processing of: displaying the first reel group in three dimensions with a point of view selectable from among the plurality of points of view by using part of the image data of the plurality of reels stored in the memory, which can add various rendered effects on the symbols displayed on the reels, thereby providing more surprises and greater enjoyment.

In accordance with a sixth aspect of the present invention, in a gaming machine, in addition to the feature of the first aspect, the controller carries out the processing of: displaying, while the at least some reels are set and displayed as the second reel group on the second display in the processing (e), visual effects specific to the second reel group thus set, on the first display. In accordance with a seventh aspect of the present invention, the first display may be disposed above the second display.

In accordance with an eighth aspect of the present invention, there is provided a gaming machine, comprising: a memory for storing image data of a plurality of reels each having a plurality of symbols arranged thereon, the part of the image data of the plurality of reels stored in the memory being generated by performing perspective transformation on the plurality of reels including the plurality of symbols with a plurality of points of view from virtual cameras set at respective predetermined points after texture mapping processing; a first display for displaying a first reel group by using part of the image data of the plurality of reels stored in the memory; a second display for displaying a second reel group used in a game by using part of the image data of the plurality of reels stored in the memory; an instruction input device for inputting an instruction from a player; and a controller for, by using the image data of the plurality of reels stored in the memory, carrying out the following processing of: (a) displaying the first reel group in three dimensions with a point of view selectable from among the plurality of points of view in accordance with an instruction inputted by the instruction input device; (b) judging whether a reel replacement instruction has been inputted by the instruction input device; (c) replacing at least some reels of the first reel group displayed on the first display with other reels by using the image data of the plurality of reels stored in the memory if it is judged that the reel replacement instruction has been inputted by the instruction input device; (d) setting, in response to a setting instruction inputted through the instruction input device, as the second reel group, at least some reels of the first reel group displayed on the first display; and (e) displaying, as the second reel group, at least some reels of the first reel group displayed on the first display set in the processing (d), on the second display, and entering into a game, thereby enabling to provide more surprises and greater enjoyment, and increase the interest in game playing while distinguishing itself from other models by reflecting the player's will on reels and symbols used in games with various rendered effects thereon.

In accordance with a ninth aspect of the present invention, there is provided a gaming machine, comprising: a memory for storing image data of a plurality of reels each having a plurality of symbols arranged thereon, the part of the image data of the plurality of reels stored in the memory being generated by performing perspective transformation on the plurality of reels including the plurality of symbols with a plurality of points of view from virtual cameras set at respective predetermined points after texture mapping processing, a first display for displaying a first reel group by using part of the image data of the plurality of reels stored in the memory; a second display for displaying a second reel group used in a game by using part of the image data of the plurality of reels stored in the memory; an instruction input device for inputting an instruction from a player; and a controller for, by using the image data of the plurality of reels stored in the memory, carrying out the following processing of: (a) displaying the first reel group in three dimensions with a point of view selectable from among the plurality of points of view in accordance with an instruction inputted by the instruction input device; (b) judging whether a reel replacement instruction has been inputted by the instruction input device; (c) replacing at least some reels of the first reel group displayed on the first display with other reels by using the image data of the plurality of reels stored in the memory if it is judged that the reel replacement instruction has been inputted by the instruction input device; (d) setting, in response to a setting instruction inputted through the instruction input device, as the second reel group, at least some reels of the first reel group displayed on the first display; and (e) displaying visual effects specific to the second reel group set in the processing (d), on the first display, while displaying the second reel group on the second display, thereby enabling to provide more surprises and greater enjoyment, and increase the interest in game playing while distinguishing itself from other models by reflecting the player's will on reels and symbols used in games with various rendered effects thereon.

In accordance with a tenth aspect of the present invention, there is provided a gaming machine comprising: a memory for storing image data of a plurality of reels each having a plurality of symbols arranged thereon; a main display for displaying a predetermined number of reels used in a game by using part of the image data of the plurality of reels stored in the memory; a sub display for displaying images; an instruction input device for inputting an instruction from a player; and a controller for executing the following processing by using the image data of the plurality of reels stored in the memory: (a) generating, in response to a game start signal inputted from the instruction input device, to produce images indicative of the rotation display of the predetermined number of reels and displaying the predetermined number of reels rotating on the main display based on the images thus produced; (b) automatically stopping the predetermined number of reels from rotating, and rearranging a plurality of kinds of symbols displayed on the predetermined number of reels on a display region of the main display; (c) judging whether a combination of symbols rearranged and displayed in an award winning area on the main display matches any one of specified combinations for providing an award; (d) displaying on the sub display at least symbols not displayed on the main display when the plurality of symbols of the plurality of reels are rearranged and partly displayed in a display region on the main display in the processing (b); (e) reading, in response to an input signal from the instruction input device, which instructs a change of the predetermined number of reels to be displayed on the display region of the main display, image data indicative of one or more reels each having a plurality of symbols different in symbol arrangements from any one of the predetermined number of reels currently displayed on the display region on the main display, and displaying the one or more reels in a display region of the sub display as a replaceable reel group based on the image data thus read; (f) replacing, in response to an input signal from the instruction input device, which instructs a change to the replaceable reel group displayed on the sub display, the predetermined number of reels in the display area on the main display with the replaceable reel group; and (g) starting, in response to a game start signal inputted from the instruction input device, a next game with a predetermined number of reels thus replaced by the replaceable reel group.

According to the aspect of the present invention, the gaming machine carries out the following processing by using the image data of the plurality of reels stored in the memory: (a) generating, in response to a game start signal inputted from the instruction input device, to produce images indicative of the rotation display of the predetermined number of reels and displaying the predetermined number of reels rotating on the main display based on the images thus produced; (b) automatically stopping the predetermined number of reels from rotating, and rearranging a plurality of kinds of symbols displayed on the predetermined number of reels on a display region of the main display; (c) judging whether a combination of symbols rearranged and displayed in an award winning area on the main display matches any one of specified combinations for providing an award; (d) displaying on the sub display at least symbols riot displayed on the main display when the plurality of symbols of the plurality of reels are rearranged and partly displayed in a display region on the main display in the processing (b); (e) reading, in response to an input signal from the instruction input device, which instructs a change of the predetermined number of reels to be displayed on the display region of the main display, image data indicative of one or more reels each having a plurality of symbols different in symbol arrangements from any one of the predetermined number of reels currently displayed on the display region on the main display, and displaying the one or more reels in a display region of the sub display as a replaceable reel group based on the image data thus read; (f) replacing, in response to an input signal from the instruction input device, which instructs a change to the replaceable reel group displayed on the sub display, the predetermined number of reels in the display area on the main display with the replaceable reel group; and (g) starting, in response to a game start signal inputted from the instruction input device, a next game with a predetermined number of reels thus replaced by the replaceable reel group, thereby making it possible for the player to arbitrarily select other reels even if the combination of symbols currently displayed in an award winning area is far from any one of specified combinations for providing an award. With this construction, since the player can select other reels even though the combination of symbols currently displayed in an award winning area is far from any one of specified combinations for providing an award, the gaming machine can increase interest in playing game. Further, the gaming machine can provide more surprises and greater enjoyment and increase the interest in game playing by making symbols displayed on reels visually recognizable easily for the player and by reflecting the player's will on reels and symbols used in games with various rendered effects thereon.

In accordance with an eleventh aspect of the present invention, there is provided a gaming machine comprising: a memory for storing image data of a plurality of reels each having a plurality of symbols arranged thereon; a first display for displaying a first reel group by using part of the image data of the plurality of reels stored in the memory, the first reel group being selectable; a second display for displaying a second reel group used in a game by using part of the image data of the plurality of reels stored in the memory; an instruction input device for inputting an instruction from a player; and a controller for executing the following processing by using the image data of the plurality of reels stored in the memory: (a) judging, in a basic game, whether a combination of symbols displayed on the second display corresponds to a predetermined combination representing a winning of the game; (b) starting a second game when it is judged that the combination of symbols displayed on the second display corresponds to the predetermined combination representing the winning of the game; (c) displaying on tie first display, in the second game, a predetermined number of reels including at least two kinds of reels, one of which is a reel displaying a predetermined number of one of two specific symbols consisting of a bonus symbol promising a high payout and a wild symbol serving a almighty symbol playing roles of other symbols and the other of which is a reel displaying a predetermined number of the bonus symbol and the wild symbol, so that one of the number and the kind or both of the number and the kind of the two specific symbols displayed on the respective reels are visible by using the image data of the plurality of reels stored in the memory; (d) judging whether a reel replacement instruction has been inputted through the instruction input device; (e) replacing at least some reels of the first reel group displayed on the first display with other reels by using the image data of the plurality of reels stored in the memory if it is judged that the reel replacement instruction has been inputted by the instruction input device; (f) setting, in response to a setting instruction inputted through the instruction input device, as the second reel group, at least some reels of the first reel group displayed on the first display; and (g) displaying, as the second reel group, at least some reels of the first reel group displayed on the first display set in the processing (f), on the second display, and entering into a game.

According to the eleventh aspect of the present invention, the gaming machine carries out the processing of: (a) judging, in a basic game, whether a combination of symbols displayed on the second display corresponds to a predetermined combination representing a winning of the game; (b) starting a second game when it is judged that the combination of symbols displayed on the second display corresponds to the predetermined combination representing the winning of the game; (c) displaying on the first display, in the second game, a predetermined number of reels including at least two kinds of reels, one of which is a reel displaying a predetermined number of one of two specific symbols consisting of a bonus symbol promising a high payout and a wild symbol serving a almighty symbol playing roles of other symbols and the other of which is a reel displaying a predetermined number of the bonus symbol and the wild symbol, so that one of the number and the kind or both of the number and the kind of the two specific symbols displayed on the respective reels are visible by using the image data of the plurality of reels stored in the memory; (d) judging whether a reel replacement instruction has been inputted through the instruction input device; (e) replacing at least some reels of the first reel group displayed on the first display with other reels by using the image data of the plurality of reels stored in the memory if it is judged that the reel replacement instruction has been inputted by the instruction input device; (f) setting, in response to a setting instruction inputted through the instruction input device, as the second reel group, at least some reels of the first reel group displayed on the first display; and (g) displaying, as the second reel group, at least some reels of the first reel group displayed on the first display set in the processing (f), on the second display, and entering into a game, thereby enabling to provide more surprises and greater enjoyment arid increase the interest in game playing while reflecting the player's will on reels and symbols used in games with various rendered effects thereon. Further, it can perform rendered effects for enhancing amusement ability in bonus games which pay out more coins and the like than a so-called normal game.

### BRIEF DESCRIPTION OF THE DRAWINGS

FIG. 1-A is a flowchart showing processing executed in the gaming machine according to an embodiment of the present invention;

FIG. 2-A is a perspective view showing an appearance of the gaming machine according to a first embodiment of the present invention;

FIG. 3-A is an enlarged view illustrating a display area of the gaming machine shown in FIG. 2-A;

FIG. 4-A is a block diagram of a controller of the gaming machine shown in FIG. 2-A;

FIG. 5-A is a block diagram of a display/input controller of the gaming machine shown in FIG. 2-A;

FIG. 6-A is a partial exploded view showing a part of a sub display of the gaming machine shown in FIG. 2-A;

FIG. 7-A is a diagram showing a method of 3-dimensionally displaying a selectable reel on the sub display of the gaming machine shown in FIG. 2-A;

FIG. 8A-A shows a display screen of the sub display of the gaming machine shown in FIG. 2-A, which is displayed 3-dimensionally from a point of view which is substantially 45 degrees diagonally backwards to the right from the display screen;

FIG. 8B-A shows a display screen of the sub display of the gaming machine shown in FIG. 2-A, which is displayed 3-dimensionally from a point of view which is substantially 45 degrees diagonally backwards to the left from the display screen;

FIG. 9-A shows symbol lines disposed on each video reel, which are displayed during a game on a main display of the gaming machine shown in FIG. 2-A;

FIG. 10-A shows a symbol arrangement table used by the gaming machine shown in FIG. 2-A;

FIG. 11A-A shows an example of a reel selection display screen that displays selectable reels displayed on the sub display of the gaming machine shown in FIG. 2-A;

FIG. 11B-A shows replaceable reels that can be displayed on the sub display of the gaming machine shown in FIG. 2-A;

FIG. 12-A is a flowchart showing main processing operation executed by a controller of the gaming machine shown in FIG. 2-A;

FIG. 13-A is a flowchart showing reel selection processing executed by the controller of the gaming machine shown in FIG. 2-A;

FIG. 14A-A is a diagram illustrating an image displayed during setting a reel on the sub display of the gaming machine shown in FIG. 2-A;

FIGS. 14B-A and 14C-A are diagrams illustrating an image displayed during setting a reel on the main display and on the sub display of the gaming machine shown in FIG. 2-A;

FIG. 14D-A is a diagram illustrating an image displayed during setting a reel on the main display of the gaming machine shown in FIG. 2-A;

FIG. 15-A is a diagram illustrating an image for a specific visual effect on a reel, which is set, displayed on the main display and the sub display of the gaming machine shown in FIG. 2-A;

FIG. 16-A shows an example of a reel selection display screen displaying selectable reels displayed on the sub display of the gaming machine of a second embodiment of the present invention;

FIG. 17-A is a flowchart showing reel selection processing executed by a controller of the gaming machine of the second embodiment of the present embodiment;

FIG. 18A-A shows a display screen displayed during setting a reel on a sub display of the gaming machine of the second embodiment of the present invention; and

FIG. 18B-A shows a display screen displayed during setting a reel on a main display and a sub display of the gaming machine of the second embodiment of the present invention.

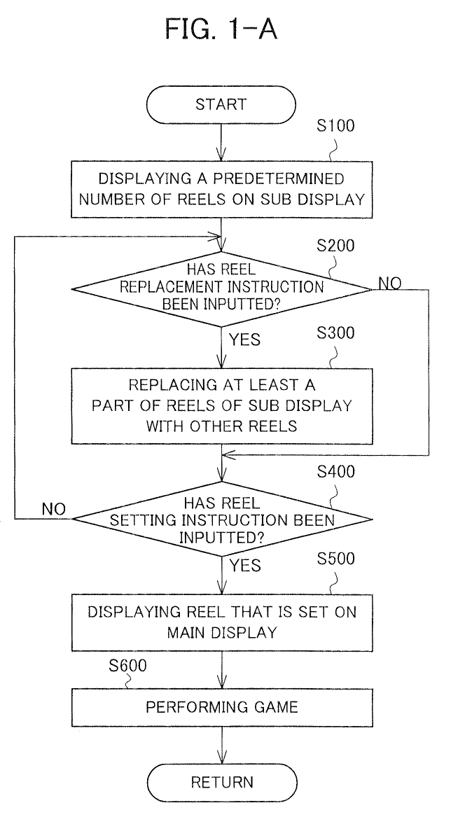

FIG. 1-B is a flowchart showing processing executed in the gaming machine according to an embodiment of the present invention;

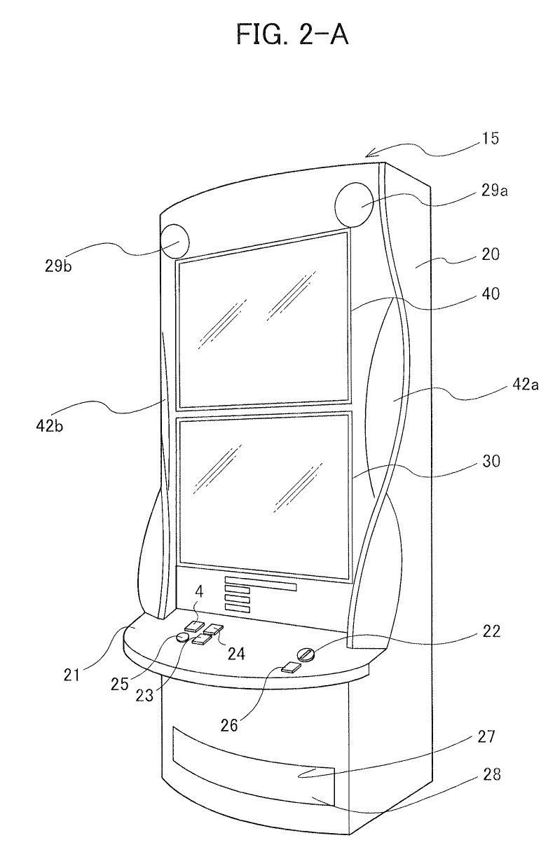

FIG. 2-B is a perspective view showing an appearance of the gaming machine according to a first embodiment of the present invention;

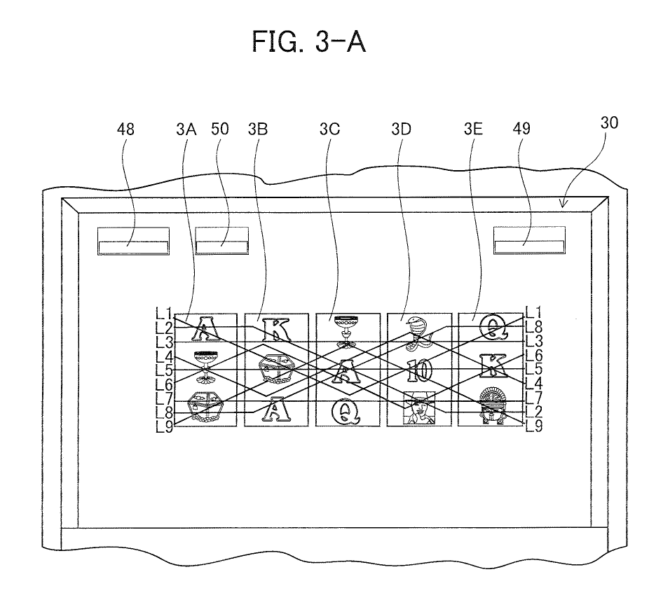

FIG. 3-B is an enlarged view illustrating a display area of the gaming machine shown in FIG. 2-B;

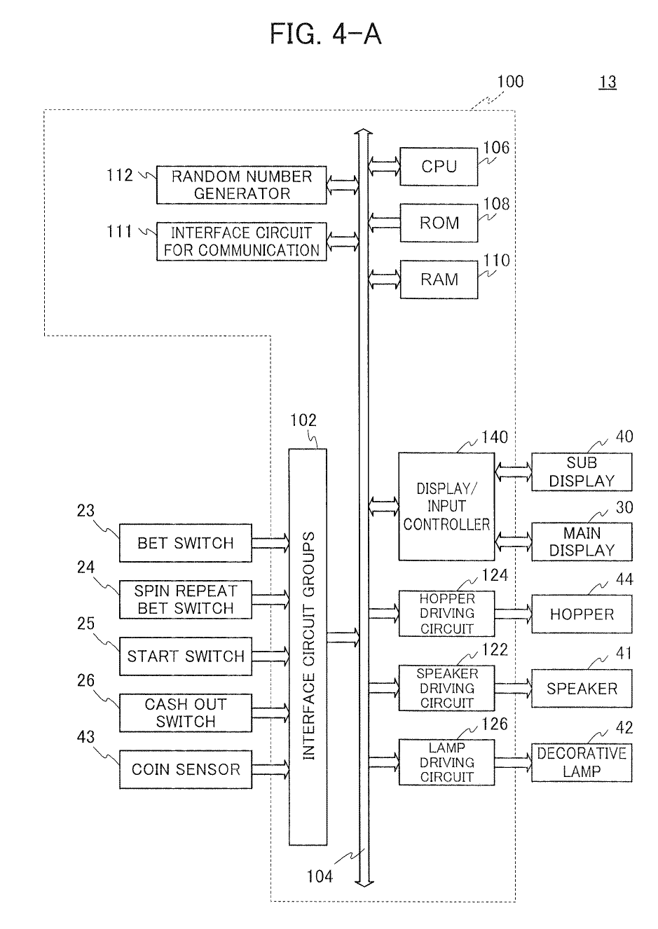

FIG. 4-B is a block diagram of a controller of the gaming machine shown in FIG. 2-B;

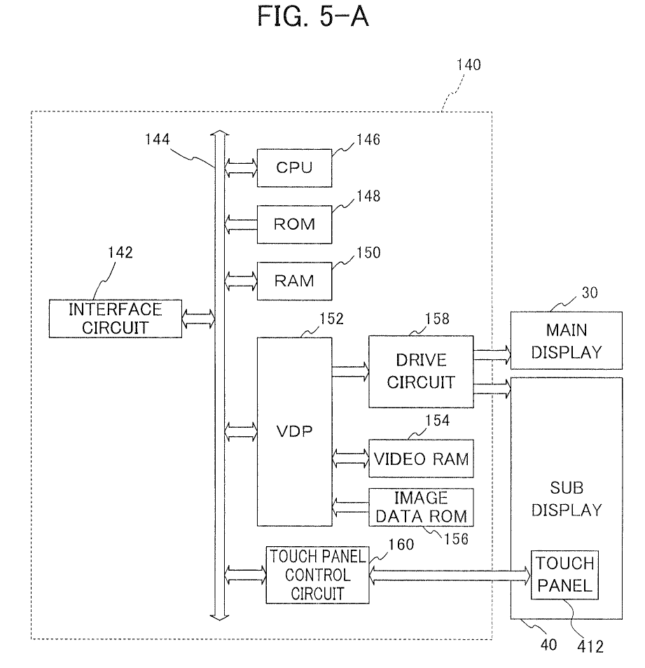

FIG. 5-B is a block diagram of a display/input controller of the gaming machine shown in FIG. 2-B;

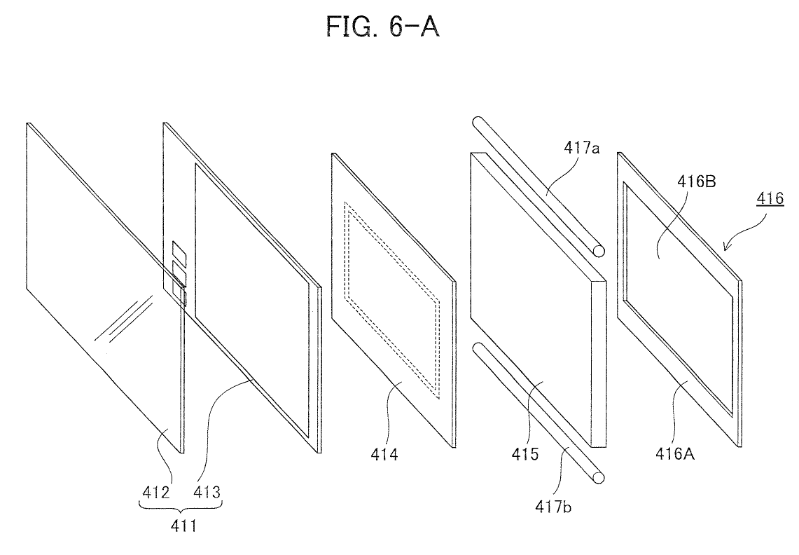

FIG. 6-B is a partial exploded view showing a part of a sub display of the gaming machine shown in FIG. 2-B;

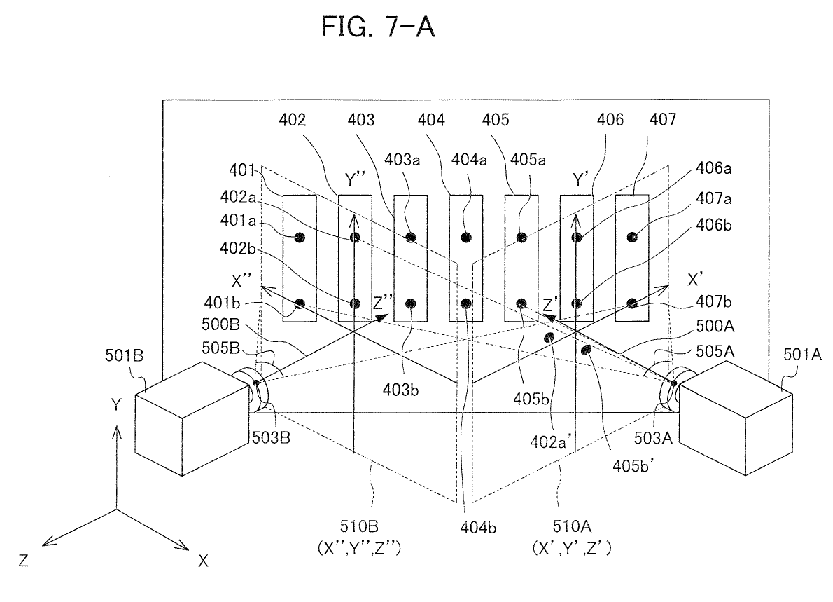

FIG. 7-B is a diagram showing a method of 3-dimensionally displaying a selectable reel on the sub display of the gaming machine shown in FIG. 2-B;

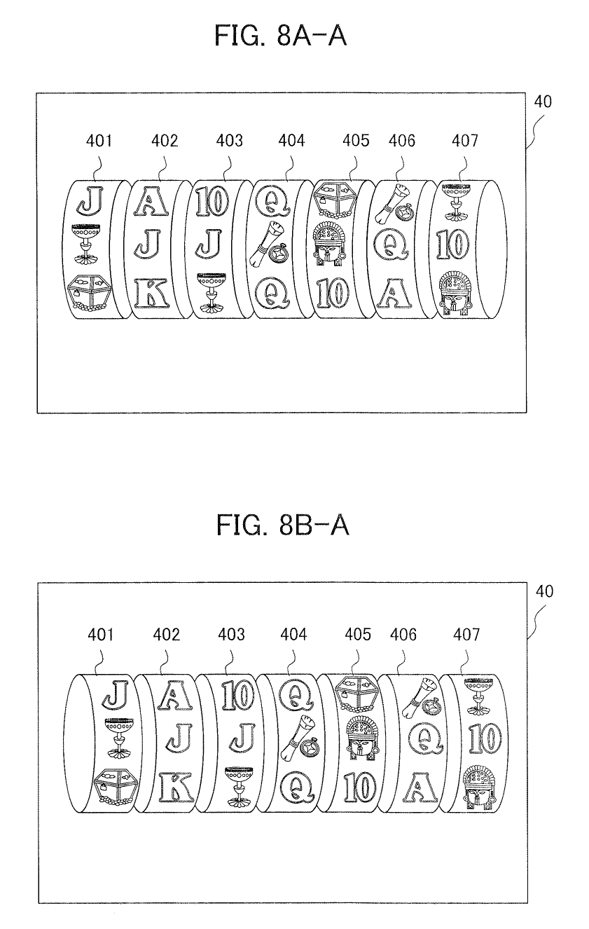

FIG. 8A-B shows a display screen 0f the sub display off the gaming machine shown in FIG. 2-B, which is displayed 3-dimensionally from a point of view which is substantially 45 degrees diagonally backwards to the right from the display screen;

FIG. 8B-B shows a display screen of the sub display of the gaming machine shown in FIG. 2-B, which is displayed 3-dimensionally from a point of view which is substantially 45 degrees diagonally backwards to the left from the display screen;

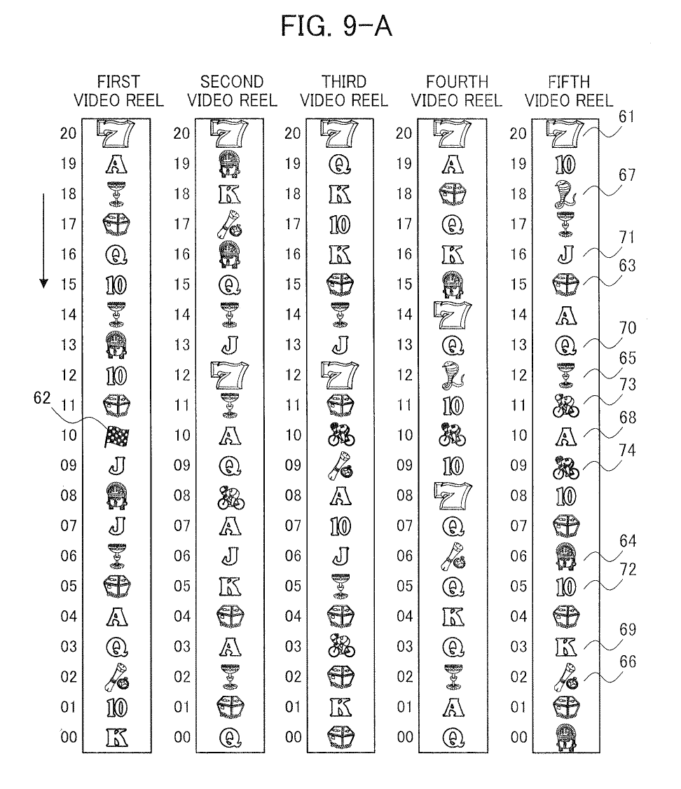

FIG. 9-B shows symbol lines disposed on each video reel, which are displayed during a second game on a main display of the gaming machine shown in FIG. 2-B;

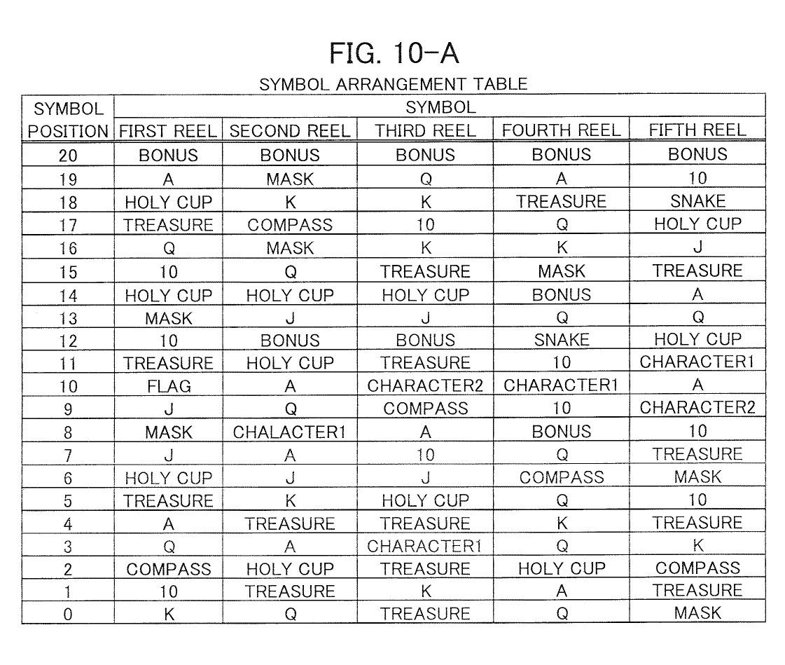

FIG. 10-B shows a symbol arrangement table used by the gaming machine shown in FIG. 2-B;

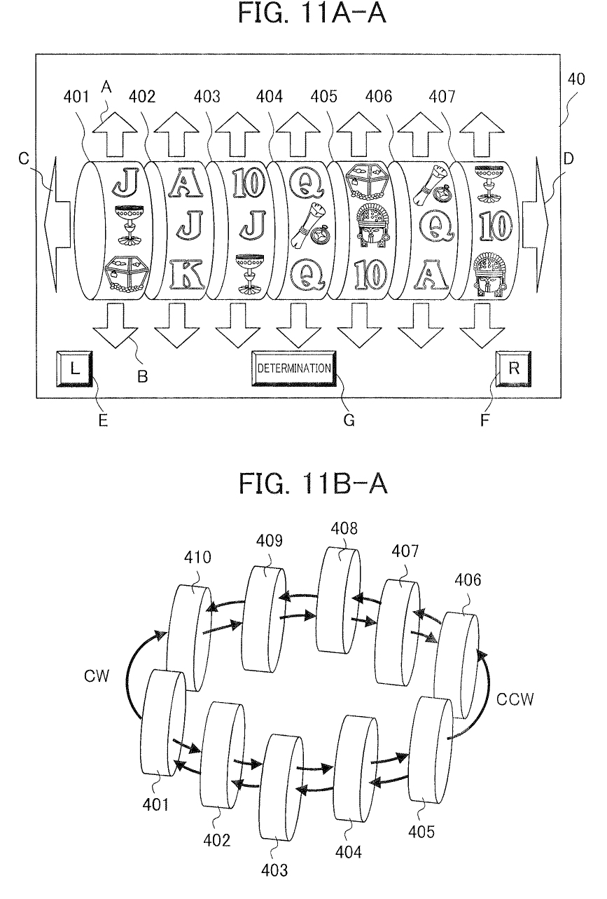

FIG. 11A-B shows an example of a reel selection display screen that displays selectable reels displayed on the sub display of the gaming machine shown in FIG. 2-13;

FIG. 11B-B shows replaceable reels that can be displayed on the sub display of the gaming machine shown in FIG. 2-B;

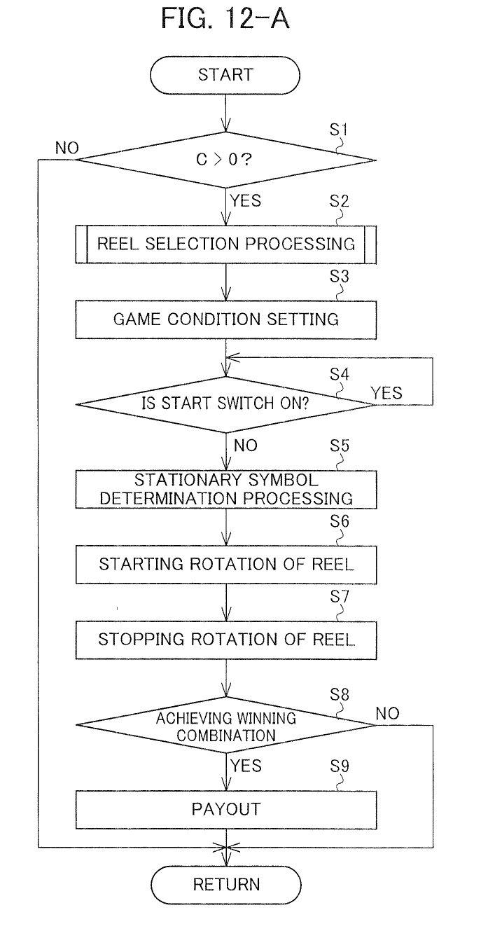

FIG. 12-B is a flowchart showing main processing operation executed by a controller of the gaming machine shown in FIG. 2-B;

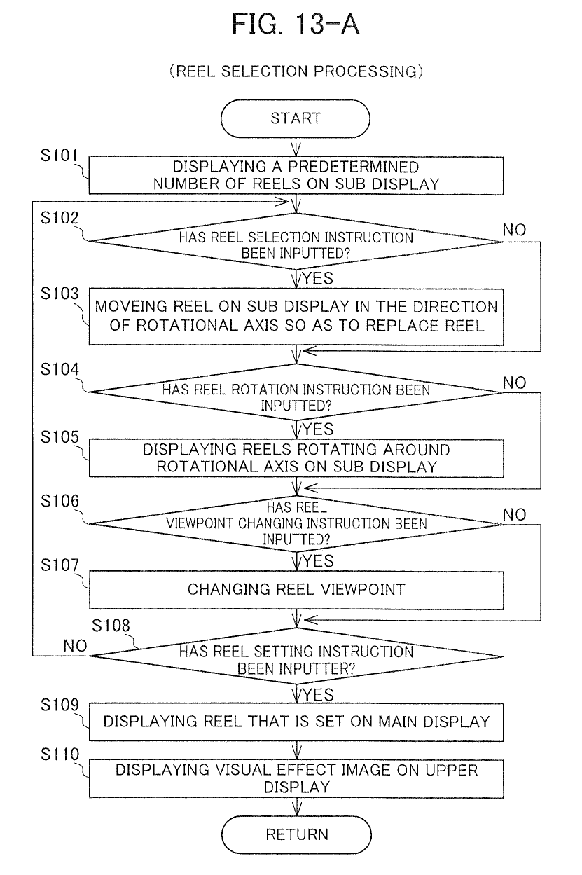

FIG. 13-B is a flowchart showing second game processing executed by the controller of the gaming machine shown in FIG. 2-B;

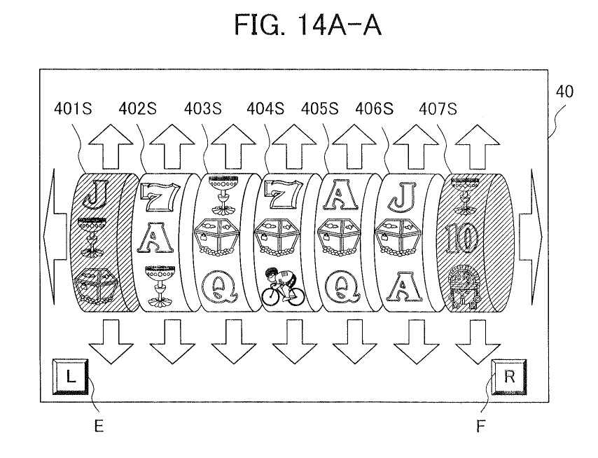

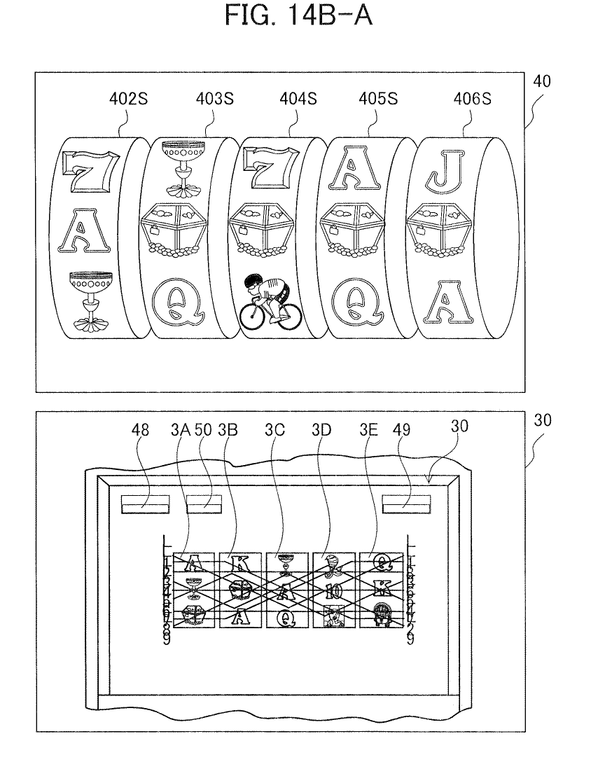

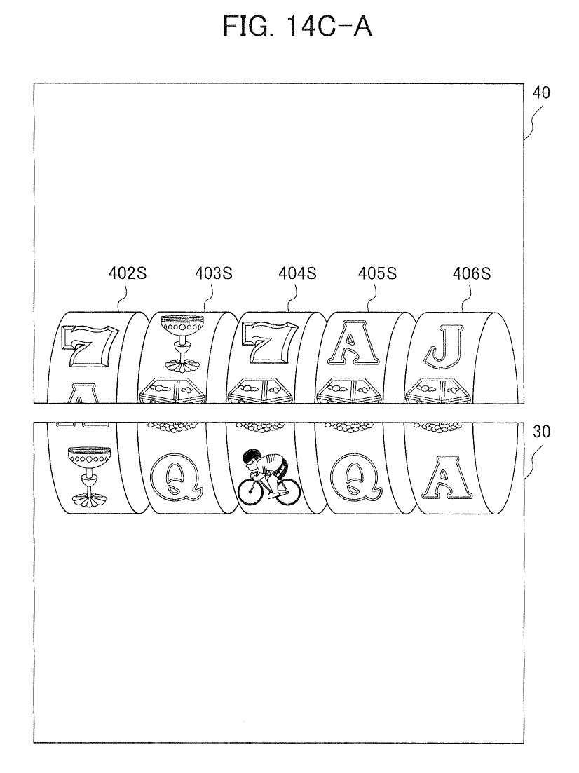

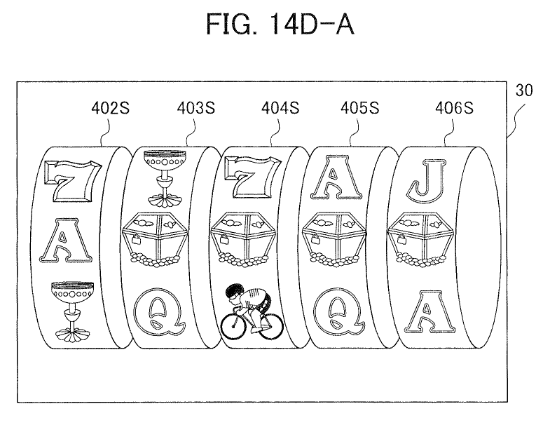

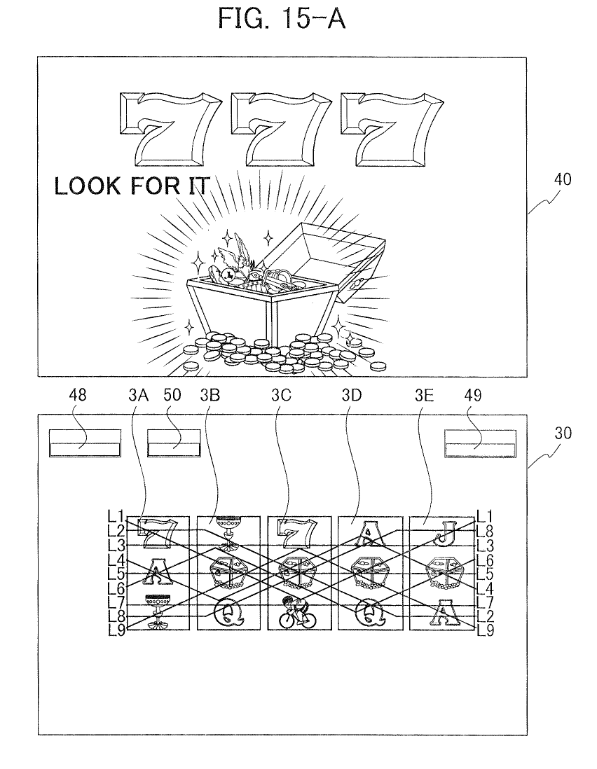

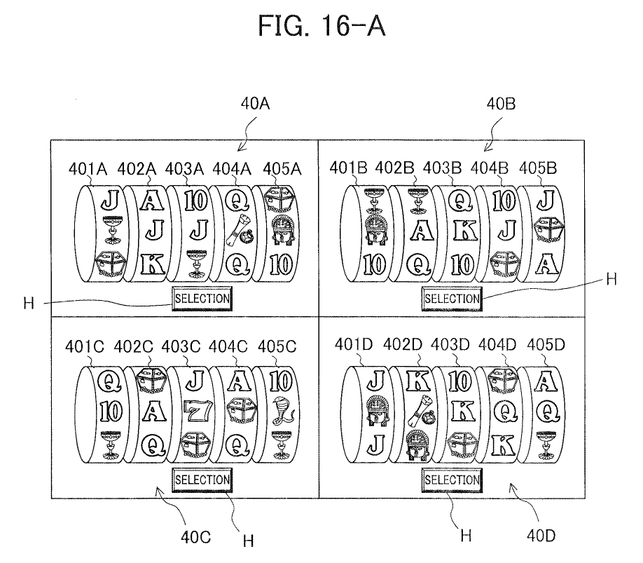

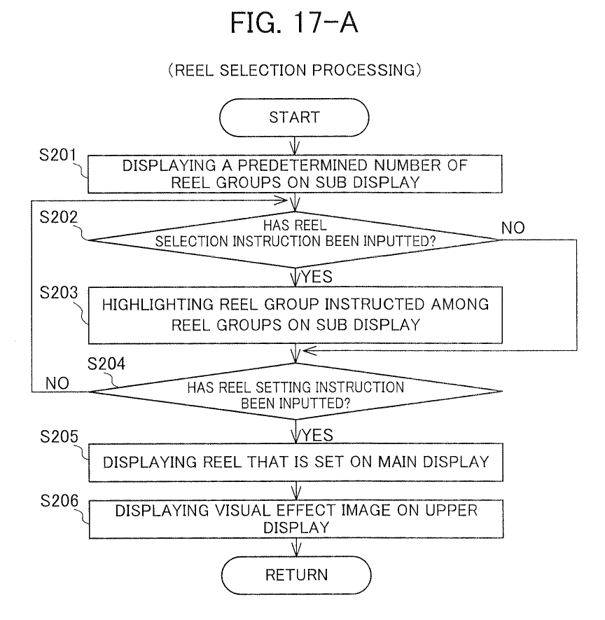

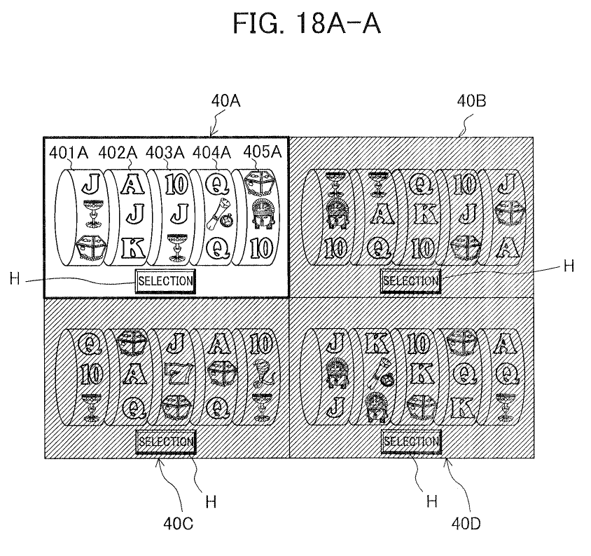

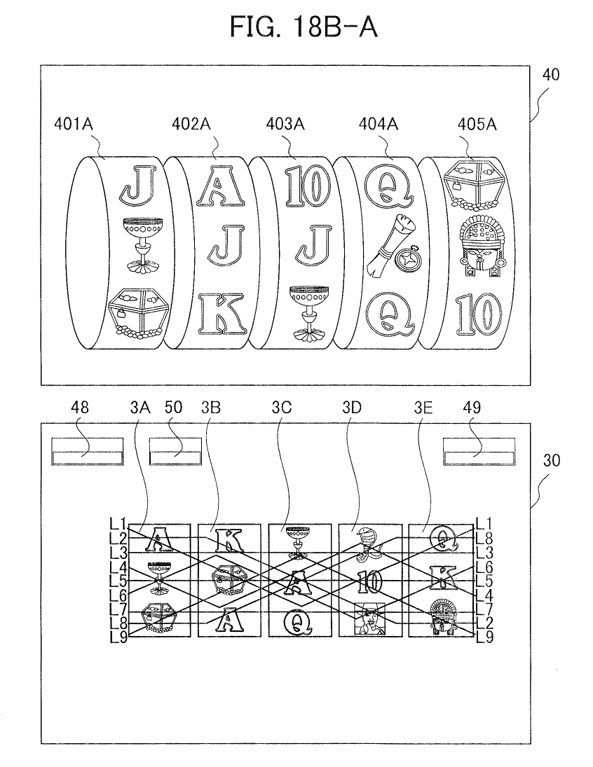

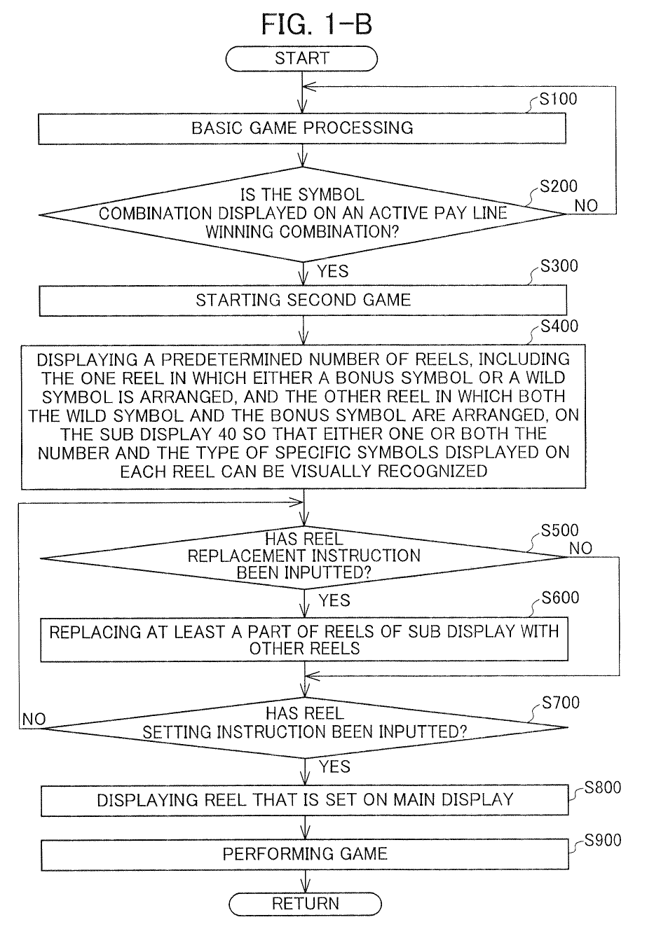

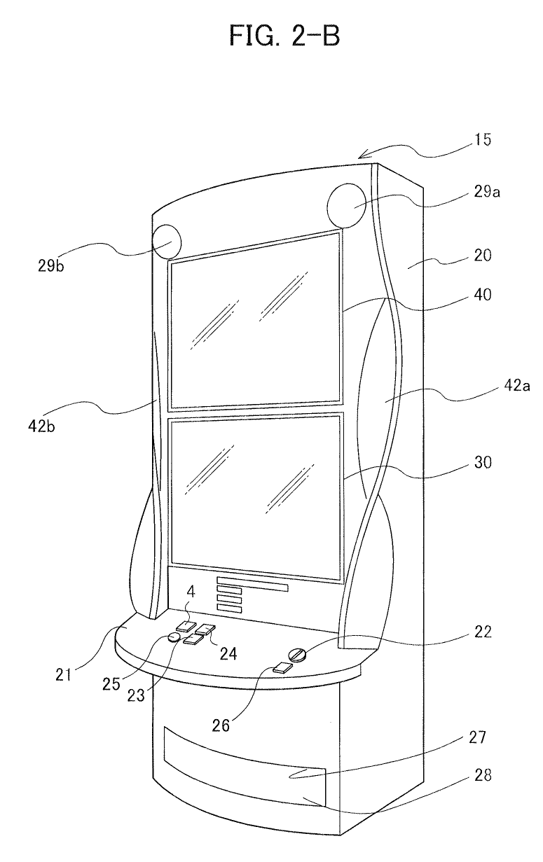

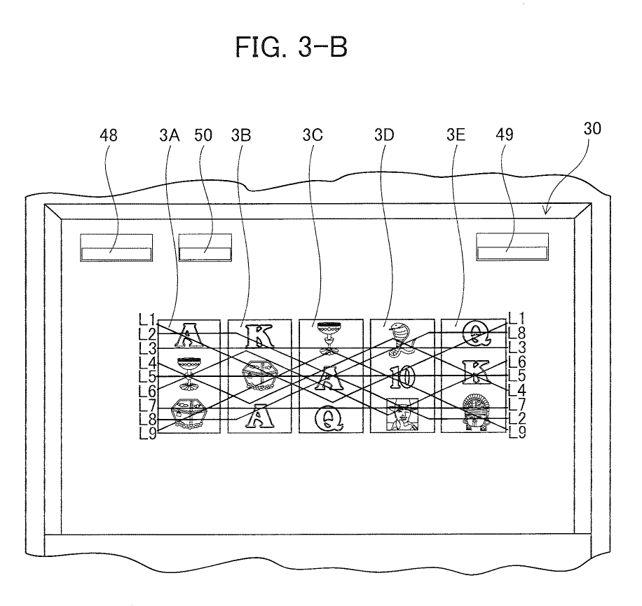

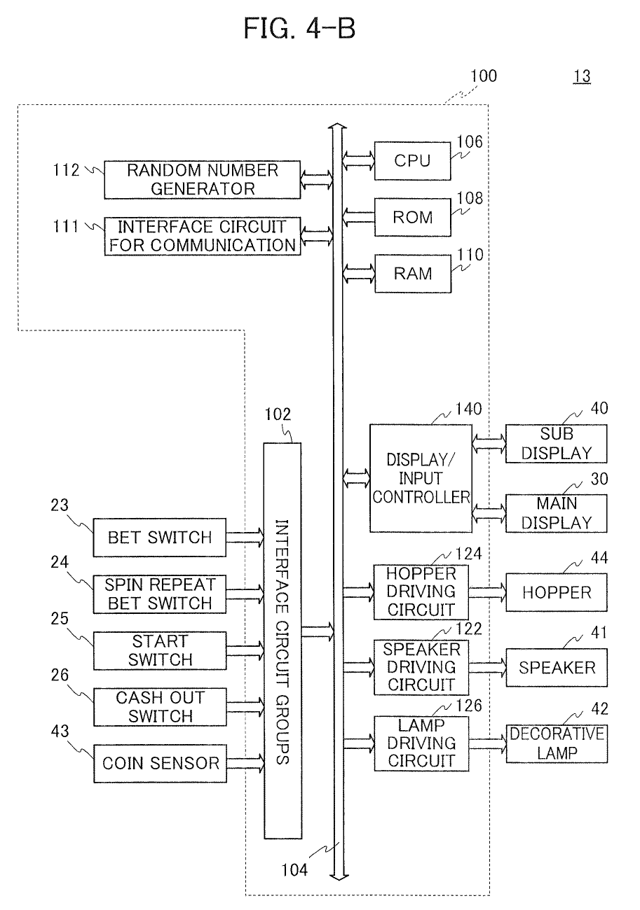

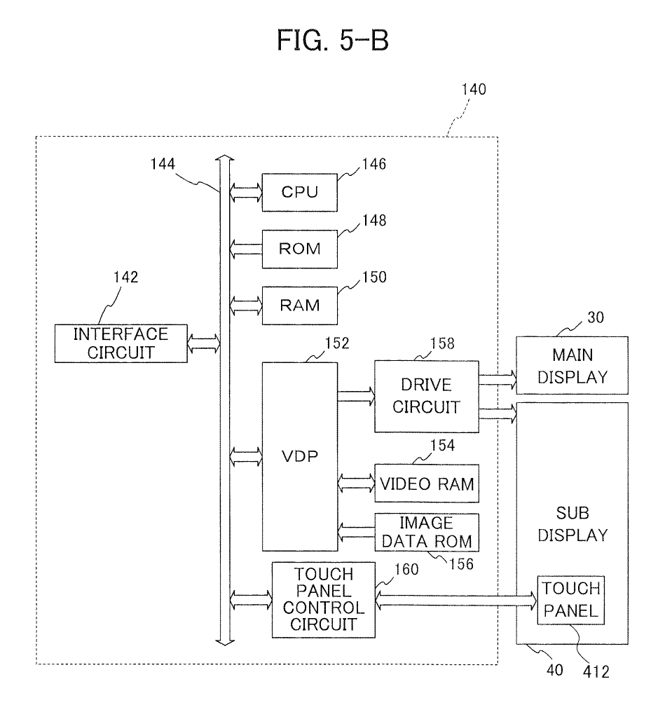

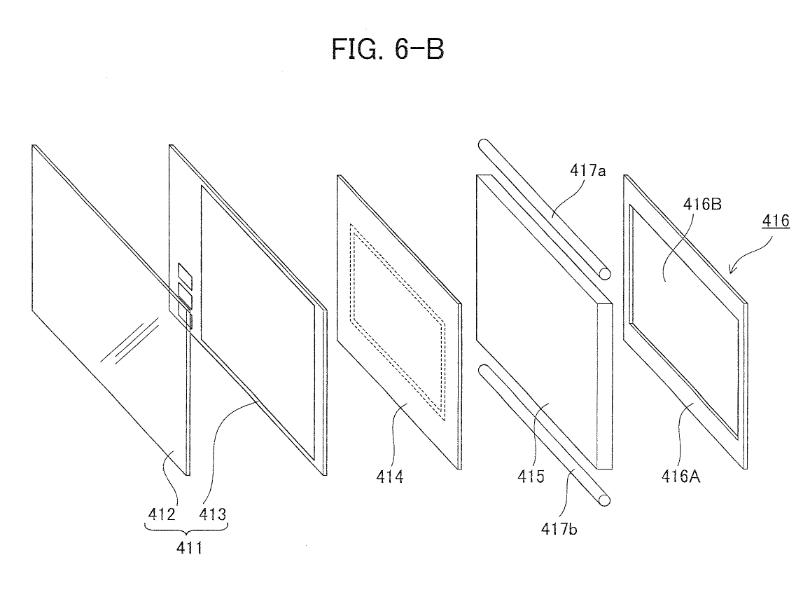

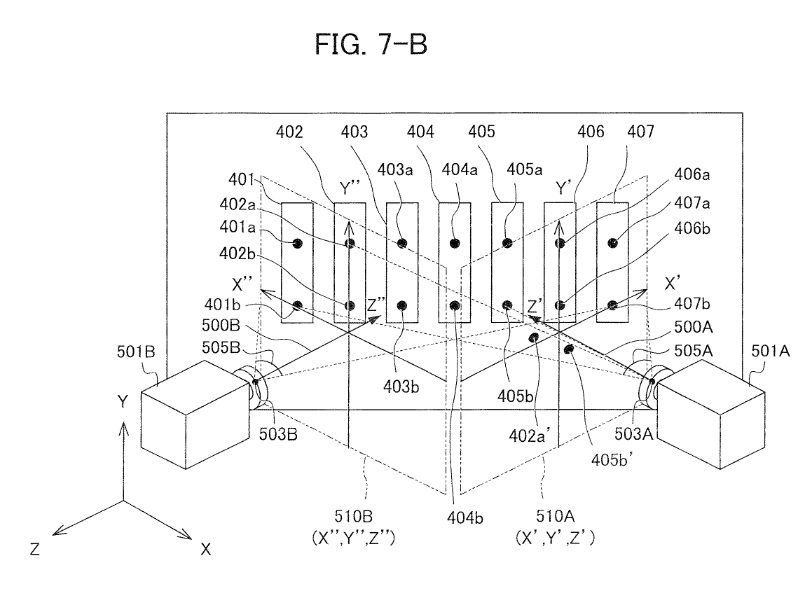

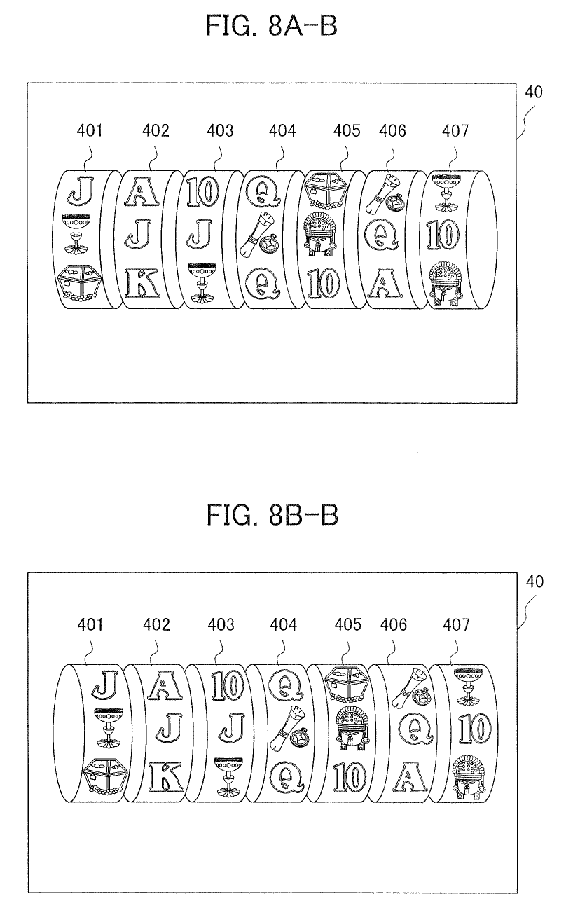

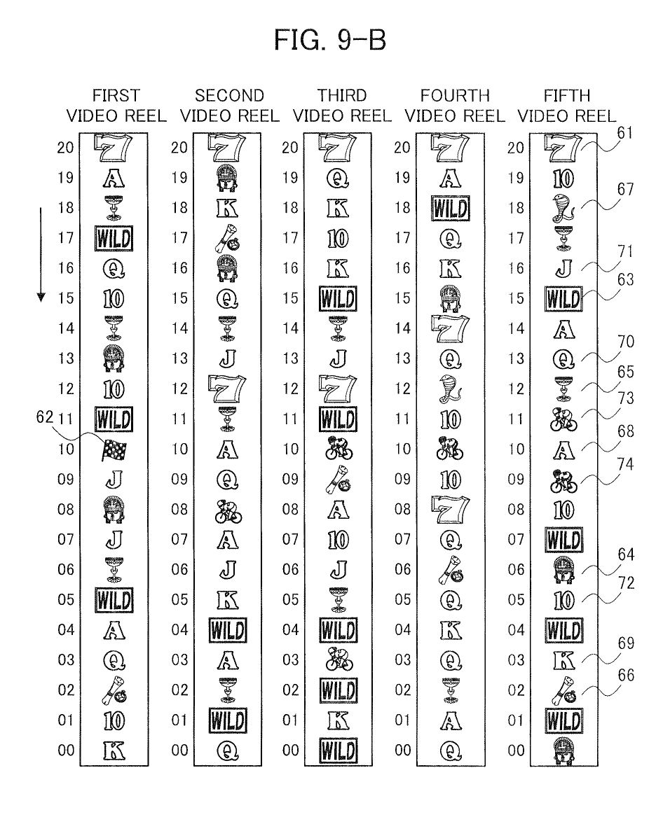

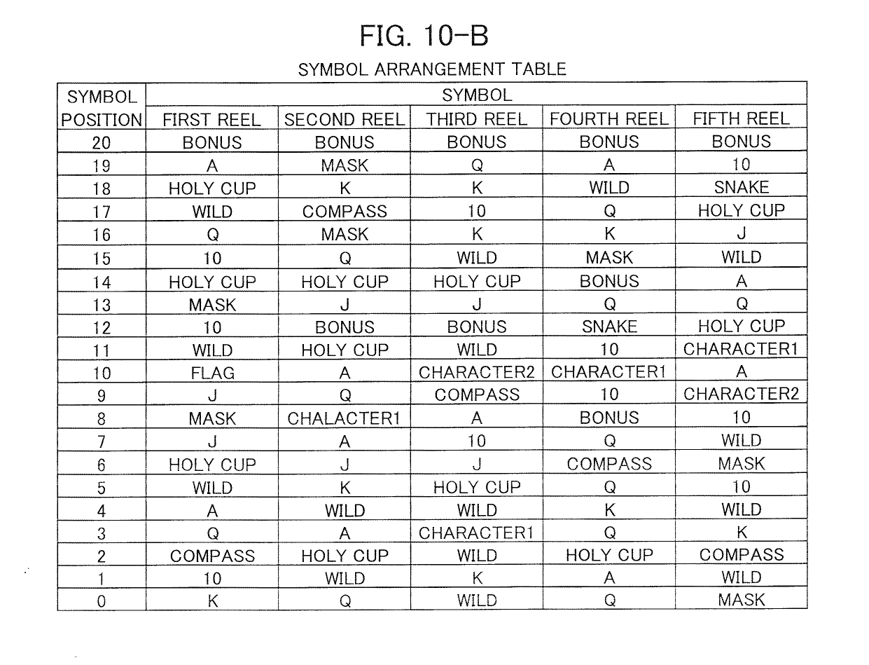

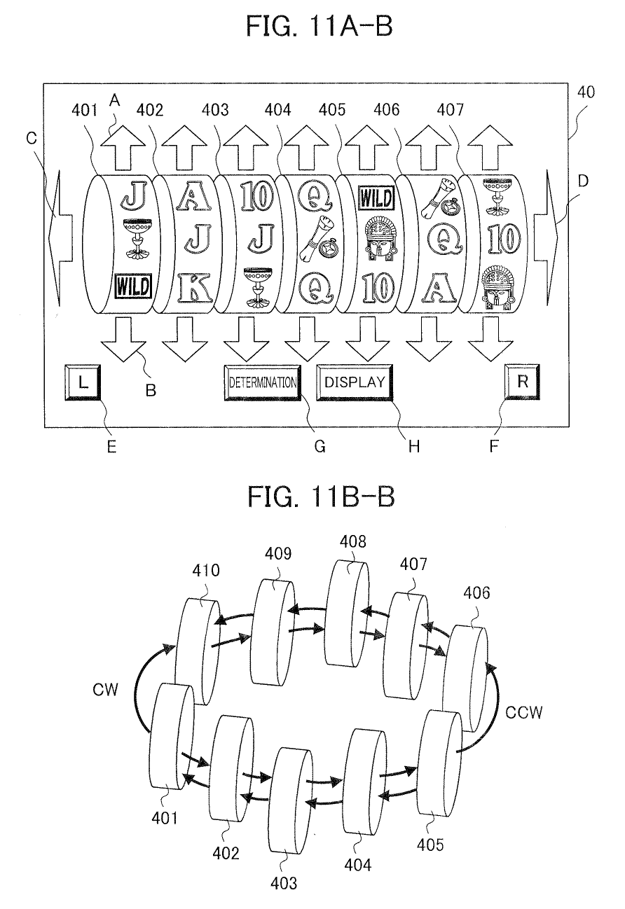

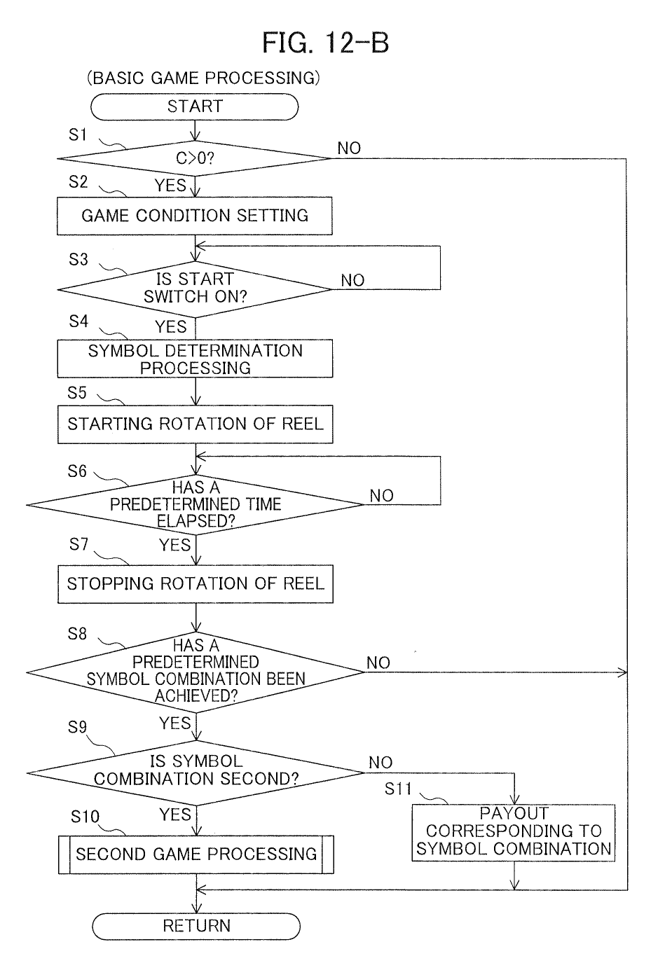

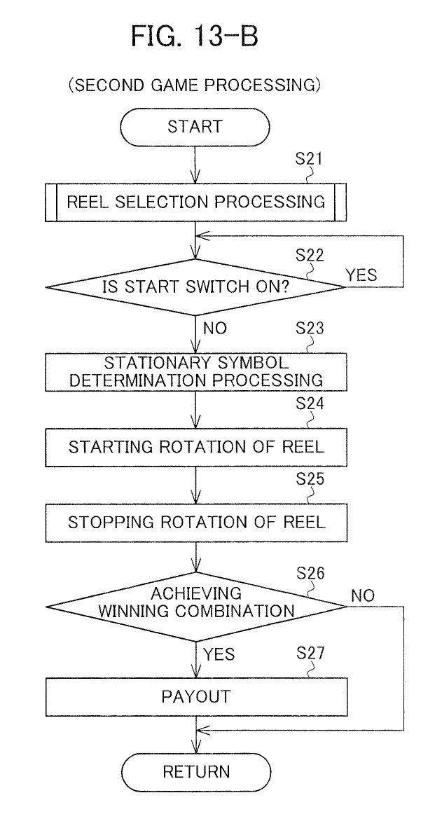

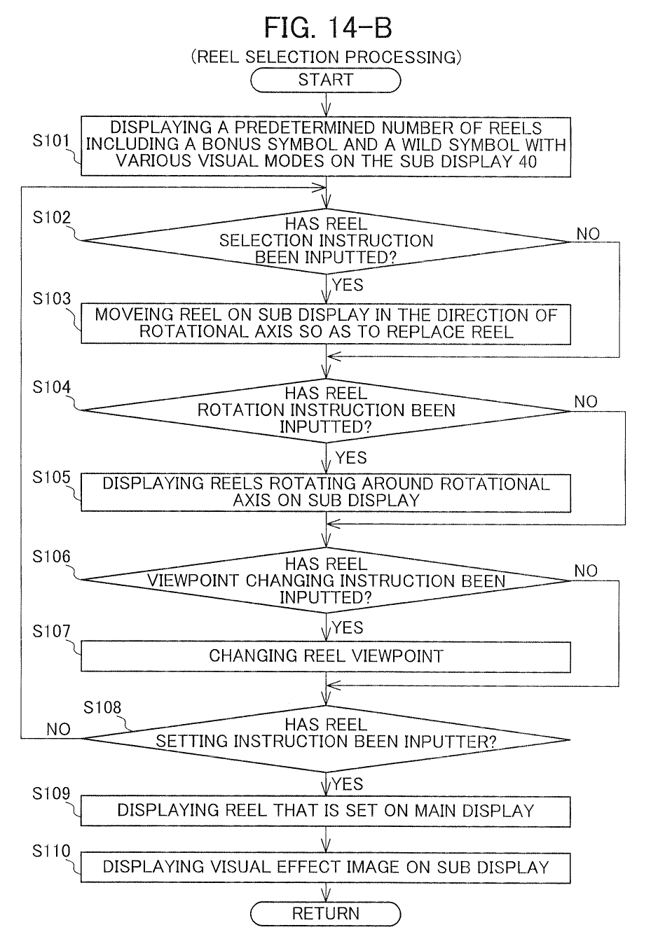

FIG. 14-B is a flowchart showings reel selection processing executed by the controller of the gaming machine shown in FIG. 2-B;

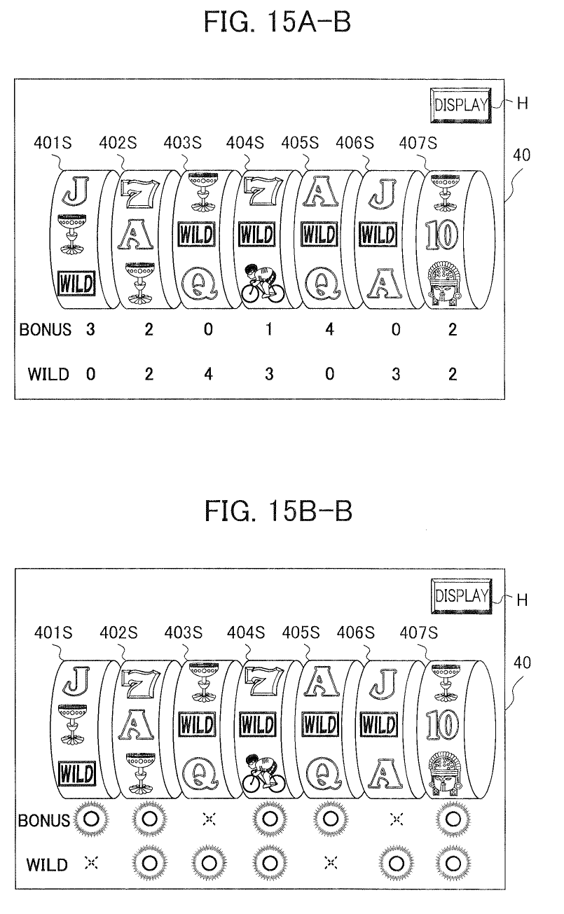

FIGS. 15A-B to 16A-B are diagrams illustrating an image displayed during selecting a reel on the sub display of the gaming machine shown in FIG. 2-B;

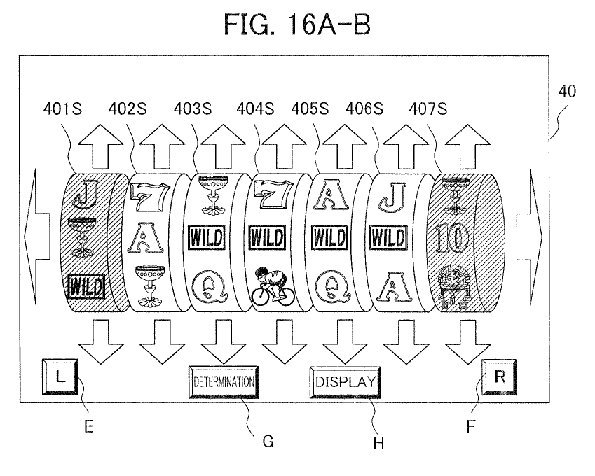

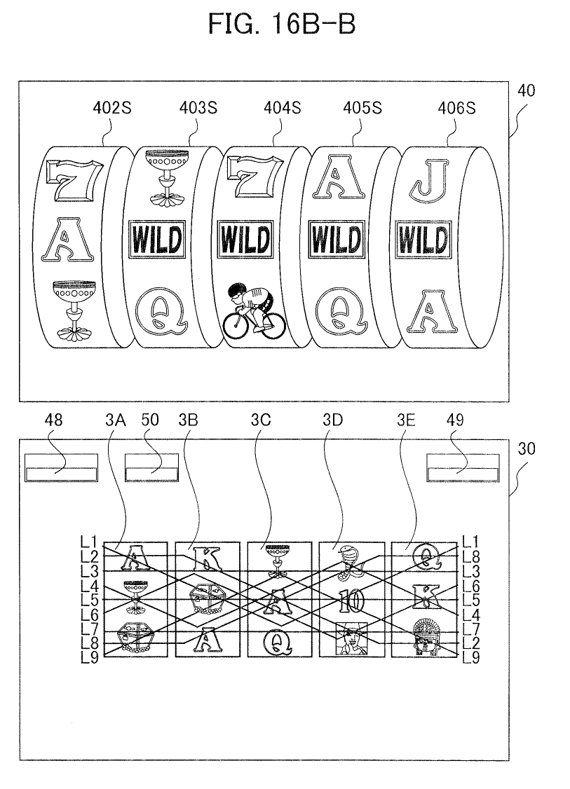

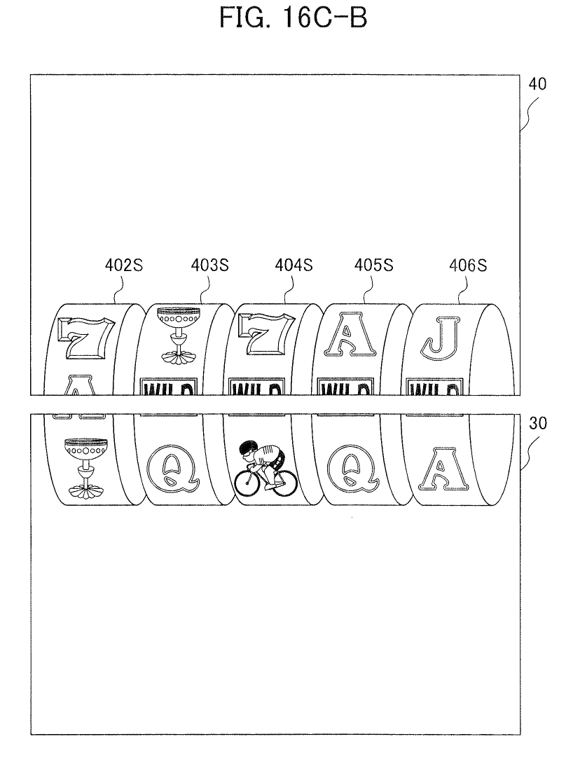

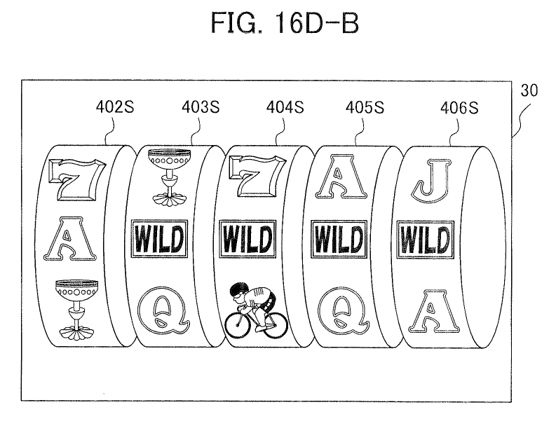

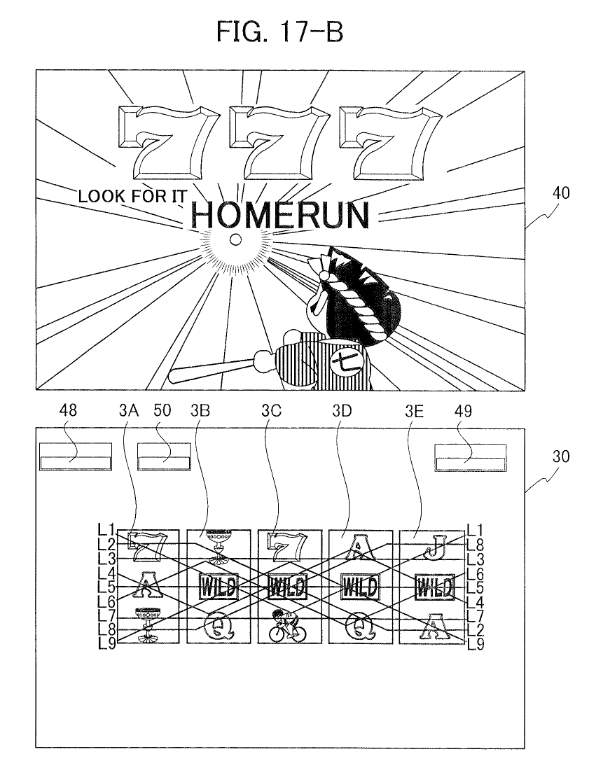

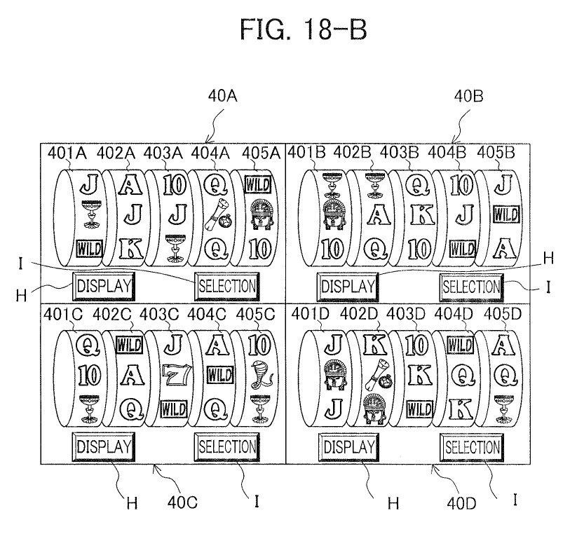

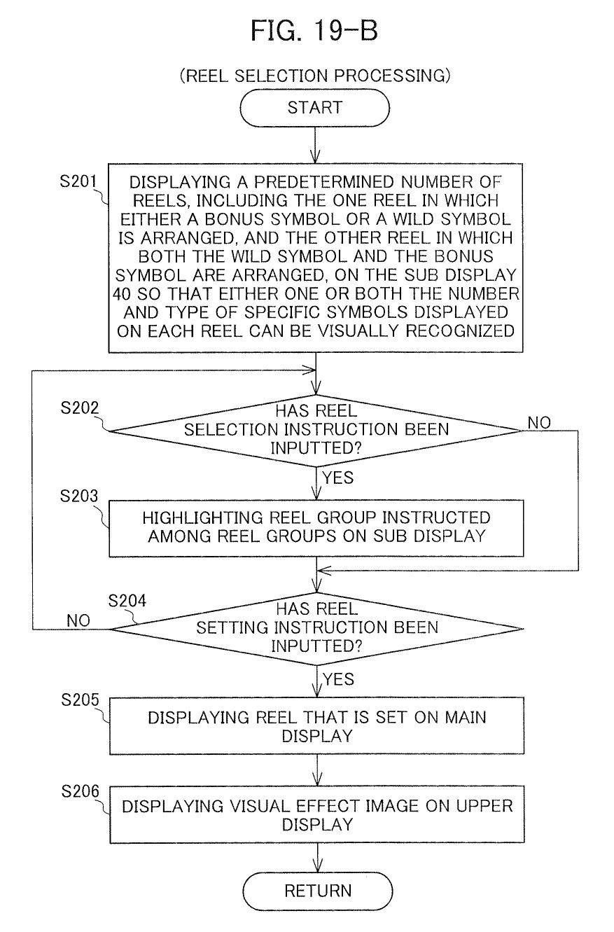

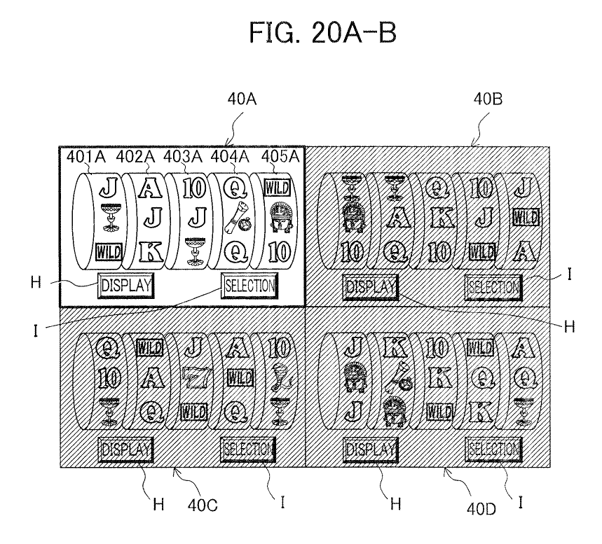

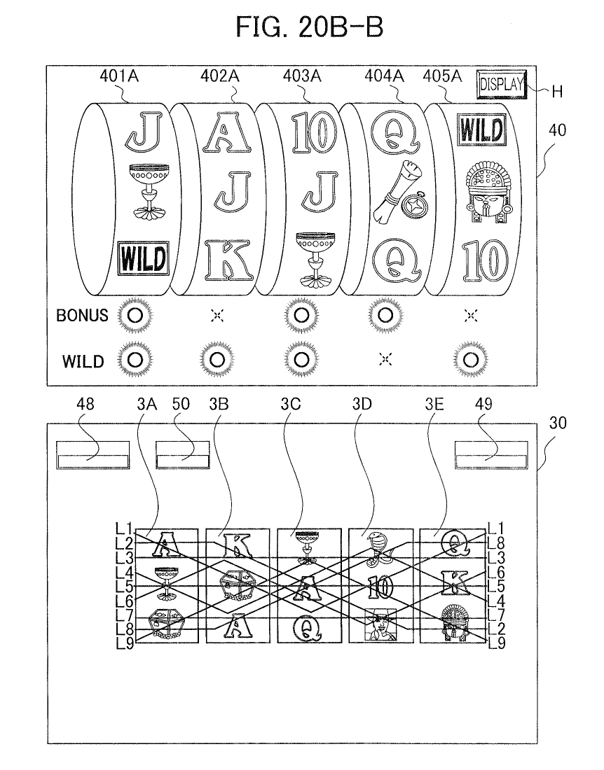

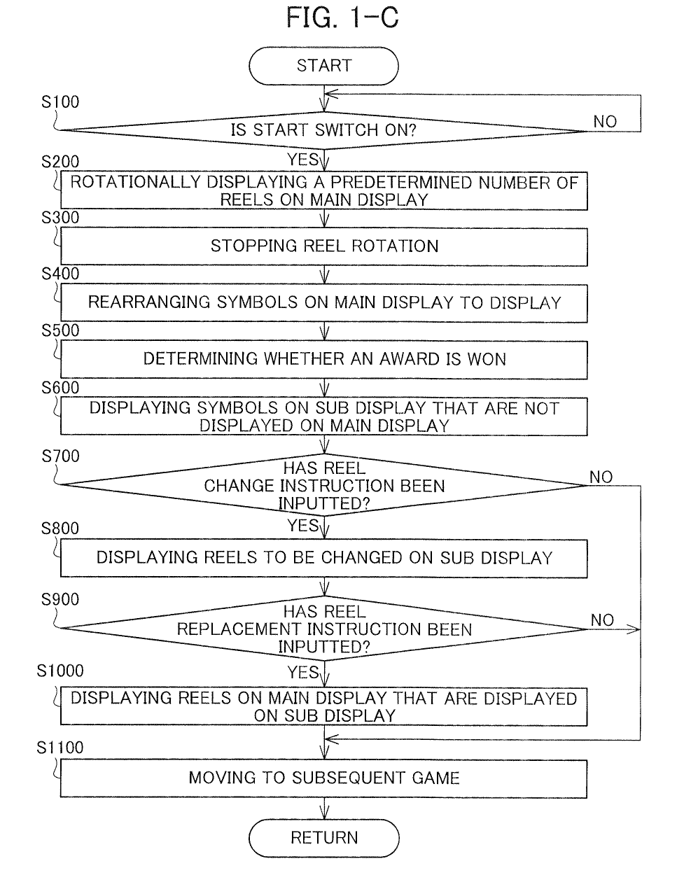

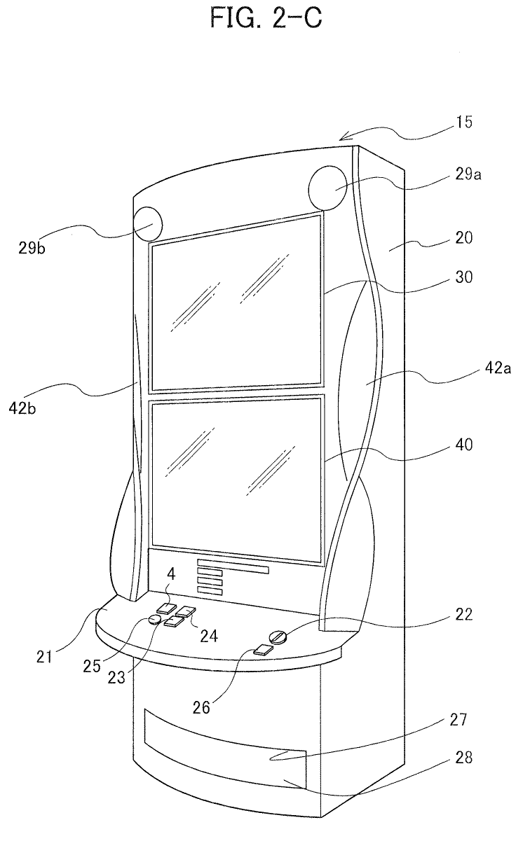

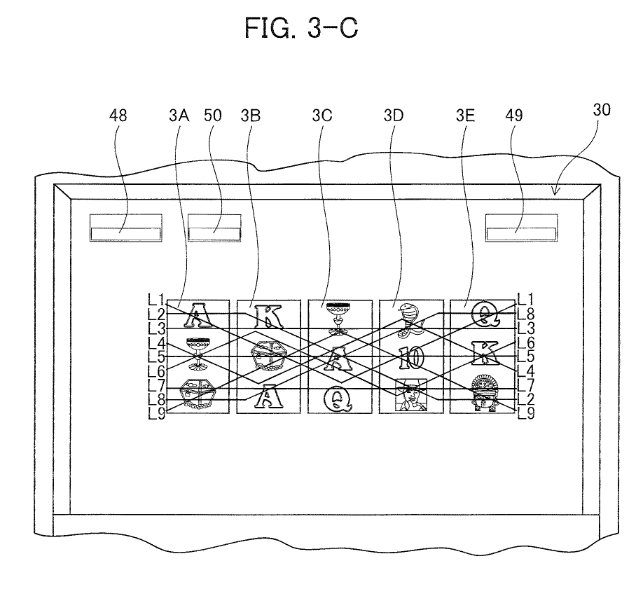

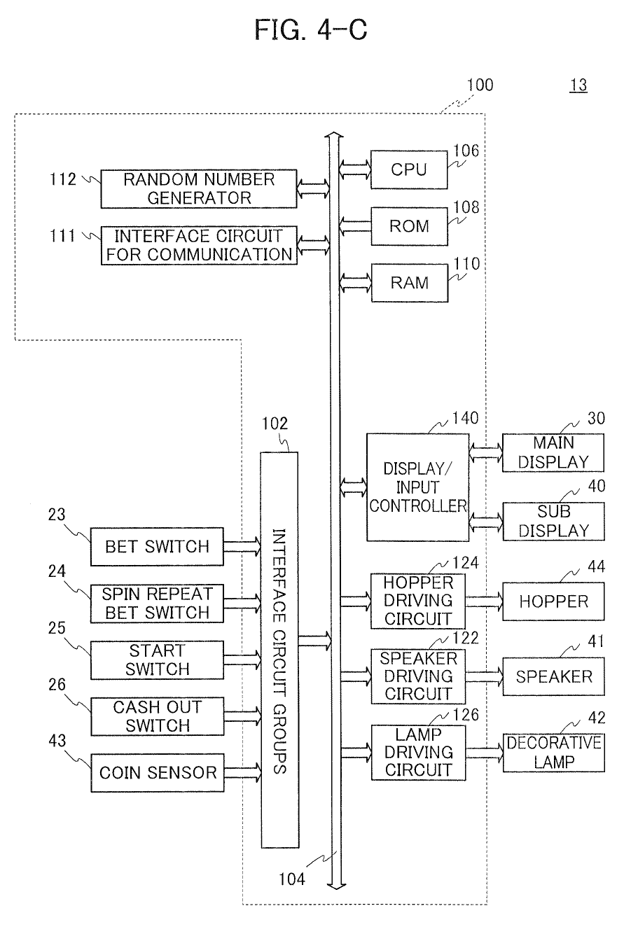

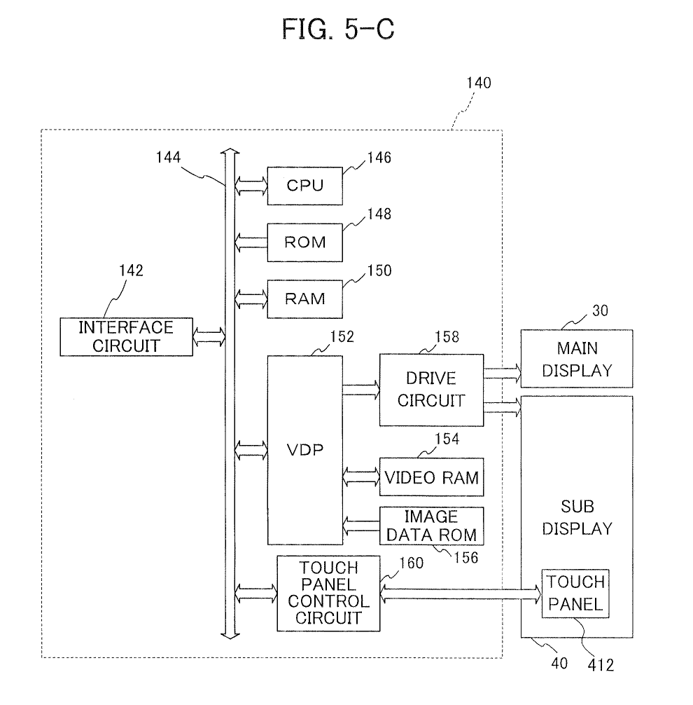

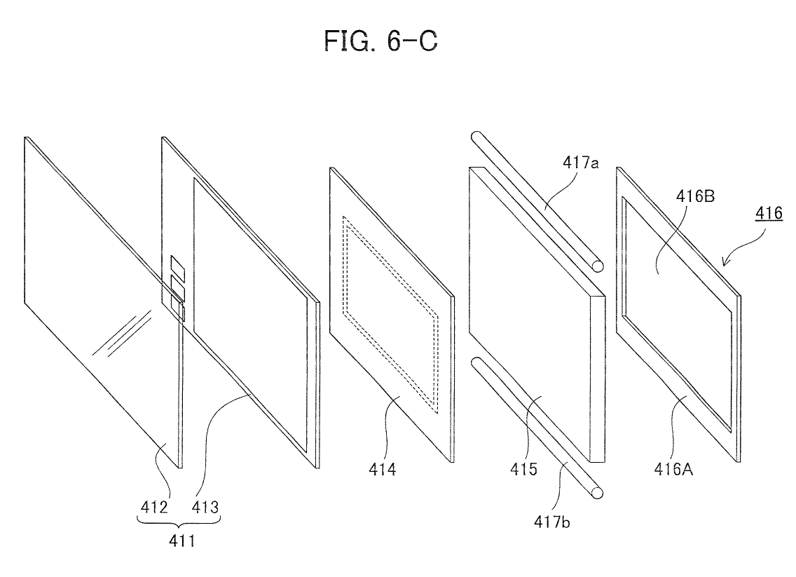

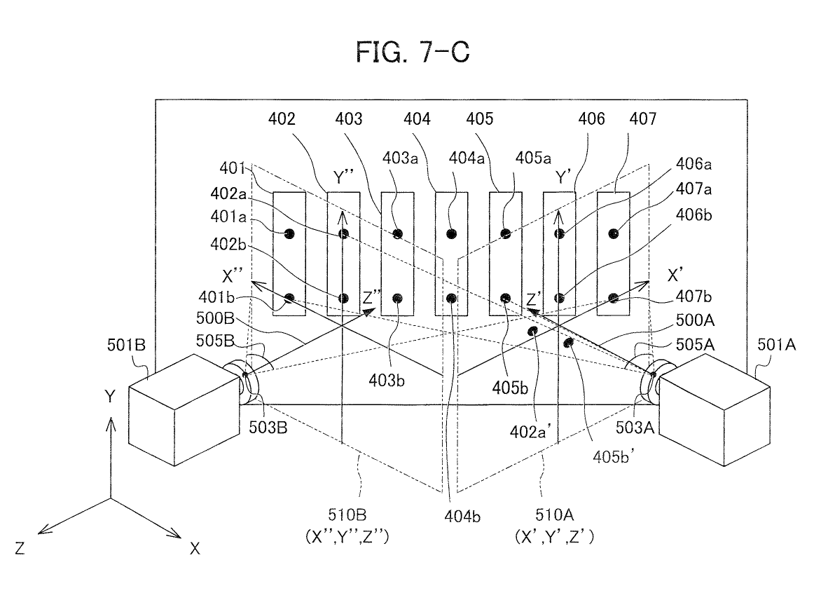

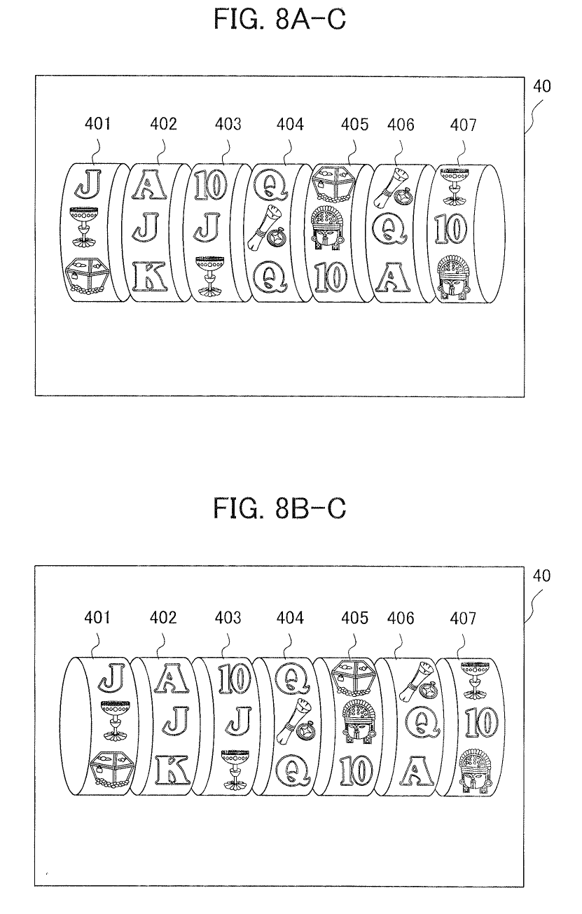

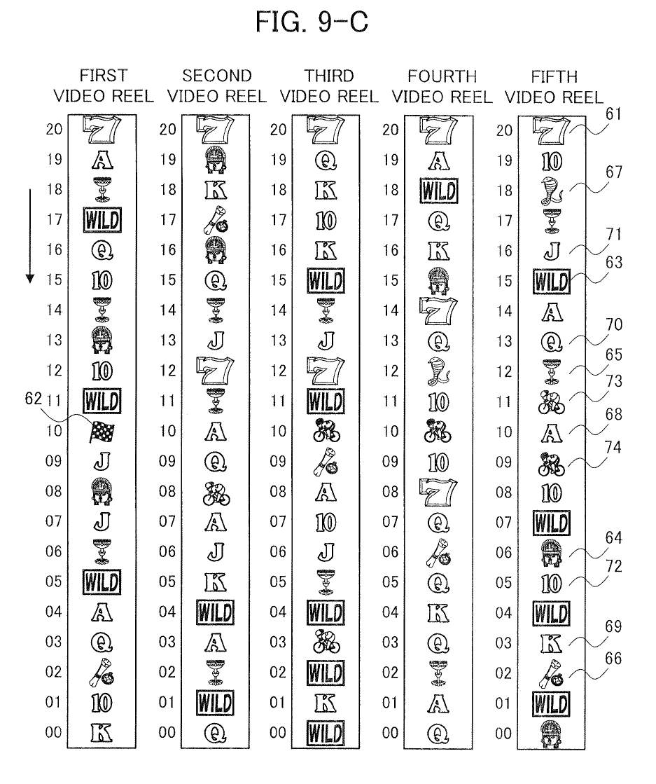

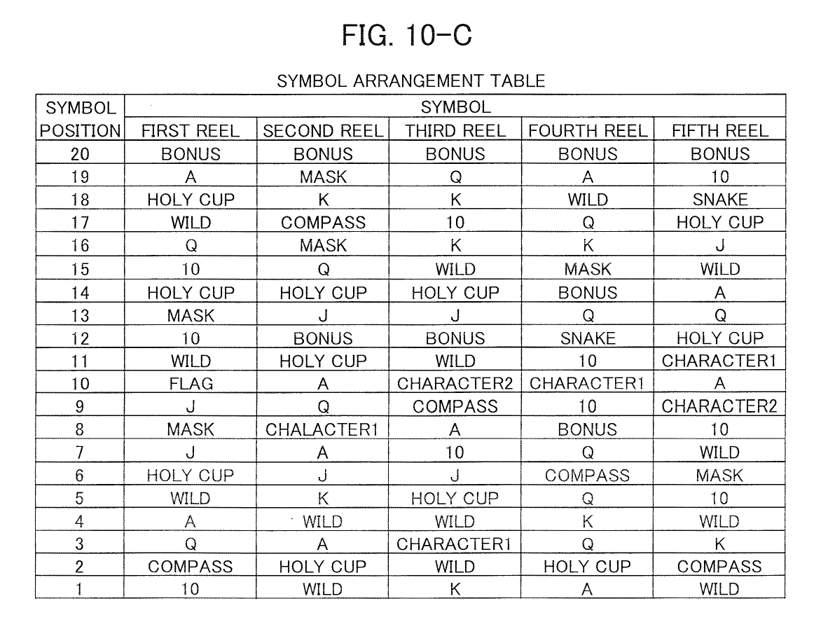

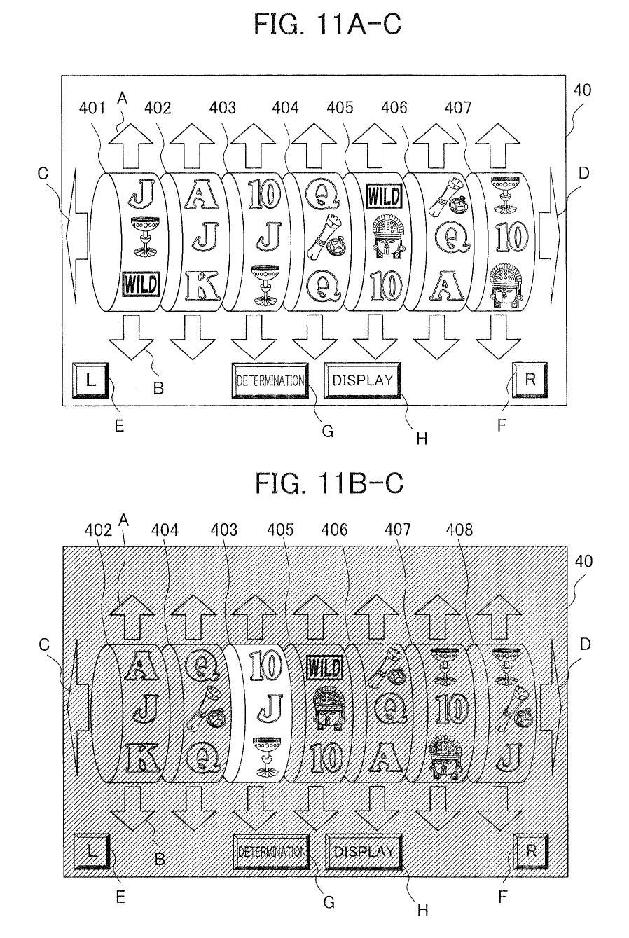

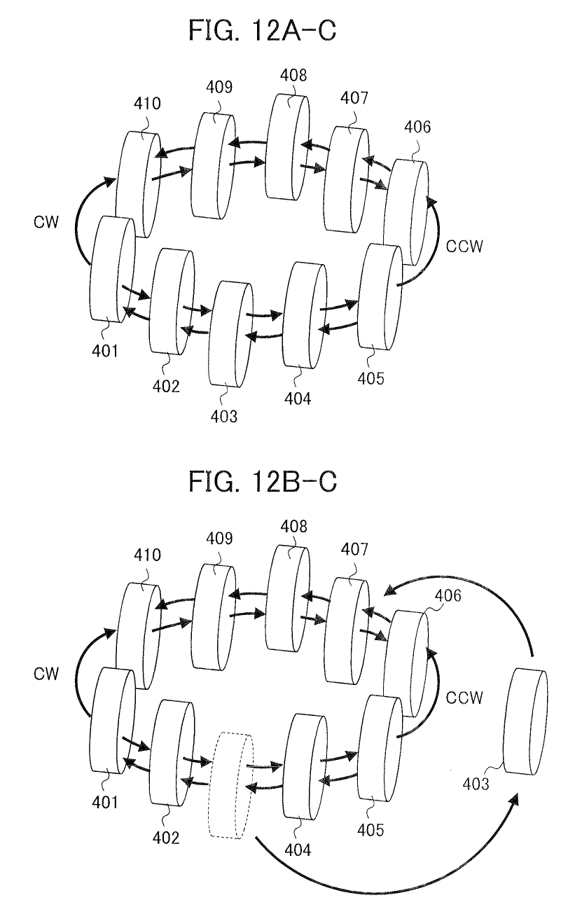

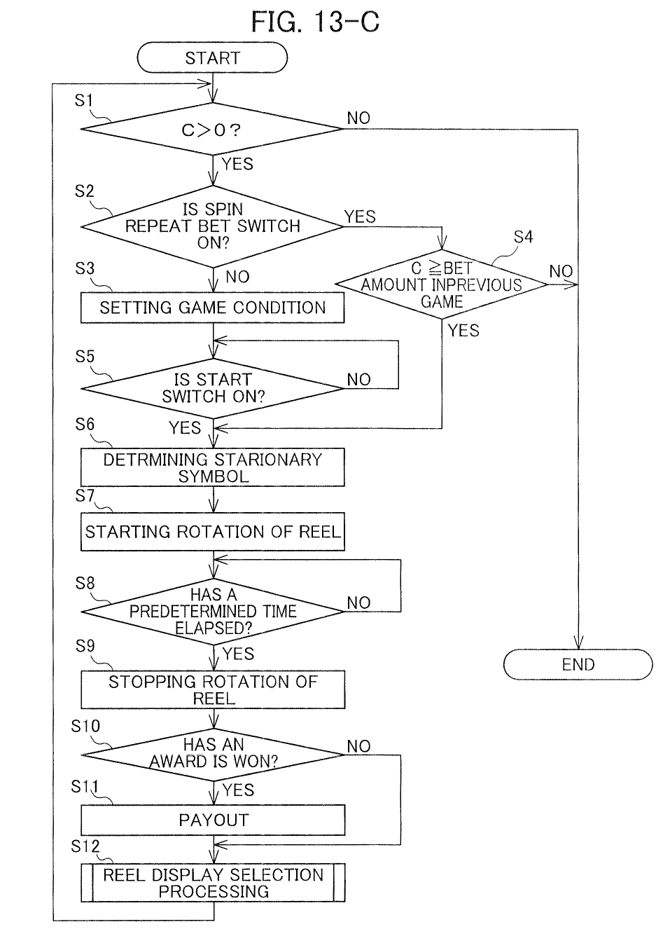

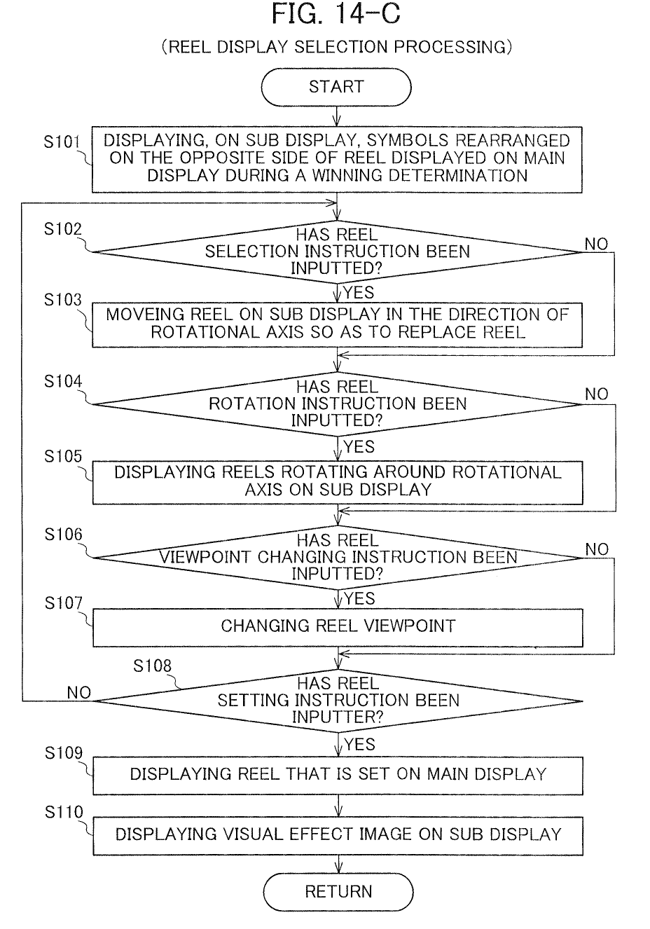

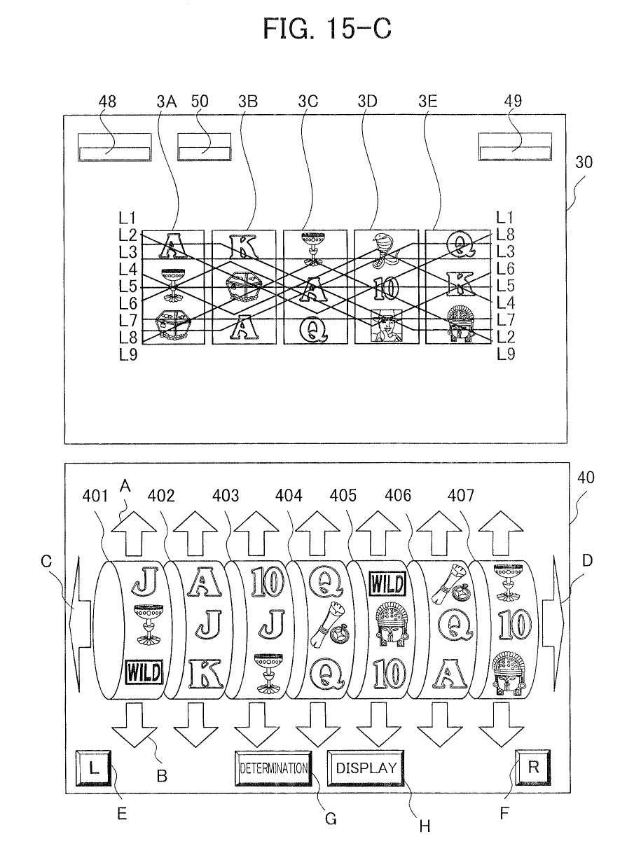

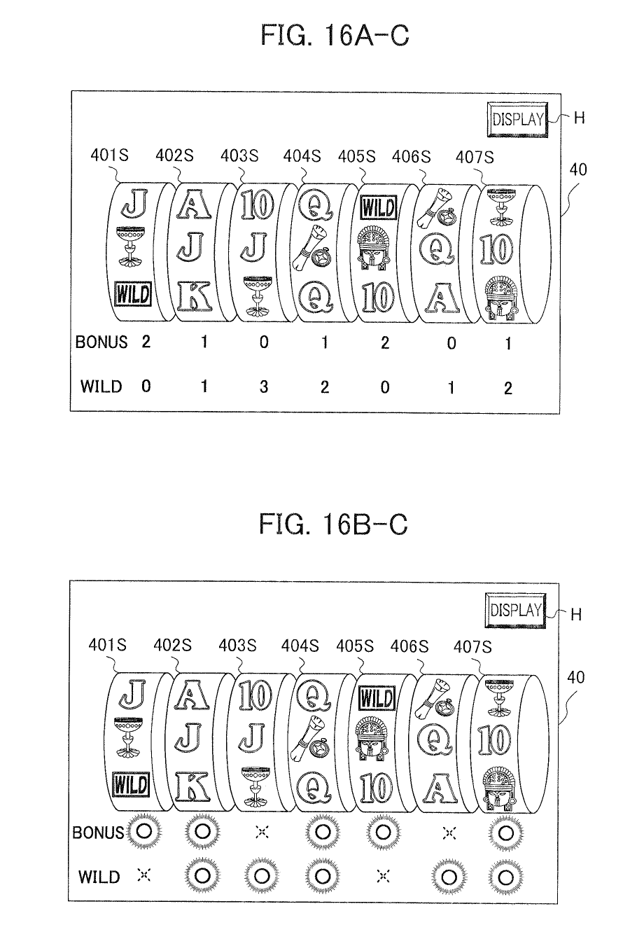

FIGS. 16B-B and 16C-B are diagrams illustrating an image displayed during setting a reel on the main display and on the sub display of the gaming machine shown in FIG. 2-B;

FIG. 16D-B is a diagram illustrating an image displayed during setting a reel on the main display of the gaming machine shown in FIG. 2-B;

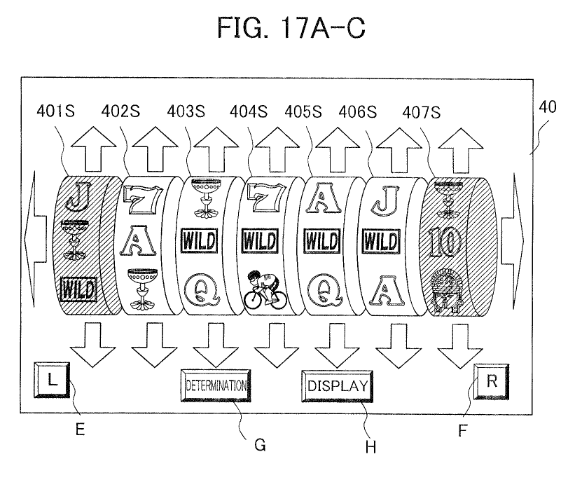

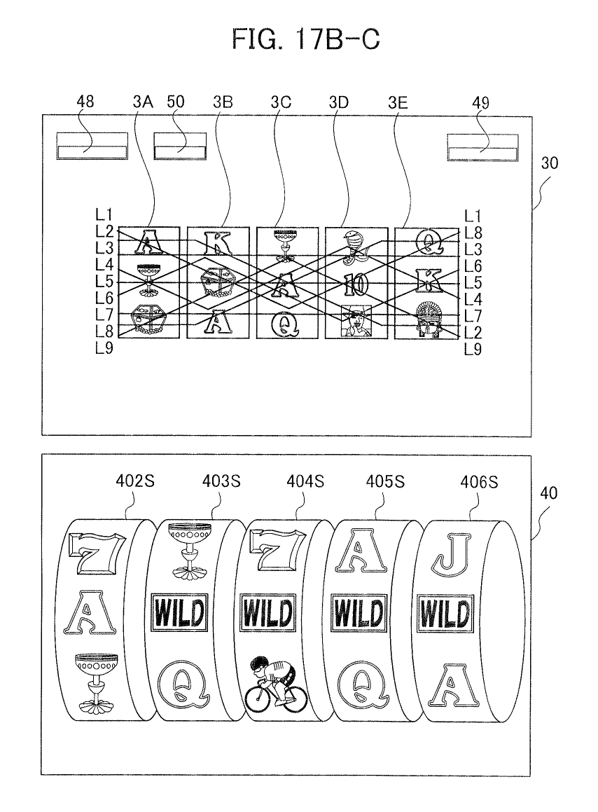

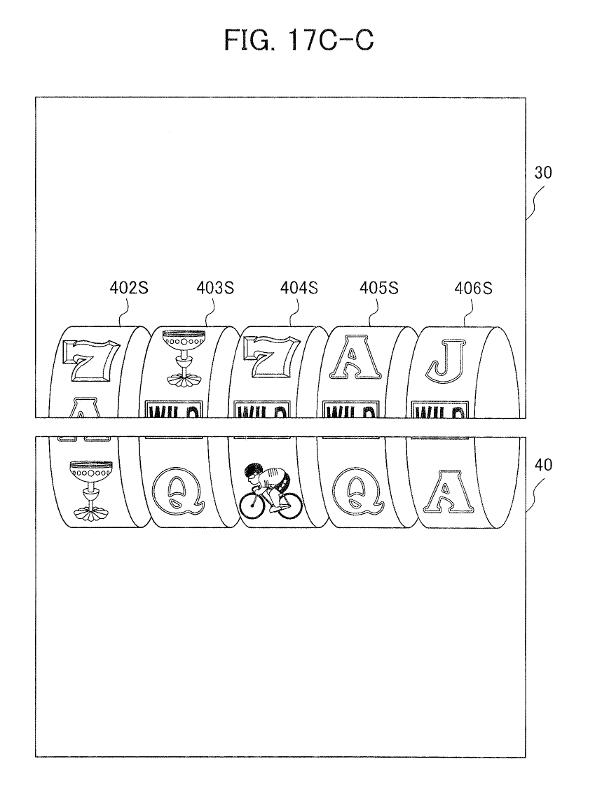

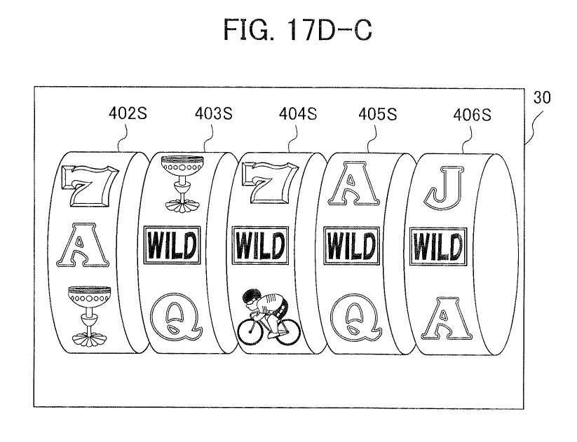

FIG. 17-B is a diagram illustrating an image for a specific visual effect on a reel, which is set, displayed on the main display and the sub display of the gaming machine shown in FIG. 2-B;

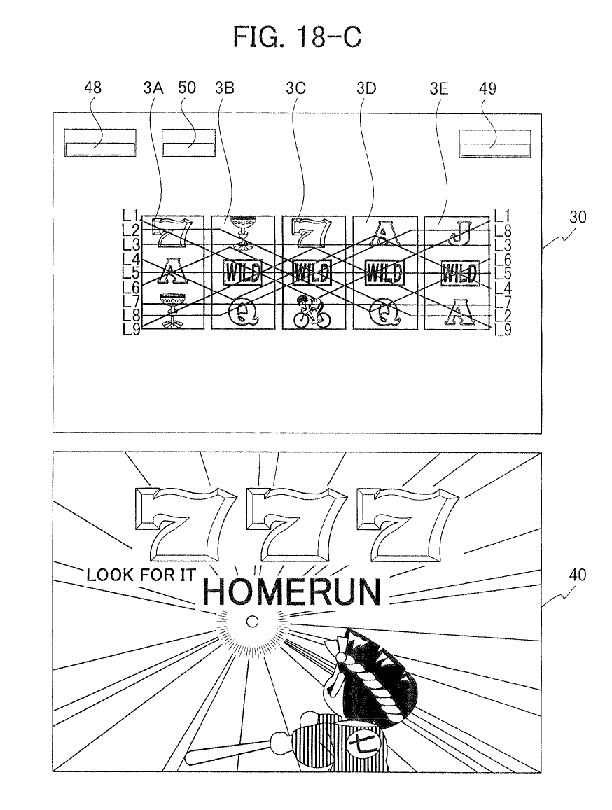

FIG. 18-B shows an example of a reel selection display screen displaying selectable reels displayed on the sub display of the gaming machine of a second embodiment of the present invention;

FIG. 19-B is a flowchart showing reel selection processing executed by a controller of the gaming machine of the second embodiment of the present embodiment;

FIG. 20A-B shows a display screen displayed during setting a reel on a sub display of the gaming machine of the second embodiment of the present invention; and

FIG. 20B-B shows a display screen displayed during setting a reel on a main display and a sub display of the gaming machine of the second embodiment of the present invention.

FIG. 1-C is a flowchart showing processing executed in the gaming machine according to an embodiment of the present invention;

FIG. 2-C is a perspective view showing the appearance of the gaming machine according to the embodiment of the present invention;

FIG. 3-C is an enlarged view illustrating a display area of the gaming machine shown in FIG. 2-C;

FIG. 4-C is a block diagram of a controller of the gaming machine shown in FIG. 2-C;

FIG. 5-C is a block diagram of a display/input controller of the gaming machine shown in FIG. 2-C;

FIG. 6-C is a partial exploded view showing a part of a sub display of the gaming machine shown in FIG. 2-C;

FIG. 7-C is a diagram showing a method of 3-dimensionally displaying a selectable reel on the sub display of the gaming machine shown in FIG. 2-C;

FIG. 8A-C shows a display screen of the sub display of the gaming machine shown in FIG. 2-C, which is, displayed 3-dimensionally from a point of view which is substantially 45 degrees diagonally backwards to the right from the display screen;

FIG. 8B-C shows a display screen of the sub display of the gaming machine shown in FIG. 2-C, which is displayed 3-dimensionally from a point of view which is substantially 45 degrees diagonally backwards to the left from the display screen;

FIG. 9-C shows symbol lines disposed on each video reel which are displayed during a game on a main display of the gaming machine shown in FIG. 2-C;

FIG. 10-C shows a symbol arrangement table used by the gaming machine shown in FIG. 2-C;

FIG. 11A-C shows an example of a reel selection display screen that displays selectable reels displayed on the sub display of the gaming machine shown in FIG. 2-C;

FIG. 11B-C shows a case in which a player selects a reel separately in a reel selection display screen displayed on a sub display of the gaming machine shown in FIG. 2-C;

FIG. 12A-C is a diagram showing a reel group that can be displayed on a sub display of the gaming machine shown in FIG. 2-C;

FIG. 12B-C illustrates a method for changing a reel that can be displayed on a sub display of the gaming machine shown in FIG. 2-C;

FIG. 13-C is a flowchart showing main processing operation executed by a controller of the gaming machine shown in FIG. 2-C;

FIG. 14-C is a flowchart showing reel display selection processing executed by the controller of the gaming machine shown in FIG. 2-C;

FIG. 15-C shows a display screen of a main display showing symbols after a winning determination and a display screen of a sub display showing symbols disposed on an opposite side of a reel displayed on the display screen of the main display;

FIG. 16A-C shows a reel display screen on a sub display of the gaming machine shown in FIG. 2-C;

FIG. 16B-C shows another reel display screen on a sub display of the gaming machine shown in. FIG. 2-C;

FIG. 17A-C is a diagram illustrating an image displayed during setting a reel on the sub display of the gaming machine shown in FIG. 2-C;

FIGS. 17B-C and 17C-C are diagrams illustrating an image displayed during setting a reel on the main display and on the sub display of the gaming machine shown in FIG. 2-C;

FIG. 17D-C is a diagram illustrating an image displayed during setting a reel on the main display of the gaming machine shown in FIG. 2-C; and

FIG. 18-C is a diagram illustrating an image for a specific visual effect on a reel, that is set, displayed on the main display and the sub display of the gaming machine shown in FIG. 2-C.

### DETAILED DESCRIPTION OF THE INVENTION

The descriptions below are directed to a gaming machine permitting a player to select reels, a gaming machine permitting a player to select reels during second game, and a gaming machine permitting a player to select reels after award is determined.

### 1. Gaming Machine Permitting Player To Select Reels

A description below is directed to a gaming machine permitting player to select reels.

A main part of the present invention is first described below. A gaming machine 15 of the invention is provided with memories 108, 110, 154 and 156 for storing image data of a plurality of reels each having a plurality of symbols arranged thereon, a first display (sub display) 40 for displaying a first reel group by using part of the image data of the plurality of reels stored in these memories, a second display (main display) 30 for displaying a second reel group used in a game by using part of the image data of the plurality of reels stored in these memories, an instruction input device 412 for inputting an instruction from a player, and a controller 100 for executing the following processing by using the image data of the plurality of reels stored in these memories (see FIGS. 2-A and 4-A).

As shown in FIG. 1-A, though a detailed description will be described later, the controller 100 displays a predetermined number of reel groups on the first display 40 (step S100), and judges whether a reel replacement instruction has been inputted by the instruction input device 412 (step S200). When it is judged that the reel replacement instruction has been inputted by the instruction input device 412, the controller 100 performs display by replacing at least some reels of the first reel group displayed on the first display 40 with other reels by using the image data of the plurality of reels stored in the memories (step S300). In response to a setting instruction inputted through the instruction input device 412 (step S400), the controller 100 sets, as a second reel group, at least some reel groups of the reel groups displayed on the first display 40, and displays them on the second display 30 (step S500), thus entering into a game (step S600).

By the foregoing processing, the player can select himself/herself symbols to be displayed on the reels used in the game so that the player's intention can be reflected on the reels and the symbols used in the game, enhancing the enthusiasm for the game.

By executing the abovementioned processing, since a player can select symbols displayed on the reel which the player uses in a game, the player's will can be reflected on the reels and symbols used in the game, which can increase the interest in game playing.

The embodiments of the present invention are hereinafter described in detail with reference to the attached drawings.

### First Embodiment

A gaming machine 15 of a first embodiment of the present invention is described with reference to FIGS. 2-A to 15-A. FIG. 2-A is a perspective view showing an external appearance of the gaming machine 15. As shown in FIG. 2-A, the gaming machine 15 includes a cabinet 20. The cabinet 20 has a structure in which a face facing the player is open. The cabinet 20 contains various components including a game controller 100 (see FIG. 4-A) for electrically controlling the gaming machine 15, and a hopper 44 (see FIG. 4-A) for controlling the insertion, storage, and payout of coins (being one type of game media), and the like. The game media is not restricted to coins. In addition, examples of such game media include medals, tokens, electronic money or electronic value information (credits) having the same value.

The main display 30 is installed substantially in the middle of the front face of the cabinet 20, and the sub display 40 is installed in an upper side of the cabinet 20. In the present embodiment, the main display 30 and the sub display 40 are configured as liquid crystal panels.

The main display 30 and the sub display 40 realize a display device for displaying a variety of images related to the game, including produced images and the like. Such a configuration allows the player to advance the game while visually confirming various kinds of images displayed on the aforementioned main display 30.

The gaming machine 15 is made up of image reels, and five virtual reels can be displayed on the main display 30. It should be noted that the term “video reel” as used here represents a mechanism for displaying a reel on the main display 30 in the form of an image instead of a mechanical reel. Multiple kinds of symbols necessary for a game include “BONUS,” “WILD,” “TREASURE BOX,” “GOLDEN MASK,” “HOLY CUP,” “COMPASS & MAP,” “SNAKE,” “A,” “K,” “Q,” “J,” and “10.” With such an arrangement, the main display 30 displays these symbols with an image as if the reel were rotating.

The other sub display 40 above the main display 30 is a display device functioning as a display for displaying the rules of the game, demonstration screens, and the like.

Sound permeable openings 29a and 29b, through which sound effects emitted from a speaker 41 (see FIG. 4-A) contained inside the cabinet 20 are propagated outside the cabinet 20, are disposed on the upper right and left sides of the sub display 40, respectively. The sound transmission openings 29a and 29b generate sound effects and the like in accordance with the progress of the game. Decorative lamps 42a and 42b are disposed on the right and left sides in the middle of the gaming machine 15, respectively. The decorative lamps 42a and 42b emit light in accordance with the progress of the game.

A substantially horizontal control panel 21 is provided below the main display 30. A coin insertion slot 22 is provided on the right side of the control panel 21 to insert coins into the gaming machine 15. On the other hand, the components provided to the left side of the control panel 21 include: a bet switch 23 that allows the player to determine which lines are to be set to active pay lines among nine lines L1, L2, L3, L4, L5, L6, L7, L8, and L9, for providing an award described later (which will simply be referred to as “active pay lines” hereafter), and which allows the player to select the amount of coins as game media that are to be bet on the aforementioned active pay lines; and a spin repeat bet switch 24 that allows the player to play the game again without changing the amount of coins bet on the aforementioned active pay lines from that in the immediately prior game. Such an arrangement allows the player to set the amount of coins bet on the active pay line by performing a pushing operation on either the bet switch 23 or the spin repeat bet switch 24.

In the control panel 21, a start switch 25 for accepting per game the player's operation of starting a game is disposed on the left side of the bet switch 23. Upon performing a pushing operation on either the start switch 25 or the spin repeat bet switch 24, which serves as a trigger to start the game, an image of the aforementioned five mechanical reels 3A to 3E starting to rotate is displayed.

A cash out switch 26 is provided near the coin insertion opening 22 on the control panel 21. Upon the player pushing the cash out switch 26, the inserted coins are paid out from a coin payout opening 27 provided at a lower portion of the front face. The coins thus paid out are retained in a coin tray 28.

FIG. 3-A is an enlarged top view of a display area configuring a game screen which is displayed on the main display 30 of the gaming machine 15 during a game. The gaming machine 15 includes lines L1 to L9 for providing nine awards as shown in FIG. 3-A. The lines L1 to L9 for providing each award extend so as to pass through a symbol on each of the image reels 3A to 3E when the spinning images of the 5 video reels 3A to 3E come to a stop.

When the abovementioned BET switch 23 is pressed once, for example, the line L3 for providing a third award, the line L5 for providing a fifth award, and the line L7 for providing a seventh award are set to be active pay lines, and one coin is consumed as a credit medal.

Furthermore, upon pushing the aforementioned bet switch 23 twice, the line L1 for providing a first award, the line L4 for providing a fourth award, and the line L8 for providing an eighth award, are set to be active pay lines, in addition to the aforementioned three lines, and two coins are consumed as credit medals, for example.

Moreover, upon pushing the aforementioned bet switch 23 three times, the line L2 for providing a second award, the line L6 for providing a sixth award, and the line L9 for providing a ninth award are set to be active pay lines, in addition to the aforementioned six lines, and three coins are input as credit medals, for example.

The game available in the present embodiment is a game in which a predetermined set of symbols are made along the active pay lines.

In addition, it is arranged so that a payout number display portion 48, a bet number display portion 50, and a credit number display portion 49 can be displayed in this order from the left side on the upper portion of the main display 30. The payout display portion 48 is a component for displaying the amount of the coins paid out when a specific combination of the symbols for providing an award has been achieved along any one of the active pay lines. The credit number display portion 49 displays the credit amount of coins stored in the gaming machine 15. The bet number display portion 50 is a component for displaying the bet amount, which is the amount of coins bet on the aforementioned active pay lines.

FIG. 4-A is a block diagram showing an electric configuration of the game controller of the gaming machine 15. Referring to FIG. 4-A, the game controller 100 of the gaming machine 15 is a microcomputer and is provided with an interface circuit group 102, an input/output bus 104, a CPU 106, ROM 108, RAN 110, an interface circuit 111 for communication, a random number generator 112, a speaker drive circuit 122, a hopper drive circuit 124, a lamp drive circuit 126, and a display/input controller 140.

The interface circuit group 102 is electrically connected with the input/output bus 104, which carries out input and output of data signals or address signals for the CPU 106.

The start switch 25 is electrically connected with the interface circuit group 102. In the interface circuit group 102, a start signal generated by the start switch 25 is converted into a predetermined form of signal to be supplied to the input/output bus 104.

Furthermore, the bet switch 23, the spin repeat bet switch 24, and the cash out switch 26 are connected to the interface circuit group 102. Each of the switching signals output from these switches 23, 24, and 26 is also supplied to the interface circuit group 102, and is converted into a predetermined signal by the interface circuit group 102. The switching signals thus converted are supplied to the input/output bus 104.

A coin sensor 43 is also electrically connected with the interface circuit group 102. The coin sensor 43 detects coins inserted into the coin insertion slot 22, and is disposed at an appropriate position relative to the coin insertion slot 22. The sensing signal output from the coin sensor 43 is also supplied to the interface circuit group 102, and is converted into a predetermined signal by the interface circuit group 102. The sensing signal thus converted is supplied to the input/output bus 104.

The ROM 108 and the RAM 110 are connected to the input/output bus 104.

Upon accepting the start operation of a game by way of the start switch 25, the CPU 106 reads a game program to execute the game. The game program executes an image starting scrolling of the symbols on the five video reels is provided on the main display 30 via the display/input controller 140, and then an image for stopping the five video reels is displayed so as to rearrange the symbols on the five video reels. If that combination of symbols stopped is displayed on the active pay lines and the combination corresponds to a specific combination for which an award is provided, the number of coins associated with the specific combination is paid out.

The ROM 108 stores a control program for governing and controlling the gaming machine 15, a program for executing routines as shown in FIGS. 8-A to 10-A (hereinafter referred to as a “routine execution program”), and initial data for executing the control program, and various data tables used in decision processing. The routine execution program includes the abovementioned game program. As an example of the data tables, a table as shown in FIG. 10-A can be exemplified. The RAM 110 temporarily stores a plurality of reels and symbol groups provided on each of the plurality of reels displayed on the main display 30, a plurality of selectable reels and symbol groups provided on each of the plurality of reels displayed on the sub display 40, a data table including a symbol arrangement table, and a flag, a variable, and data used in the control program.

Furthermore, a communication interface circuit 111 is connected to the input/output bus 104. The communication interlace circuit 111 is a circuit for communicating with a controller for an external control unit (not shown), etc. via the network including various types of networks.

The random number generator 112 for generating a random number is connected to the input/cutout bus 104. The random number generator 112 generates random numbers in a predetermined range of “0” to “65535” (the sixteenth power of two minus one), for example. Alternatively, an arrangement may be made in which the CPU 106 generates a random number by computation.

The speaker drive circuit 122 for the speakers 41 is also electrically connected with the input/output bus 104. The CPU 106 reads the sound data stored in the ROM 100, and transmits the sound data thus read to the speaker driving circuit 122 via the input/output bus 104. In this way, the speakers 41 generate predetermined sound effects.

The hopper drive circuit 124 for driving the hopper 44 is also electrically connected with the input/output bus 104. Upon receiving a cash out signal input from the cash out switch 26, the CPU 106 transmits a driving signal to the hopper driving circuit 124 via the input/output bus 104. Accordingly, the hopper 44 pays out coins such that the amount thereof is equivalent to the current number of coins remaining as credits, which is stored in a predetermined memory area of the RAM 110.

Alternatively, the payout of the coins may be performed in a mode of storing credit data in a data card or the like, instead of using physical coins. That is, the player may carry a card functioning as a recording medium, and store the data related to the credits by inserting the card into the gaming machine 15.

The lamp drive circuit 126 for driving the decorative lamps 42a and 42b is also connected with the input/output bus 104. The CPU 106 transmits the signal for driving the lamps according to the predetermined conditions based on the program stored in the ROM 108 to the lamp driving circuit 126. In this way, decorative lamps 42a and 42b blink and the like.

The display/input controller 140 is connected to the input/output bus 104. The CPU 106 creates an image display command corresponding to the state and results of the game, and outputs the image display command thus created to the display/input controller 140 via the input/output bus 104. Upon receiving the image display command input from the CPU 106, the display/input controller 140 creates a driving signal for driving the main display 30 and the sub display 40 according to the image display command thus input, and outputs the driving signal thus created to the main display 30 and the sub display 40. As a result, a predetermined image is displayed on the main display 30 and the sub display 40. In addition, the gaming machine 15 includes a touch panel 412 on a surface of the sub display 40. The touch panel 412 accepts an input by a player corresponding to the player's pushing location and pushing duration, and outputs the input signal generated by the player's input to the CPU 106 via the input/output bus 104. In addition, the image display command includes commands corresponding to a payout number display portion 403, a credit number display unit portion, and a bet number display portion 50.

FIG. 5-A is a block diagram showing an electric configuration of a display/input controller 140 of the gaming machine 15. The display/input controller 140 of the gaming machine 15 is a sub-micro computer which performs image display processing and the control of input from the touch panel 412, and which has an interface circuit 142, an input/output bus 144, a CPU 146, ROM 148, RAM 150, a VDP 152, video RAM 154, ROM 156 for image data, a drive circuit 158 and a touch panel control circuit 160.

The interface circuit 142 is connected to the input/output bus 144. The image display command outputted from the CPU 106 on the game controller 100 is supplied to the input/output bus 144 via the interface circuit 142. The input/output bus 144 performs input/output of data signals or address signals to and from the CPU 146.

The ROM 148 and the RAM 150 are connected to the input/output bus 144. The ROM 148 stores a display control program under which a drive signal to be supplied to the main display 30 and the sub display 40 is generated based on the image display instruction from the CPU 106 on the game controller 100. On the other hand, the RAM 150 stores flags and variables used in the aforementioned display control program.

The VDP 152 is connected to the input/output bus 144. The VDP 152 includes a so-called sprite circuit, a screen circuit, a palette circuit, etc., and can perform various types of processing for displaying images on the main display 30 and the sub display 40. The video RAM 154 and the ROM 156 are connected to the VDP 152. The video RAM 154 stores image data based on the image display instructions from the CPU 106 on the game controller 100. The ROM 156 for image data stores various kinds of image data containing the abovementioned produced image data, symbols for 3-D display (described later) and the like. Furthermore, the driving circuit 158 for outputting a driving signal for driving the main display 30 and the sub display 40 is connected to the VDP 152.

By reading and executing the display control program stored in the ROM 148, the CPU 146 instructs the video RAM 154 to store image data to be displayed on the main display 30 and the sub display 40 in response to the image display instruction from the CPU 106 on the game controller 100. Examples of the image display commands include various kinds of image display commands including the aforementioned image display commands for visual effects, etc.

The image data ROM 156 stores various kinds of image data including the image data that provides visual effects.

The touch panel control circuit 160 outputs the signals inputted via the touch panel 412 provided on the sub display 40 to the CPU 106 via the input/output bus 144 in the form of an input signal.

FIG. 6-A is an exploded perspective view showing a configuration of a portion of the sub display 40. The sub display 40 functions as a first display for displaying selectable reels during selection of reels. For this reason, the sub display 40 includes: a front panel 411 having a touch panel 412 and a display plate 413; a transparent liquid crystal panel 414; a light-introducing plate 415; a reflecting film 416; fluorescent lamps 417A and 417B, which serve as a so-called white light source; and a Table Carrier Package (TCP) mounting ICs for driving the transparent liquid crystal panel. In addition, it should be noted that, although riot shown in FIG. 5-A, it may be possible for the TCP to include a flexible printed board (not shown) connected with terminals of the transparent liquid crystal panel 414. The touch panel 412 is formed of a transparent member. The display plate 413 is formed of a transparent member.

A way of displaying selectable reels displayed on the sub display 40 is described with reference to FIGS. 7-A, 8A-A, and 8B-A. Selectable reels are displayed 3-dimensionally on the sub display 40 in the present embodiment. FIG. 7-A is a diagram illustrating a method of displaying selectable reels 3-dimensionally on the sub display 40. Using two virtual cameras 501A and 501B, a plurality of reels 401 to 407 represented using a local coordinate system (x, y, z) are displayed on the sub display 40 in such a manner that perspective transformation is performed for a virtual 3-dimensional space on a world coordinate system (X′, Y′, Z′) and (X″, Y″, Z″) so that each axis of the local coordinate system is at a predetermined angle (in the present embodiment, substantially 45 degrees) to each axis of the world coordinate system. Examples of the 3-dimensional images thus generated are shown in FIGS. 8A-A and 8B-A. FIG. 8A-A is a display screen on the sub display 40 in which the plurality of reels 401 to 407 that the player can select are displayed 3-dimensionally with a point of view which is substantially 45 degrees diagonally backwards to the right from the display screen. FIG. 83-A is a display screen on the sub display 40 in which the plurality of reels 401 to 407 that the player can select are displayed 3-dimensionally with a point of view which is substantially 45 degrees diagonally backwards to the left from the display screen. Accordingly, perspective transformation and a point of view from the virtual cameras are important to display the plurality of reels in three dimensions with a plurality of points of view.

A way of displaying the selectable reels 3-dimensionally is described in detail with reference to FIG. 7-A. The virtual cameras 501A and 501B disposed in the virtual 3-dimensional space projects images of the plurality of reels with a point of view which is substantially 45 degrees diagonally backwards to the right from the display screen (see FIG. 8A-A) and images of the plurality of reels with a point of view which is substantially 45 degrees diagonally backwards to the left from the display screen (see FIG. 8B-A) on the virtual screens 510A and 5103, respectively. The positions of the virtual cameras 501A and 501B decide the points of view 503A and 503B, respectively. The directions of the virtual cameras 501A and 501B decide axes of vision 500A and 5003, respectively. Each of the points of view 503A and 503B decides angles of vision 505A and 505B, each of which consists of two lines connecting apexes of opposing corners of the virtual screens 510A and 501B. Here, the coordinate system of the virtual screen 510A is called a point of view coordinate system (X′, Y′, Z′) and the coordinate system of the virtual screen 510B is called a point of view coordinate system (X″, Y″, Z″), and a Z′ axis and a Z″ axis in the coordinate system are in the direction of the axes of vision 500A and 500B. Here, the coordinate of the world coordinate system including the coordinate converted from the coordinate of the local coordinate system is converted to the coordinate of the point of view coordinate system, and then perspective transformation for the coordinate of the point of view coordinate system is performed. An axis of vision 404 is in the direction of a symbol located substantially at the center of each reel. In a case in which each reel is moved, the axis of vision 404 may move, for example, from the direction of the positions 401a and 402a to the positions 401b and 402b so as to face the direction of the symbol located substantially at the center. It should be noted that a stereoscopic effect is enhanced further using, for example, texture mapping processing for the selectable reels displayed on the sub display 40. The image data ROM 156 stores image data thus generated in regards to the plurality of points of view for each video reel, and the CPU 106 rewrites image data of the plurality of selectable reels stored in the video RAM 154 and displayed on the sub display 40 as appropriate based on image data stored in the image data ROM 156. In addition, the way of displaying the selectable reels 3-dimensionally used in the present embodiment is described as an example, and thus the present invention is not limited thereto. For one skilled in the art, there may be various conceivable techniques possible that are evident. In addition, although cases of displaying on the sub display 40 at a point of view which is substantially 45 degrees diagonally backwards to the left or substantially 45 degrees diagonally backwards to the right from the display screen have been described, the number of points of view that can be displayed and the angles thereof on the sub display 40 may be varied as appropriate.

FIG. 9-A is a diagram showing symbol lines disposed on each video reel which are displayed during games on the main display 30 of the gaming machine 15 of the present embodiment. FIG. 9-A shows symbol lines on which 21 symbols arranged on each video reel 3A to 3E (see FIG. 3-A) are represented. The symbol line for the first video reel corresponds to the video reel 3A. The symbol line for the second video reel corresponds to the video reel 3B. The symbol line for the third video reel corresponds to the video reel 3C. The symbol line for the fourth video reel corresponds to the video reel 3D. The symbol line for the fifth video reel corresponds to the video reel 3E. When each video reel 3A to 3E rotates around a virtual rotational axis, these symbols appear in the order depicted in FIG. 9-A.

As shown in FIG. 9-A, a code number of “00” to “20” is referred to for each symbol of video reels 3A to 3E. These code numbers are converted to be data in a data table so as to be stored in the aforementioned ROM 108 and RAM 110 (see FIG. 4-A).

The column of symbols is represented on the image reels 3A to 3E, respectively. More specifically, the column of symbols is made up of a “BONUS” symbol (symbol 61) (hereinafter abbreviated as “BONUS”), a “FLAG” symbol (symbol 62) (hereinafter abbreviated as “FLAG”), a “TREASURE BOX” symbol (symbol 63) (hereinafter abbreviated as “TREASURE BOX”), a “GOLDEN MASK” symbol (symbol 64) (hereinafter abbreviated as “GOLDEN MASK”), a “HOLY GRAIL” symbol (symbol 65) (hereinafter abbreviated as “HOLY GRAIL”), a “COMPASS&MAP” symbol (symbol 66) (hereinafter abbreviated as “COMPASS&MAP”), a “SNAKE” symbol (symbol 67) (hereinafter abbreviated as “SNAKE”), an “A” symbol (symbol 68) (hereinafter abbreviated as “A”), a “K” symbol (symbol 69) (hereinafter abbreviated as “K”), a “Q” symbol (symbol 70) (hereinafter abbreviated as “Q”), a “J” symbol (symbol 71.) (hereinafter abbreviated as “J”), a “10” symbol (symbol 72) (hereinafter abbreviated as “10”), a “RACE CHARACTER 1” (symbol 73) (hereinafter abbreviated as “RACE CHARACTER 1”), and a “RACE CHARACTER 2” (symbol 74) (hereinafter abbreviated as “RACE CHARACTER 2”). The columns of symbols on the image reels 3A to 3E can be moved by the display of an image where the reels 3A to 3E are spinning in a forward direction. In addition, in the present embodiment, “FLAG” is provided on the first video reel alone.

In the present embodiment, “BONUS,” “SECOND,” “SNAKE,” “TREASURE BOX,” “GOLDEN MASK,” “HOLY CUP” “COMPASS & MAP,” “A,” “K,” “Q,” “J,” and “10” are provided as hands in awarding a predetermined winning. A combination (combination data) is control information which relates credits awarded to a player (the payout amount of coins) to a combination of an award combination, and which is used for stop control of each video reel 3A to 3E, changing (shift) of a game state, providing coins, and the like.

FIG. 10-A is a diagram showing a symbol arrangement table used by the gaming machine 15 of the present embodiment. The symbol arrangement table relates the code number indicating the position of each symbol which constitutes the aforementioned symbol lines to each symbol of the respective video reels 3A to 3E, and then registers thereof. In addition, the first through the fifth video reels correspond to the video reels 3A to 3E, respectively. In other words, the symbol arrangement table includes symbol information corresponding to the symbol position (the code number) of video reels 3A to 3E (see FIG. 3-A).

In FIG. 10-A, “TREASURE,” “MASK,” “COMPASS,” “CHARACTER 1” and “CHARACTER 2” are abbreviations for the abovementioned “TREASURE BOX,” “GOLDEN MASK,” “COMPASS&MAP,” “CHARACTER 1” and “CHARACTER 2,” respectively.

FIG. 11A-A shows an example of a reel selection display screen that displays selectable reels displayed on the sub display 40. As described above, in the present embodiment, the number of reels displayed on the main display 30 during games is five, and the number of selectable reels displayed on the sub display 40 is seven. However, the present invention is not limited to the abovementioned configuration. For example, the number of selectable reels displayed on the sub display 40 may be the same as that of reels displayed on the main display 30. FIG. 11B-A shows replaceable reels that can be displayed on the sub display 40 by a player's operation. In the present embodiment, the number of selectable reels that can be displayed on the sub display 40 by a player's operation is ten. As with the video reels shown in FIG. 9-A, each symbol line with each code number is arranged on the video reels 401 to 410 that can be displayed on the sub display 40. These code numbers are converted to be data in a data table so as to be stored in the abovementioned ROM 108 and the RAM 110 (see FIG. 4-A) along with the symbol arrangement table as shown in FIG. 10-A. As shown in FIG. 11B-A, the plurality of selectable reels are stored in a way that each reel is adjacent each other.

As shown in FIG. 11A-A, on the sub display 40, up-pointing and down-pointing arrows are displayed on each of the selectable reels 401 to 407. In addition, right-pointing and left-pointing arrows are displayed on the reels 401 and 407, which are located at both ends. Since the sub display 40 includes the touch panel, the player can change the images of the selectable reels 401 to 407 in the direction of the arrows by pushing the arrows on the touch panel. For example, when the player pushes an up-pointing arrow A of the reel 401, the reel 401 rotates in the up direction around the rotational axis. At this time, the symbol “J” on the reel 401 disappears and the symbol “A” on the reel 401 appears (see FIGS. 9-A and 10-A). Similarly, when the player pushes a down-pointing arrow B of the reel 401, the reel 401 rotates in the down direction around the rotational axis. At this time, the symbol “TREASURE BOX” disappears on the reel 401 and the symbol “MASK” appears on the reel 401 (see FIGS. 9-A and 10-A).

In addition, as shown in FIG. 11B-A, when the player pushes the arrow C, the reels 401 to 410, which can be displayed on the sub display 40, rotate in a clockwise direction. Thus, the reels 401 to 407 that can be displayed move to the left side along the axial direction of the reels. Then, the reel 401 disappears to the left side and the reel 407 appears in the right side. Similarly, when the player pushes the arrow D, the reels 401 to 410, which can be displayed on the sub display 40, rotate in a counterclockwise direction. Thus, the reels 401 to 407 that can be displayed move to the right side along the axial direction of the reels. Then, the reel 407 disappears to the right side and the reel 401 appears on the left side.

In addition, a button L shown by E, a button R shown by F, and a determination button shown by G are displayed at the lower left portion and the lower right portion of the display screen, which displays the selectable reels 401 to 407 on the sub display 40. Since the sub display 40 includes a touch panel, the player can input various commands to the gaming machine 15 by pushing these buttons. When the player pushes the button L, the selectable reels 401 to 407 are displayed 3 dimensionally from a point of view which is substantially 45 degrees diagonally backwards to the right from the display screen, as shown in FIG. 83A-A. On the other hand, when the player pushes the button R, the selectable reels 401 to 407 are displayed 3-dimensionally from a point of view which is substantially 45 degrees diagonally backwards to the right from the display screen, as shown in FIG. 8B-A. When the player pushes the determination button G, a reel group, which is located at the center among the reel groups currently being displayed, is determined as a reel group used in a game. In addition, when pushing the determination button G immediately after pushing a reel separately among the selectable reels 401 to 407, the reel is highlighted. When the player pushes the determination button G again, the reel is released from being highlighted. In addition, in a case in which a reel is highlighted separately, even when the player pushes the determination button G, the reel is not determined as a reel used in a game. The reel highlighted remains at the same location on the selection display screen, even when the arrow C or D is pushed. Thus, the selectable reels 401 to 407 can be replaced collectively or can be replaced separately.

Thus, since the abovementioned configuration can improve the visibility of reels and can reflect the player's will on the reel-s and symbols used in games, it can increase the player's interest in game playing.

FIG. 12-A is a flowchart showing processing operation executed by the controller 100 of the gaming machine 15. FIG. 13-A is a flowchart showing reel selection processing in detail among the main processing operations executed by the controller 100 of the gaming machine 15. FIGS. 14A-A to 15-A are a diagram illustrating images displayed on the sub display 40 and the main display 3( when the reel selection processing is executed. A single routine shown in FIGS. 12-A and 13-A is equal to a single unit game.

It should be noted that the gaming machine 15 is activated in advance and the variables used in the CPU 106 on the game controller 100 are initialized to predetermined values, respectively, thereby providing a stationary state of the gaming machine 15.

Firstly, a general description of the main processing operation executed by the controller 100 of the gaming machine 15 is described with reference to FIG. 12-A.

In Step S1, the CPU 106 on the game controller 100 determines whether a certain amount of credits remains, which is the number of remaining coins inserted by the player. More specifically, the CPU 106 reads the amount of credits C stored in the RAM 110, and executes processing according to the amount of credits C. When the amount of credits C equals “0” (in the case of a “NO” determination by the processing of Step S1), the CPU 106 terminates the routine without executing any processing, since it cannot start a game. When the amount of credits C is not less than “1” (in the case of a “YES” determination by the processing of Step S1), the CPU 106 determines that coins remain as credits, and the CPU 106 moves the processing to Step S2.

In Step S2, the CPU 106 performs a reel selection processing. The CPU 106 then moves the processing to Step S3. This processing is described later.

In Step S3, the CPU 106 sets a game condition. More specifically, the CPU 106 determines the amount of coins bet on the active pay lines in this game based on the operation of the bet switch 23. At this time, the CPU 106 determines the bet amount to be bet on the active pay lines based on the number of times signals that indicate operation of the bet switch 23 have been received, and stores the bet amount thus determined in a predetermined memory area of the RAM 110. The CPU 106 reads the amount of credits C stored in a predetermined memory area of the RAM 110, and subtracts the total bet amount, which is the sum of the aforementioned bet amounts, from the amount of credits C thus read. Then, the CPU 106 stores the subtracted value in a predetermined memory area of the RAM 110. Subsequently, the CPU 106 moves the processing to Step S4.

In the following Step S4, the CPU 106 determines whether the start switch 25 is ON, and then waits for the start switch 35 to be operated. Upon the start switch 25 being operated, and accordingly upon the operation signal being input from the start switch 25 (in a case of a “YES” in the determination processing in Step S4), the CPU 1(06 determines that the start switch 25 has been operated, and the flow proceeds to Step S5.

In the following Step S5, the CPU 106 performs stationary symbol determination processing. A specific description is made below regarding the stationary symbol determination processing.

First, the CPU 106 selects a random number in a range of values from 0 to 255 for each of the five reels 3A to 3E by extracting a random number from the random generator 112. Next, the CPU 106 reads payout rate setting data from the ROM 108 to store in the RAM 110, refers to symbol weighting data corresponding to the payout rate setting data, and determines code numbers (see FIG. 9-A) for each of the reels 3A to 3E based on the five random numbers thus selected. The code number selected for each reel 22 corresponds to the symbol code number of the symbol which is to be rearranged along the pay line. The CPU 106 determines the code numbers for each of the reels 3A to 3E, thereby determining a winning combination. For example, in a case where the CPU 106 determines that the code numbers for each of the reels 3A to 3E are “20,” “20,” “20,” “20,” and “20,” it indicates that the CPU 106 has determined that the winning combination is “BONUS”. In addition, in a case where three or more identical symbols are rearranged on the active pay line, a winning combination corresponding to the rearranged symbol is achieved. In addition, regarding “BONUS,” in a case in which at least three “BONUS” symbols are rearranged, regardless of the active pay lines, its winning combination may be determined as “BONUS”.

Upon determining stationary symbols, the CPU 106 causes the specific combination data, which indicates the stationary symbols thus determined, to be stored in the predetermined memory area of RAM 110. Then, the CPU 106 reads the random number value and the specific combination data stored in the predetermined memory area of the RAM 110 and determines the combination of the symbols to be displayed to be stationary based upon the random number value and the specific combination data thus read. In this stage, a symbol arrangement table stored in the ROM 108 is read by the CPU 106. The symbol arrangement table thus read is stored in a predetermined memory area of the RAM 110, and used as reference data. The CPU 106 causes the stationary symbol combination data, which indicates the stationary symbol combination thus determined, to be stored in a predetermined memory area of the RAM 110. Alternatively, it may be configured that a stationary symbol for each reel is determined using the random number table.

Upon determining the combination of the symbols when stationary with respect to the aforementioned active pay lines, the CPU 106 determines whether the combination of the symbols when they are stationary with respect to the active pay lines matches any one of the specified combinations for providing an award. In a case where the combination of the symbols when they are stationary with respect to the active pay lines matches any one of the specified combinations for providing an award, the CPU 106 activates a flag, which indicates that the player has won the award that corresponds to the kind of specified combination for providing an award, in order to provide the award that corresponds with the specified combination of symbols with respect to the active pay lines for providing the award. The activated flag, which indicates the player has won an award, is stored in a predetermined area of the RAM 110 according to the instruction from the CPU 106. On the other hand, in a case where the combination of the symbols when they are stationary with respect to the active pay lines matches any one of the other combinations, i.e. losing combinations, the CPU 106 does not activate the flag which indicates that the player has won an award. Subsequently, the CPU 106 moves the processing to Step S6.

In the following Step S6, the CPU 106 instructs the video reels 3A through 3E to start to rotate. More specifically, the CPU 106 displays an image which shows rotating the video reels 3A to 3E, in sequence or simultaneously, based upon the symbol arrangement table stored in the aforementioned RAM 110.

Upon displaying the image showing the video reels 3A to 3E starting to rotate, the CPU 106 waits for a predetermined period of time to elapse. After the predetermined period of time has elapsed, the CPU 106 instructs the video reels 3A to 3E to automatically stop rotating (Step S7). More specifically, the CPU 106 displays an image showing the video reels 3A to 3E stopping rotation in sequence such that the stationary symbols, which correspond to the specific combinations for providing an award determined in the aforementioned Step S5, are displayed within a display region that has a visually interactive relationship with the player. Subsequently, the CPU 106 moves the process to Step S18.

In the following Step S8, the CPU 106 determines whether or not a predetermined symbol combination has been formed based upon the results of the stationary symbol determination processing in Step S5. More specifically, the CPU 106 makes this determination based upon the state of the flag that indicates whether the player has won an award with respect to the active pay lines stored in the predetermined memory area of the aforementioned RAM 110. In a case where the flag, which indicates that the player has won an award, has not been activated, i.e. in a case where the specific symbol combination matches any one of the “other” combinations, which are combinations other than the specified combinations for providing an award (in a case of a “NO” in the determination processing in Step S8), the CPU 106 determines that the specific combination for providing an award has not been formed, and ends this routine. On the other hand, in a case where the flag, which indicates that the player has won an award, has been activated, i.e. in a case where the symbol combination matches any one of the combinations other than the “other” combinations (in a case of a “YES” in the determination processing in Step S9), the flow proceeds to Step S9 according to the instruction from the CPU 106.

In a case where the flow has proceeded to Step S9, the CPU 106 pays out an amount of coins corresponding to the specific combination for providing the abovementioned award by way of the stationary symbol determination processing in Step S5. More specifically, the CPU 106 refers to a payout table and calculates a payout number of coins corresponding to this specific combination for providing the award. The CPU 106 reads the credit amount stored in the aforementioned predetermined memory area of the RAM 110. Then, the CPU 106 calculates the sum total amount of coins to be paid out thus calculated and the credit amount thus read, and stores the sum thus calculated in a predetermined memory area of the RAM 110. The CPU 106 displays the aforementioned value thus stored on the credit number display portion 49. Subsequently, the CPU 106 terminates the present routine.

Reel selection processing is described in detail with reference to FIGS. 13-A to 15-A.

In Step S101, the CPU 106 on the game controller 100 displays a predetermined number of reels on the sub display 40. More specifically, the CPU 106 displays a plurality of selectable reels stored in the RAM 110, as well as symbol groups disposed on each of the plurality of reels (see FIG. 11A-A). Subsequently, the CPU 106 moves the processing to Step S102.

In Step S102, the CPU 106 determines whether or not a reel selection instruction has been inputted. If the judgment result is “YES”, the processing advances to Step S103, and if it is “NO”, the processing advances to Step S42. More specifically, upon the arrow C or D on the touch panel 412 of the sub display 40 being pushed, and accordingly upon the signal from the touch panel 412 being input, the CPU 106 determines that the reel selection instruction has been inputted, and the flow proceeds to Step S103. When the CPU 106 determines that the reel selection instruction was not inputted, the flow proceeds to Step S104.

In Step S103, the CPU 106 moves a reel on the sub display 40 in the direction of the rotational axis so as to replace a reel. More specifically, the CPU 106 determines whether the arrow C or the arrow D has been pushed based on the input signal from the touch panel 412. In a case where the CPU 106 determines that the arrow C has been pushed, the CPU 106 rewrites the plurality of selectable reels displayed on the sub display 40 that are stored in the RAM 110, the symbol groups disposed on each of the plurality of reels, the symbol arrangement table, and the like. Then, as shown in FIG. 11B-A, the CPU causes the reels 401 to 410, which can be displayed on the sub display 40, to rotate in a clockwise direction. Thus, the selectable reels 401 to 407 move to the left side along the axial direction of the reels, and then the reel 401 disappears to the left side and the reel 408 appears on the right side. In addition, in a case where the CPU 106 determines that the arrow D has been pushed, the CPU 106 rewrites the plurality of selectable reels displayed on the sub display 40 that are stored in the RAM 110, the symbol groups disposed on each of the plurality of reels, the symbol arrangement table, and the like. Then, as shown in FIG. 11B-A, the CPU causes the reels 401 to 410, which can be displayed on the sub display 40, to rotate in a counterclockwise direction. Thus, the reels 401 to 407 that can be displayed move to the right side along the axial direction of the reels. Then, the reel 407 disappears to the right side and the reel 401 appears on the left side.

In Step S104, the CPU 106 determines whether or not the reel rotation instruction has been inputted. If the judgment result is “YES,” the processing advances to Step S105, and if it is “NO,” the processing advances to Step S106. More specifically, upon the up-pointing arrow or the down-pointing arrow on the touch panel 412 of the sub display 40 being pushed, and accordingly upon the signal from the touch panel 412 being input, the CPU 106 determines that the reel rotation instruction was inputted, and the flow proceeds to Step S105. In a case where the CPU 106 determines that the reel rotation instruction was not inputted, the flow proceeds to Step S106.

In Step S105, the CPU 106 displays the reels rotating around the rotational axis on the sub display 40. More specifically, the CPU 106 determines the up-pointing arrow or the down-pointing arrow pushed based on a signal inputted from the touch panel 412, and causes the corresponding reels to rotate. For example, when the player pushes the up-pointing arrow A of the reel 401, and accordingly the signal from the touch panel 412 is inputted, the CPU 106 rewrites the plurality of selectable reels displayed on the sub display 40 that are stored in the RAM 110, the symbol groups disposed on each of the plurality of reels, the data related to the reel 401 from the symbol arrangement table, and the like. Then, the CPU causes the reels 401 to rotate in an upper direction around the rotational axis. Similarly, when the player pushes the down-pointing arrow B of the reel 401, and accordingly the signal from the touch panel 412 is inputted, the CPU 106 rewrites the plurality of selectable reels displayed on the sub display 40 that are stored in the RAM 110, the symbol groups disposed on each of the plurality of reels, the data related to the reel 401 from the symbol arrangement table, and the like. Then, the CPU causes the reels 401 to rotate in a lower direction around the rotational axis.

In Step S106, the CPU 106 determines whether or not a reel viewpoint changing instruction has been inputted. If the judgment result is “YES,” the processing advances to Step S107, and if it is “NO,” the processing advances to Step S108. More specifically, upon the button L or R on the touch panel 412 of the sub display 40 being pushed, and accordingly upon the signal from the touch panel 412 being input, the CPU 106 determines that the reel viewpoint changing instruction has been inputted, and the flow proceeds to Step S107. In a case where the CPU 106 determines that the reel viewpoint changing instruction has not been inputted, the flow proceeds to Step S108.

In Step S107, the CPU 106 changes a reel viewpoint of the sub display 40. More specifically, the CPU 106 determines whether the button L or R was pushed based on the signal inputted from the touch panel 412. In a case where the CPU 106 determines that the button L was pushed, the CPU 106 rewrites, for example, image data of the plurality of selectable reels displayed on the sub display 40 that is stored in the video RAM 154 based on image data stored in the image ROM 156 and, as shown in FIG. 8A-A, displays the image data 3-dimensionally from a point of view which is substantially 45 degrees diagonally backwards to the left from the display screen. Similarly, in a case where the CPU 106 determines that the button R has been pushed, the CPU 106 rewrites, for example, image data of the plurality of selectable reels displayed on the sub display 40 that is stored in the video RAM 154 based on image data stored in the image ROM 156 and, as shown in FIG. 85-A, displays the image data 3-dimensionally from a point of view which is substantially 45 degrees diagonally backwards to the left from the display screen.

In Step S108, the CPU 106 determines whether or not a reel setting instruction has been inputted. If the judgment result is “YES,” the processing advances to Step S109, and if it is “NO,” the processing advances to Step S102. More specifically, upon the determination button G on the touch panel 412 of the sub display 40 being pushed, and accordingly upon the signal from the touch panel 412 being input, the CPU 106 determines that the reel setting instruction was inputted, and the flow proceeds to Step S109. In a case where the CPU 106 determines that the reel setting instruction has not been inputted, the flow proceeds to Step S102. In addition, when the player pushes the determination button G after pushing the selectable reel separately, the reel is highlighted, but the CPU 106 does not determine that the reel setting instruction has been inputted, and moves the processing to Step S102. The reel highlighted remains the same location on the selection display screen even when the arrow C or D is pushed. As described above, the plurality of selectable reels 401 to 410 as shown in FIG. 11B-A are stored in the RAM 110 in a way in which each reel is adjacent to each other. However, the highlighted reel is moved outside from the circle of the selectable reels until the determination button G is pushed again. Thus, by pushing the arrow C or D while a specific reel is highlighted, the arrangement of the plurality of reels 401 to 410, which are arranged adjacent to each other and stored in the RAM 110 as well as the symbol arrangement table, can be changed.

In Step S109, the CPU 106 displays the reel selected on the main display 30. More specifically, the CPU 106 rewrites, for example, image data of the plurality of selectable reels displayed on the sub display 40 and the main display 30 that is stored in the video RAM 154 based on image data stored in the image ROM 156, and executes the following rendered effects. Firstly, as shown in FIG. 14A-A, the reels 401A and 407S at both ends among the selectable reel groups 401S to 407S are darkened, and the reel groups 402S to 406S, which are located at the center, are highlighted as the reels that are set. Next, the reel groups 402S to 406S located at the center are displayed to be enlarged, as shown in FIG. 14B-A. In addition, the image of the reel groups 402S to 406S are moved in a lower direction, as shown in FIG. 14-A. Then, the image of the reel groups 402S to 406S are moved from the sub display 40 to the main display 30, and displayed solely on the main display 30, as shown in PIG. 14D-A. In addition, the CPU 106 rewrites the plurality of reels stored in the RAM 110 and displayed on the main display 30, symbol groups disposed on each of the plurality of reels, a symbol arrangement table, and the like. The CPU 106 moves the processing to Step S110.

In Step S110, rendered effects are displayed on the sub display 40. More specifically, after the CPU 106 rewrites the plurality of reels displayed on the main display 30 that are stored in the RAM 110 and data related to the symbol groups disposed on each of the plurality of reels to data corresponding to the reel groups 402S to 406S, as shown in FIG. 5-A, the CPU 106 rewrites image data displayed on the main display 30 that is stored in the video RAM 154 and displays the reel groups 402S to 406S thus selected as a game screen. In addition, the CPU 106 displays rendered effects corresponding to the reel groups selected on the sub display 40 based on the rendered effects stored in the image data ROM 156. In the present embodiment, as shown in FIG. 15-A, since the player selected the reel group which includes relatively many “TREASURE BOX” symbols, the rendered image displayed on the sub display 40 shows a message to look for a treasure box. Thus, it is preferred that data for the rendered effects stored in the image data ROM 156 is selected in relation to each reel group that the player selects. Alternatively, data for the rendered effects stored in the image data ROM 156 may be associated with each reel group that the player selects, respectively. Thus, since the player can reflect the player s will on the reels and symbols used in games, it can increase the player 's interest in game playing.

Thus, according to the gaming machine 15 of the present embodiment, since a reel selection display screen is displayed on the sub display 40 arid the player can select reels to be used in the games so as to reflect the player's will on the reels and symbols used in the games, it can increase the player's interest in game playing. In addition, according to the gaming machine 15 of the present invention, since reels are displayed 3-dimensionally, which can add various rendered effects on the symbols displayed on the reels, it can provide more surprises and greater enjoyment.

In the present embodiment, although it is described that the number of selectable reels displayed on the reel selection display screen is greater than that of reels displayed on the game screen during a game, any number of the selectable reels displayed on the reel selection display screen may be acceptable as long as the number thereof is appropriate while selecting a reel. For example, the number may be the same as that of reels displayed on the game screen.

In addition, in the present embodiment, although a predetermined number of reels is displayed on the reel selection display screen, a plurality of reel groups available during a game may be displayed on the reel selection display screen. In the following embodiment, a case in which a plurality of reel groups available during a game is displayed on a reel selection display screen is described.

### Second Embodiment

A gaming machine of a second embodiment of the present invention is described with reference to FIGS. 16-A to 18B-A. The gaming machine of the second embodiment has substantially the same configuration and operations as those in the gaming machine of the first embodiment, other than that a plurality of reel groups available is displayed on a reel selection display screen. In the following description of a second embodiment, the same components and operations as those in the first embodiment are denoted by the same reference numerals, and descriptions thereof are omitted or simplified. FIG. 16-A shows an example of a reel selection display screen that displays a plurality of selectable reels displayed on the sub display 40. FIG. 17-A is a flowchart showing reel selection processing executed in the present embodiment. FIGS. 18A-A and 18B-A are diagrams illustrating images displayed on the sub display 40 and the main display 30 during execution of the reel selection processing.

As shown in FIG. 16-A, in the present embodiment, a plurality of selectable reel groups is displayed on the reel selection display screen displayed on the sub display 40. As with the video reels shown in FIG. 9-A, each symbol line with each code number is arranged on a reel group 40A including the video reels 401A to 405A, a reel group 40B including the video reels 401B to 405B, a reel group 40C including the video reels 401C to 405C, and a reel croup 40D including the video reels 401D to 405D, which can be displayed on the sub display 40. These code numbers are converted to data in a data table so as to be stored in the abovementioned ROM 108 and the RAM 110 (see FIG. 4-A) along with the symbol arrangement table as shown in FIG. 10-A. In addition, it should be noted that image data used for displaying images corresponding to the plurality of reel groups 40A to 40D on the main display 30 and the sub display 40 is stored in the image data ROM 156 and the video RAM 154.

In addition, a selection button H is displayed on images displaying each of the reel groups 40A to 40D, respectively. Since the sub display 40 includes a touch panel, the player can input a selection instruction for indicating selection of a reel group pushed on the touch panel of the gaming machine 15 by pushing the selection button H once. In addition, by pushing the selection button H displayed in the image of the reel group that the player selected, it can be recognized as setting instruction for setting the reel group as the reel group used in a game by the player.

The reel selection processing of the present embodiment is described with reference to FIGS. 16-A to 1B-A.

Firstly, in Step S201, the CPU 106 on the game controller 100 displays a predetermined number of reel groups 40A to 40D on the sub display 40. More specifically, the CPU 106 displays a plurality of selectable reels 40A to 40D stored in the RAM 110, as well as symbol groups disposed on each of the plurality of reels (see FIG. 16-A). Subsequently, the CPU 106 advances the processing to Step S202.

In Step S202, the CPU 106 determines whether or not a reel selection instruction has been inputted. If it is a “YES” determination, the CPU advances the processing to Step S203, and if it is a “NO” determination, the CPU advances the processing to Step S204. More specifically, upon the selection button H on the touch panel 412 of the sub display 40 being pushed, and accordingly upon the signal from the touch panel 412 being input, the CPU 106 determines that the reel selection instruction was inputted, and the flow proceeds to Step S203. In a case were the CPU 106 determines that the reel selection instruction has not been inputted, the flow proceeds to Step S204.

In Step S204, a reel group selected from the reel groups on the sub display 40 is highlighted. More specifically, when the CPU 106 determines a reel group such as a reel group 40A selected based on the signal inputted from the touch panel 412, the CPU 106 rewrites, for example, image data of the plurality of selectable reels displayed on the sub display 40 that is stored in the video RAM 154 based on image data stored in the image ROM 156. In addition, as shown in FIG. 18A-A, the CPU 106 darkens the reel groups 40B to 40D which have not been selected among the selectable reel groups 40A to 40D and highlights the reel group as the selected one. Subsequently, the flow proceeds to Step S204 according to the instruction from the CPU 106.

In Step S204, the CPU 106 determines whether or not a reel setting instruction is inputted. If it is a “YES” determination, the CPU advances the processing to Step S205, and if it is a “NO” determination, the CPU moves the processing to Step S202. More specifically, upon the selection button H on the touch panel 412 of the reel group 40A, which is currently highlighted, on the sub display 40 being pushed, and accordingly upon the signal from the touch panel 412 being input, the CPU 106 determines that the reel setting instruction was inputted, and the flow proceeds to Step S205. When a selection button H other than that of the reel group 40A, which has been currently highlighted, on the sub display 40 is pushed again, the CPU 106 moves the processing to Step S202.

In Step S205, the CPU 106 displays the reel selected on the main display 30. More specifically, the CPU 106 rewrites, for example, image data of the plurality of selectable reels displayed on the main display 30 and the sub display 40 that is stored in the video RAM 154 based on the image data stored in the image data ROM 156 and, as shown in FIG. 18B-A, displays the image data thus selected, which is enlarged, on the sub display 40. Subsequent visual effect processing and processing for displaying rendered effects on the sub display 40 executed in Step S206 are similar to those described in the first embodiment with reference to FIG. 14C-A to FIG. 15-A, and are, therefore, abbreviated. Furthermore, in Step S204, the reel rotation processing and the reel viewpoint changing processing executed in Steps S104 to S106 described in the first embodiment may be performed after displaying the image data thus selected, which is enlarged, on the sub display 40. In addition, Steps S205 and S206 may be performed after the selection button H is pushed again.

Thus, according to the gaming machine 15 of the present embodiment, since a reel selection display screen is displayed on the sub display 40 and the player can select a reel group used in the games so as to reflect the player's will on the reel groups and symbols used in the games, it can increase the player's interest in game playing. In addition, according to the gaming machine 15 of the present invention, since reels are displayed 3-dimensionally, which can add various rendered effects on the symbols displayed on the reels, more surprises and greater enjoyment can be provided.

In addition, in the gaming machine 15 of the abovementioned embodiments, although the main display 30 is disposed below the sub display 40, the main display 30 may be disposed above the sub display 40. Although the touch panel 412 is provided as an input device, this is not limited thereto and, for example, a selection input-only button may be provided.

### 2. Gaming Machine Permitting Player To Select Reels During Second Game

A description below is directed to a gaming machine permitting player to select reels during second game.

A main part of the present invention is described below. A gaming machine 15 of the invention is provided with memories 108, 110, 154 and 156 for storing image data of a plurality of reels each having a plurality of symbols arranged thereon, a sub display (a first display) 40 for displaying a first reel group by using part of the image data of the plurality of reels stored in these memories, a main display (a second display) 30 for displaying a second reel group used in a game by using part of the image data of the plurality of reels stored in these memories, an instruction input device 412 for inputting an instruction from a player, and a controller 100 for executing the following processing by using the image data of the plurality of reels stored in these memories (see FIGS. 2-B and 4-B).

As shown in FIG. 1-B, though a detailed description will be described later, the controller 100 executes a basic game processing (step S100). When it is judged that a combination of symbols displayed on the first display (sub display) 40 corresponds to a predetermined combination representing a winning of the game (step S200), the controller 100 starts a second game (step S300). By using the image data of the plurality of reels stored in these memories, including two kinds of specific symbols consisting of a bonus symbol promising a high payout and a wild symbol serving as a so-called “almighty” symbol playing roles of other symbols, the controller 100 performs display on the first display 40 a predetermined number of reels including at least two kinds of reels, one of which is a reel displaying a predetermined number of one of the bonus symbol and the wild symbol and the other is a reel displaying a predetermined number of the bonus symbol and the wild symbol, so that one of the number and the kind or both of them of these two specific symbols displayed on these two kinds of reels are visible (step S400). The controller 100 then judges whether a reel replacement instruction has been inputted through the instruction input device 412 (step S500). When it is judged that the reel replacement instruction has been inputted through the instruction input device 412, the controller 100 performs display by replacing at least some reels of the first reel group displayed on the first display 40 with other reels by using the image data of the plurality of reels stored in the memories (step S600). In response to a setting instruction inputted through the instruction input device (step S700), the controller 100 sets, as a second reel group, at least some reel groups of the reel groups displayed on the second display 30, and displays them on the second display as the second reel group (step S800), thus entering into a game (step S900).

By executing the abovementioned processing, since a player can select symbols displayed on the reel that the player uses in a game, the player's will can be reflected on the reels and symbols used in the game, thereby increasing the interest in the bonus game, which pays out more coins and the like than a so-called basic game.

The embodiments of the present invention are hereinafter described in detail with reference to the attached drawings.

### First Embodiment

A gaming machine 15 of a first embodiment of the present invention is described with reference to FIGS. 2-B to 15-B. FIG. 2-B is a perspective view showing an external appearance of the gaming machine 15. As shown in FIG. 2-B, the gaming machine 15 includes a cabinet 20. The cabinet 20 has a structure in which a face facing the player is open. The cabinet 20 contains various components including a game controller 300 (see FIG. 4-B) for electrically controlling the gaming machine 15, and a hopper 44 (see FIG. 4-B) for controlling the insertion, storage, and payout of coins (being one type of game media), and the like. The game media is not restricted to coins. In addition, examples of such game media include medals, tokens, electronic money or electronic value information (credits) having the same value.

The main display (second display) 30 is installed substantially in the middle of the front face of the cabinet 20, and the sub display 40 is installed in an upper side of the cabinet 20. In the present embodiment, the main display 30 and the sub display 40 are configured as liquid crystal panels.

The main display 30 and the sub display 40 realizes a display device for displaying a variety of images related to the game, including produced images and the like. Such a configuration allows the player to advance the game while visually confirming various kinds of images displayed on the aforementioned main display 30.

The gaming machine 15 is made up of image reels, and five virtual reels can be displayed on the main display 30. It should be noted that the term “video reel” as used here represents a mechanism for displaying a reel on the main display 30 in the form of an image instead of a mechanical reel. Multiple kinds of symbols necessary for a game include “WILD,” “RACE CHARACTER1,” “RACE CHARACTER2,” “BONUS,” “WILD,” “WILD,” “GOLDEN MASK,” “HOLY GRAIL,” “COMPASS & MAP,” “SNAKE,” “A,” “K,” “Q,” “J,” and “10.” With such an arrangement, the main display 30 displays these symbols with an image as if the reel were rotating.

The other sub display 40 above the main display 30 is a display device functioning as a display for displaying the rules of the game, demonstration screens, and the like.

Sound permeable openings 29a and 29b, through which sound effects emitted from a speaker 41 (see FIG. 4-B) contained inside the cabinet 20 are propagated outside the cabinet 20, are disposed on the upper right and left sides of the sub display 40, respectively. The sound transmission openings 29a and 29b generate sound effects and the like in accordance with the progress of the game. Decorative lamps 42a and 42b are disposed on the right and left sides in the middle of the gaming machine 15, respectively. The decorative lamps 42a and 42b emit light in accordance with the progress of the game.

A substantially horizontal control panel 21 is provided below the main display 30. A coin insertion slot 22 is provided on the right side of the control panel 21 to insert coins into the gaming machine 15. On the other hand, the components provided to the left side of the control panel 21 include: a bet switch 23 that allows the player to determine which lines are to be set to active pay lines among nine lines L1, L2, L3, L4, L5, L6, L7, L8, and L9, for providing an award described later (which will simply be referred to as “active pay lines” hereafter), and which allows the player to select the amount of coins as game media that are to be bet on the aforementioned active pay lines; and a spin repeat bet switch 24 that allows the player to play the game again without changing the amount of coins bet on the aforementioned active pay lines from that in the immediately prior game. Such an arrangement allows the player to set the amount of coins bet on the active pay line by performing a pushing operation on either the bet switch 23 or the spin repeat bet switch 24.

In the control panel 21, a start switch 25 for accepting per game the player's operation of starting a game is disposed on the left side of the bet switch 23. Upon performing a pushing operation on either the start switch 25 or the spin repeat bet switch 24, which serves as a trigger to start the game, an image of the aforementioned five mechanical reels 3A to 3E starting to rotate is displayed.

A cash out switch 26 is provided near the coin insertion opening 22 on the control panel 21. Upon the player pushing the cash out switch 26, the inserted coins are paid out from a coin payout opening 27 provided at a lower portion of the front face. The coins thus paid out are retained in a coin tray 28.

FIG. 3-B is an enlarged top view of a display area configuring a game screen which is displayed on the main display 30 of the gaming machine 15 during a game. The gaming machine 15 includes lines L1 to L9 for providing nine awards as shown in FIG. 3-B. The lines L1 to L9 for providing each award extend so as to pass through a symbol on each of the image reels 3A to 3E when the spinning images of the 5 video reels 3A to 3E come to a stop.

When the abovementioned BET switch 23 is pressed once, for example, the line L3 for providing a third award, the line L5 for providing a fifth award, and the line L7 for providing a seventh award are set to be active pay lines, and one coin is consumed as a credit medal.

Furthermore, upon pushing the aforementioned bet switch 23 twice, the line L1, for providing a first award, the line L4 for providing a fourth award, and the line L8 for providing an eighth award, are set to be active pay lines, in addition to the aforementioned three lines, and two coins are consumed as credit medals, for example.

Moreover, upon pushing the aforementioned bet switch 23 three times, the line L2 for providing a second award, the line L6 for providing a sixth award, and the line L9 for providing a ninth award are set to be active pay lines, in addition to the aforementioned six lines, and three coins are input as credit medals, for example.

The game available in the present embodiment is a game in which a predetermined set of symbols are made along the active pay lines.

In addition, it is arranged so that a payout number display portion 48, a bet number display portion 50, and a credit number display portion 49 can be displayed in this order from the left side on the upper portion of the main display 30. The payout display portion 48 is a component for displaying the amount of the coins paid out when a specific combination of the symbols for providing an award has been achieved along any one of the active pay lines. The credit number display portion 49 displays the credit amount of coins stored in the gaming machine 15. The bet number display portion 50 is a component for displaying the bet amount which is the amount of coins bet on the aforementioned active pay lines.

FIG. 4-B is a block diagram showing an electric configuration of the game controller of the gaming machine 15. Referring to FIG. 4-B, the game controller 100 of the gaming machine 15 is a microcomputer and is provided with an interface circuit group 102, an input/output bus 104, a CPU 106, ROM 108, RAM 110, an interface circuit 111 for communication, a random number generator 112, a speaker drive circuit 122, a hopper drive circuit 124, a lamp drive circuit 126, and a display/input controller 140.

The interface circuit group 102 are electrically connected with the input/output bus 104, which carries out input and output of data signals or address signals for the CPU 106.

The start switch 25 is electrically connected with the interface circuit group 102. In the interface circuit group 102, a start signal generated by the start switch 25 is converted into a predetermined form of signal to be supplied to the input/output bus 104.

Furthermore, the bet switch 23, the spin repeat bet switch 24, and the cash out switch 26 are connected to the interface circuit group 102. Each of the switching signals output from these switches 23, 24, and 26 is also supplied to the interface circuit group 102, and is converted into a predetermined signal by the interface circuit group 102. The switching signals thus converted are supplied to the input/output bus 104.

A coin sensor 43 is also electrically connected with the interface circuit group 102. The coin sensor 43 detects coins inserted into the coin insertion slot 22, and is disposed at an appropriate position relative to the coin insertion slot 22. The sensing signal output from the coin sensor 43 is also supplied to the interface circuit group 102, and is converted into a predetermined signal by the interface circuit group 102. The sensing signal thus converted is supplied to the input/output bus 104.

The ROM 108 and the RAM 110 are connected to the input/output bus 104.

Upon acceptance of the start operation of a game by way of the start switch 25, the CPU 106 reads a game program to execute the game. The game program executes an image starting scrolling of the symbols on the five video reels is provided on the main display 30 via the display/input controller 140, and then, an image for stopping the five video reels is displayed so as to rearrange the symbols on the five video reels. If that combination of symbols stopped is displayed on the active pay lines and the combination corresponds to a specific combination for which an award is provided, the number of coins associated with the specific combination is paid out.

The ROM 108 stores a control program for governing and controlling the gaming machine 15, a program for executing routines as shown in FIGS. 8-B to 10-B (hereinafter referred to as a “routine execution program”), and initial data for executing the control program, and various data tables used in decision processing The routine execution program includes the above-mentioned basic game program. As an example of the data tables, there is a table as shown in FIG. 10-B. The RAM 110 temporarily stores a plurality of reels and symbol groups provided on each of the plurality of reels displayed on the main display 30, a plurality of selectable reels and symbol groups provided on each of the plurality of reels displayed on the sub display 40, a data table including a symbol arrangement table, and a flag, a variable, and data used in the control program.

Furthermore, a communication interface circuit 111 is connected to the input/output bus 104. The communication interface circuit 111 is a circuit for communicating with a controller for an external control unit (not shown), etc. via the network including various types of networks. The random number generator 112 for generating a random number is connected to the input/output bus 104. The random number generator 112 generates random numbers in a predetermined range of “0” to “65535” (the sixteenth power of two minus one), for example. Alternatively, an arrangement may be made in which the CPU 106 generates a random number by computation.

The speaker drive circuit 122 for the speakers 41 is also electrically connected with the input/output bus 104. The CPU 106 reads the sound data stored in the ROM 108, and transmits the sound data thus read to the speaker driving circuit 122 via the input/output bus 104. In this way, the speakers 41 generate predetermined sound effects.

The hopper drive circuit 124 for driving the hopper 44 is also electrically connected with the input/output bus 104. Upon reception of a cash out signal input from the cash out switch 26, the CPU 106 transmits a driving signal to the hopper driving circuit 124 via the input/output bus 104. Accordingly, the hopper 44 pays out coins such that the amount thereof is equivalent to the current number of coins remaining as credits, which is stored in a predetermined memory area of the RAM 110.

Alternatively, the payout of the coins may be performed in a mode of storing credit data in a data card or the like, instead of using physical coins. That is, the player may carry a card functioning as a recording medium, and store the data related to the credit by inserting the card into the gaming machine 15.

The lamp drive circuit 126 for driving the decorative lamps 42a and 42b is also connected with the input/output bus 104. The CPU 106 transmits the signal for driving the lamps according to the predetermined conditions based on the program stored in the ROM 108 to the lamp driving circuit 126. In this way, decorative lamps 42a and 42b blink and the like.

The display/input controller 140 is connected to the input/output bus 104. The CPU 106 creates an image display command corresponding to the state and results of the game, arid outputs the image display command thus created to the display/input controller 140 via the input/cutout bus 104. Upon receiving the image display command input from the CPU 106, the display/input controller 140 creates a driving signal for driving the main display 30 and the sub display 40 according to the image display command thus input, and outputs the driving signal thus created to the main display 30 and the sub display 40. As a result, a predetermined image is displayed on the main display 30 and the sub display 40. In addition, the gaming machine 15 includes a touch panel 412 on a surface of the sub display 40. The touch panel 412 accepts an input by a player corresponding to the player's pushing location and pushing duration, and outputs the input signal generated by the player's input to the CPU 106 via the input/output bus 104. The image display instruction also contains the instructions in accordance with the payout number display portion 48, the credit number display portion 49, and the bet number display portion 50.

FIG. 5-B is a block diagram showing an electric configuration of a display/input controller 140 of the gaming machine 15. The display/input controller 140 of the gaming machine 15 is a sub-micro computer which performs image display processing and the control of input from the touch panel 412, and which has an interface circuit 142, an input/output bus 144, a CPU 146, ROM 148, RAM 150, a VDP 152, video RAM 154, ROM 156 for image data, a drive circuit 158, and a touch panel control circuit 160.

The interface circuit 142 is connected to the input/output bus 144. The image display command outputted from the CPU 106 on the game controller 100 is supplied to the input/output bus 144 via the interface circuit 142. The input/output bus 144 performs input/output of data signals or address signals to and from the CPU 146.

The ROM 148 and the RAM 150 are connected to the input/output bus 144. The ROM 148 stores a display control program under which a drive signal to be supplied to the main display 30 and the sub display 40 is generated based on the image display instruction from the CPU 106 on the game controller 100. On the other hand, the RAM 150 stores flags and variables used in the aforementioned display control program.

The VDP 152 is connected to the input/output bus 144. The VDP 152 includes a so-called sprite circuit, a screen circuit, a palette circuit, etc, and can perform various types of processing for displaying images on the main display 30 and the sub display 40. The video RAM 154 and the ROM 156 are connected to the VDP 152. The video RAM 154 stores image data based on the image display instructions from the CPU 106 on the game controller 100. The ROM 156 for image data stores various kinds of image data containing the abovementioned produced image data, symbols for 3-dimensional display (described later), and the like. Furthermore, the driving circuit 158 for outputting a driving signal for driving the main display 30 and the sub display 40 is connected to the VDP 152.

By reading and executing the display control program stored in the ROM 148, the CPU 146 instructs the video RAM 154 to store image data to be displayed on the main display 30 and the sub display 40 in response to the image display instruction from the CPU 106 on the game controller 100. Examples of the image display commands include various kinds of image display commands including the aforementioned image display commands for visual effects, etc.

The image data ROM 156 stores various kinds of image data including the image data that provides visual effects.

The touch panel control circuit 160 outputs the signals inputted via the touch panel 412 provided on the sub display 40 to the CPU 106 via the input/output bus 144 in the form of an input signal.

FIG. 6-B is an exploded perspective view showing a configuration of a portion of the sub display 40. The sub display 40 functions as a first display for displaying selectable reels during selection of reels. For this reason, the sub display 40 includes: a front panel 411 having a touch panel 412 and a display plate 413; a transparent liquid crystal panel 414; a light-introducing plate 415; a reflecting film 415; fluorescent lamps 417A and 417B, which serve as a so-called white light source; and a Table Carrier Package (TCP) mounting ICs for driving the transparent liquid crystal panel. In addition, it should be noted that although not shown in FIG. 5-B, it may be possible for the TCP to include a flexible printed board (not shown) connected with terminals of the transparent liquid crystal panel 414. The touch panel 412 is formed of a transparent member. The display plate 413 is formed of a transparent member.

A method of displaying selectable reels displayed on the sub display 40 in reel selection processing (described later) is described with reference to FIGS. 7-B, 8A-B, and 8B-B. Selectable reels are displayed 3-dimensionally on the sub display 40 in the present embodiment. FIG. 7-B is a diagram illustrating a method of displaying selectable reels 3-dimensionally on the sub display 40. Using two virtual cameras 501A and 501B, a plurality of reels 401 to 407 represented using a local coordinate system (x, y, z) are displayed on the sub display 40 in such a manner that perspective transformation is performed for a virtual 3-dimensional space on a world coordinate system (X′, Y′, Z′) and (X″, Y″, Z″) so that each axis of the local coordinate system is at a predetermined angle (in the present embodiment, substantially 45 degrees) to each axis of the world coordinate system. Examples of the 3-dimensional images thus generated are shown in FIGS. 8A-B and 8B-B. FIG. 8A-B is a display screen on the sub display 40 in which the plurality of reels 401 to 407 that the player can select are displayed 3-dimensionally with a point of view which is substantially 45 degrees diagonally backwards to the right from the display screen. FIG. 8B-B is a display screen on the sub display 40 in which the plurality of reels 401 to 407 that the player can select are displayed 3-dimensionally with a point of view which is substantially 45 degrees diagonally backwards to the left from the display screen. Accordingly, perspective transformation and a point of view from the virtual cameras are important to display the plurality of reels in three dimensions with a plurality of points of view.

A method of displaying the selectable reels in 3-dimensional is described in detail with reference to FIG. 7-B. The virtual cameras 501A and 501B disposed in the virtual 3-dimensional space projects images of the plurality of reels with a point of view which is substantially 45 degrees diagonally backwards to the right from the display screen (see FIG. 8A-B) and images of the plurality of reels with a point of view which is substantially 45 degrees diagonally backwards to the left from the display screen (see FIG. 8B-B) on the virtual screens 510A and 510B, respectively. The positions of the virtual cameras 501A and 501B decide the points of view 503A and 503B, respectively. The directions of the virtual cameras 501A and 501B decide axes of vision 500A and 500B, respectively. Each of the points of view 503A and 503B decides angles of vision 505A and 505B, each of which consists of two lines connecting apexes of opposing corners of the virtual screens 510A and 501B. Here, the coordinate system of the virtual screen 510A is called a point of view coordinate system (X′, Y′, Z′) and the coordinate system of the virtual screen 510B is called a point of view coordinate system (X″, Y″, Z″), and a Z′ axis and a Z″ axis in the coordinate system are in the direction of the axes of vision 500A and 500B. Here, the coordinate of the world coordinate system including the coordinate converted from the coordinate of the local coordinate system is converted to the coordinate of the point of view coordinate system, and then perspective transformation for the coordinate of the point of view coordinate system is performed. An axis of vision 404 is in the direction of a symbol located substantially at the center of each reel. In a case in which each reel is moved, the axis vision 404 may move, for example, from the direction of the positions 401a and 402a to the positions 401b and 402b so as to face the direction of the symbol located substantially at the center. It should he noted that a stereoscopic effect is enhanced further using, for example, texture mapping processing for the selectable reels displayed on the sub display 40. The image data ROM 156 stores image data thus generated in regards to the plurality of points of view for each video reel, and the CPU 106 rewrites image data of the plurality of selectable reels stored in the video RAM 154 and displayed on the sub display 40 as appropriate based on image data stored in the image data ROM 156. In addition, the method of displaying the selectable reels in 3-dimensionally used in the present embodiment is described as an example, and thus, the present invention is not limited thereto. For one skilled in the art, there may be various conceivable techniques possible that are evident. In addition, although cases of displaying on the sub display 40 at a point of view which is substantially 45 degrees diagonally backwards to the left or substantially 45 degrees diagonally backwards to the right from the display screen have been described, the number of points of view that can be displayed and the angles thereof on the sub display 40 may be varied as appropriate.

FIG. 9-B is a diagram showing symbol lines disposed on each video reel which are displayed during a second game on the main display 30 of the gaming machine 15 of the present embodiment. FIG. 9-B shows symbol lines on which 21 symbols arranged on each video reel 3A to 3E (see FIG. 3-B) are represented. The symbol line for the first video reel corresponds to the video reel 3A. The symbol line for the second video reel corresponds to the video reel 3B. The symbol line for the third video reel corresponds to the video reel 3C. The symbol line for the fourth video reel corresponds to the video reel 3D. The symbol line for the fifth video reel corresponds to the video reel 3E. When each video reel 3A to 3E rotates around a virtual rotational axis, these symbols appear in the order depicted in FIG. 9-B.

As shown in FIG. 9-B, a code number of “00” to “20” is referred to for each symbol of video reels 3A to 3E. These code numbers are converted to be data in a data table so as to be stored in the aforementioned ROM 108 and RAM 110 (see FIG. 4-B). The column of symbols is represented on the image reels 3A to 3E, respectively. More specifically, the column of symbols is made up of a “BONUS” symbol (symbol 61) (hereinafter abbreviated as “BONUS”), a “FLAG” symbol (symbol 62) (hereinafter abbreviated as “FLAG”), a “WILD” symbol (symbol 63) (hereinafter abbreviated as “WILD”), a “GOLDEN MASK” symbol (symbol 64) (hereinafter abbreviated as “GOLDEN MASK”), a “HOLY GRAIL” symbol (symbol 65) (hereinafter abbreviated as “HOLY GRAIL”), a “COMPASS&MAP” symbol (symbol 66) (hereinafter abbreviated as “COMPASS&MAP”), a “SNAKE” symbol (symbol 67) (hereinafter abbreviated as “SNAKE”), a “A” symbol (symbol 68) (hereinafter abbreviated as “A”), a “K” symbol (symbol 69) (hereinafter abbreviated as “K”), a “Q” symbol (symbol 70) (hereinafter abbreviated as “Q”), a “J” symbol (symbol 7-1) (hereinafter abbreviated as “J”), a “10” symbol (symbol 72) (hereinafter abbreviated as “10”) a “RACE CHARACTER 1” (symbol 73) (hereinafter abbreviated as “RACE CHARACTER 1”), and a “RACE CHARACTER 2” (symbol 74) (hereinafter abbreviated as “RACE CHARACTER 2”).

The columns of symbols on the image reels 3A to 3E can be moved by the display of an image where the reels 3A to 3E are spinning in a forward direction.

In the present embodiment, “BONUS”, “SECOND”, “SNAKE”, “WILD”, “GOLDEN MASK”, “HOLY GRAIL”, “COMPASS & MAP”, “A”, “K”, “Q”, “J”, and “10” are provided as hands in awarding a predetermined winning. A combination (combination data) is control information which relates credits awarded to a player (the payout amount of coins) to a combination of an award combination, and which is used for stop control of each video reel 3A through 3E, changing (shift) of a game state, providing coins, and the like.

FIG. 10-B is a diagram showing a symbol arrangement table used by the gaming machine 15 of the present embodiment. The symbol arrangement table relates the code number indicating the position of each symbol which constitutes the aforementioned symbol lines to each symbol of the respective video reels 3A to 3E, and then registers thereof. In addition, the first through the fifth video reels correspond to the video reels 3A to 3E, respectively. In other words, the symbol arrangement table includes symbol information corresponding to the symbol position (the code number) of video reels 3A to 3E (see FIG. 3-B).

In FIG. 10-B, “MASK,” “COMPASS,” “CHARACTER 1” and “CHARACTER 2” are abbreviations for the abovementioned “GOLDEN MASK,” “COMPASS&MAP,” “CHARACTER 1,” and “CHARACTER 2,” respectively. In addition, a bonus symbol is referred to as “BONUS” and a wild symbol is referred to as “WILD” below.

A bonus is made effective when three or more “BONUS” symbols come to rest on a pay line. When a game is entitled to a bonus, the CPU 106 initiates a second game which is more advantageous than a basic game. In the second game, a bonus symbol assures a high dividend, and a wild symbol functions as any of usual symbols when it is arranged on an active pay line. In the present embodiment, it should be noted that a bonus symbol and a wild symbol are specific symbols that a player want to acquire on a reel used in a second game.

FIG. 11A-B shows an example of a reel selection display screen that displays selectable reels displayed on the sub display 40 in reel selection processing. As described above, in the present embodiment, the number of reels displayed on the main display 30 during games is five, and the number of selectable reels displayed on the sub display 40 is seven. However, the present invention is not limited to the abovementioned configuration. For example, the number of selectable reels displayed on the sub display 40 may be the same as that of reels displayed on the main display 30. FIG. 11B-B shows selectable reels that can be displayed on the sub display 40 by a player's operation. In the present embodiment, the number of selectable reels that can be displayed on the sub display 40 by a player's operation is ten. As with the video reels shown in FIG. 9-B, each symbol line with each code number is arranged on the video reels 401 to 410 that can be displayed on the sub display 40. These code numbers are converted to be data in a data table so as to be stored 1n the abovementioned ROM 100 and the RAM 110 (see FIG. 4-B) along with the symbol arrangement table as shown in FIG. 10-B. As shown in FIG. 11B-B, the plurality of selectable reels are stored in a way that each reel is adjacent each other.

As shown in FIG. 11A-B, in reel selection processing, up-pointing and down-pointing arrows are displayed on each of the selectable reels 401 to 407 displayed on the sub display 40. In addition, right-pointing and left-pointing arrows are displayed on the reels 401 and 407, which are located at both ends. Since the sub display 40 includes the touch panel, the player can change the images of the selectable reels 401 to 407 in the direction of the arrows by pushing the arrows on the touch panel. For example, when the player pushes an up-pointing arrow A of the reel 401, the reel 401 rotates in the up direction around the rotational axis. At this time, the symbol “J” on the reel 401 disappears and the symbol “A” on the reel 401 appears (see FIGS. 9-B and 10-B). Similarly, when the player pushes a down-pointing arrow B of the reel 401, the reel 401 rotates in the down direction around the rotational axis. At this time, the symbol “WILD” disappears on the reel 401 and the symbol “MASK” appears on the reel 401 (see FIGS. 9-B and 10-B).

In addition, as shown in FIG. 11B-B, when the player pushes the arrow C, the reels 401 to 410 which can be displayed on the sub display 40 rotate in a clockwise direction. Thus, the reels 401 to 407 that can be displayed move to the left side along the axial direction of the reels. Then, the reel 401 disappears to the left side and the reel 408 appears on the right side of the reel 407. Similarly, when the player pushes the arrow D, the reels 401 to 410, which can be displayed on the sub display 40, rotate in a counterclockwise direction. Thus, the reels 401 to 407 that can be displayed move to the right side along the axial direction of the reels. Then, the reel 407 disappears to the right side and the reel 401 appears on the left side.

In addition, a button L shown by E, a button R shown by F, a determination button shown by G, and a display button shown by H are displayed at the lower left portion and the lower right portion of the display screen which displays the selectable reels 401 to 407 on the sub display 40. Since the sub display 40 includes a touch panel, the player can input various commands to the gaming machine 15 by pushing these buttons. When the player pushes the button L, the selectable reels 401 to 407 are displayed 3 dimensionally from a point of view which is substantially 45 degrees diagonally backwards to the right from the display screen, as shown in FIG. 8A-B. On the other hand, when the player pushes tie button R, the selectable reels 401 to 407 are displayed 3-dimensionally from a point of view which is substantially 45 degrees diagonally backwards to the right from the display screen, as shown in FIG. 8B-B. When the player pushes the determination button G, a reel group, which is located at the center among the reel groups currently being displayed, is determined as a reel group used in a game. In addition, when pushing the determination button G immediately after pushing a reel separately among the selectable reels 401 to 407, the reel is highlighted. When the player pushes the determination button G again, the reel is released from being highlighted. In addition, in a case in which a reel is highlighted separately, even when the player pushes the determination button G, the reel is not determined as a reel used in a game. The reel highlighted remains as the same location on the selection display screen, even when the arrow C or D is pushed. Thus, the selectable reels 401 to 407 can be replaced collectively or can be replaced separately.

Regarding a reel selection display screen as shown in FIG. 11A-B, upon pushing the display button H, the sub display 40 switches to a reel selection display screen in which the number of bonus and wild symbols are visibly recognizable (see FIG. 15A-B). Upon pushing the display button H in the reel selection display screen shown in FIG. 15A-B, the sub display 40 is switched to a reel selection display screen in which a variety of wild and bonus symbols or the existence thereof are visually recognizable (see FIG. 15B-B). In a case where there is a bonus symbol or a wild symbol in the reel selection display screen shown in FIG. 15B-B, corresponding lamps are turned on, and otherwise, turned off. Upon pushing the display button H in the display screen of FIG. 15B-B, the sub display 40 switched to the reel selection display screen shown in FIG. 11A-B.

Thus, since the abovementioned configuration can improve the visibility of reels and can reflect the player's will on the reels and symbols used in games, it can increase the player's interest in game playing.

FIG. 12-B is a flowchart showing processing operation executed by the controller 100 of the gaming machine 15. FIG. 13-B is a flowchart showing second game processing executed by the controller of the gaming machine shown in FIG. 2-B; FIG. 14-B is a flowchart showing reel selection processing in detail among the main processing operations executed by the controller 100 of the gaming machine 15. FIGS. 15A-B to 17-B are a diagram illustrating images displayed on the sub display 40 and the main display 30 when the reel selection processing is executed. A single routine shown in FIG. 12-B is equal to a single unit game.

It should be noted that the gaming machine 15 is activated in advance and the variables used in the CPU 106 on the game controller 100 are initialized to predetermined values, respectively, thereby providing a stationary state of the gaming machine 15.

Firstly, a general description of the main processing operation executed by the controller 100 of the gaming machine 15 is described with reference to FIG. 12-B.

In Step S1, the CPU 106 on the game controller 100 determines whether a certain amount of credits remains, which is the number of remaining coins inserted by the player. More specifically, CPU 106 reads the amount of credits C stored in the RAM 110, and executes processing according to the amount of credits C. When the amount of credits C equals “0” (in the case of a “NO” determination by the processing of Step S1), the CPU 106 terminates the routine without executing any processing, since it cannot start a game. When the amount of credits C is not less than “1” (in the case of a “YES” determination by the processing of Step S1), the CPU 106 determines that coins remain as credits, and the CPU 106 moves the processing to Step S2.

In Step S2, the CPU 106 sets a game condition. More specifically, the CPU 106 determines the amount of coins bet on the active pay lines in this game based on the operation of the bet switch 23. At this time, the CPU 106 determines the bet amount to be bet on the active pay lines based on the number of times signals that indicate operation of the bet switch 23 have been received, and stores the bet amount thus determined in a predetermined memory area of the RAM 110. The CPU 106 reads the amount of credits C stored in a predetermined memory area of the RAM 110, and subtracts the total bet amount, which is the sum of the aforementioned bet amounts, from the amount of credits C thus read. Then, the CPU 106 stores the subtracted value in a predetermined memory area of the RAM 110. The CPU 106 then moves the procedure to Step S3.

In the following Step S3, the CPU 106 determines whether the start switch 25 is ON, and then waits for the start switch 35 to be operated. Upon the start switch 25 being operated, and accordingly upon the operation signal being input from the start switch 25 (in a case of a “YES” in the determination processing in Step S3), the CPU 106 determines that the start switch 25 has been operated, and the flow proceeds to Step S4.

In the following Step S4, the CPU 106 performs stationary symbol determination processing. A specific description is made below regarding the stationary symbol determination processing.

First, the CPU 106 selects a random number in a range of values from 0 to 255 for each of the five reels 3A to 3E by extracting a random number from the random generator 112. Next, the CPU 106 reads payout rate setting data from the ROM 108 to store in the RAM 110, refers to symbol weighting data corresponding to the payout rate setting data, and determines code numbers (see FIG. 6-B) for each of the reels 3A to 3E based on the five random numbers thus selected. The code number selected for each reel 3A to 3E corresponds to the symbol code number of the symbol which is, to be rearranged along the pay line. The CPU 106 determines the code numbers for each of the reels 3A to 3E, thereby determining a winning combination. For example, in a case where the CPU 106 determines that the code numbers for each of the reels 3A to 3E are “20,” “20,” “20,” “20,” and “20,” it indicates that the CPU 106 has determined that the winning combination is “BONUS”. In addition, in a case where three or more identical symbols are rearranged on the active pay line, a winning combination corresponding to the rearranged symbol is achieved. In addition, a “WILD” symbol functions as any normal symbol. Therefore, in a case where two identical symbols and a single “WILD” symbol are arranged on an active pay line, it is assumed that three identical symbols are arranged on the active pay line, which achieves a winning combination. Regarding “BONUS”, in a case in which at least three “BONUS” symbols are rearranged, regardless of the active pay line, the winning combination is determined as “BONUS”. In addition, even in a case where two “BONUS” symbols and at least one “WILD” symbol are rearranged, its winning combination is determined as “BONUS”.

Upon determining stationary symbols, the CPU 106 causes the specific combination data which indicates the stationary symbols thus determined to be stored in the predetermined memory area of the RAM 110. Then, the CPU 106 reads the random number value and the specific combination data stored in the predetermined memory area of the RAM 110 and determines the combination of the symbols to be displayed to be stationary based upon the random number value and the specific combination data thus read. In this stage, a symbol arrangement table stored in the ROM 108 is read by the CPU 106. The symbol arrangement table thus read is stored in a predetermined memory area of the RAM 110, and used as reference data. The CPU 106 causes the stationary symbol combination data, which indicates the stationary symbol combination thus determined, to be stored in a predetermined memory area of the RAM 110. Alternatively, it may be configured that a stationary symbol for each reel is determined using the random number table.

Upon determining the combination of the symbols when stationary with respect to the aforementioned active pay lines, the CPU 106 determines whether the combination of the symbols when they are stationary with respect to the active pay lines matches any one of the specified combinations for providing an award. In a case where the combination of the symbols when they are stationary with respect to the active pay lines matches any one of the specified combinations for providing an award, the CPU 106 activates a flag, which indicates that the player has won the award that corresponds to the kind of specified combination for providing an award, in order to provide the award that corresponds with the specified combination of symbols with respect to the active pay lines for providing the award. The activated flag, which indicates the player has won an award, is stored in a predetermined area of the RAM 110 according to the instruction from the CPU 106. On the other hand, in a case where the combination of the symbols when they are stationary with respect to the active pay lines matches any one of the other combinations, i.e. losing combinations, the CPU 106 does not activate the flag which indicates that the player has won an award. Subsequently, CPU 106 moves the processing to Step S6.

In the following Step S5, the CPU 106 instructs the video reels 3A through 3E to start to rotate. More specifically, the CPU 106 displays an image which shows rotating the video reels 3A to 3E, in sequence or Simultaneously, based upon the symbol arrangement table stored in the aforementioned RAM 110. Upon displaying the image showing the video reels 3A to 3E starting to rotate, the CPU 106 waits for a predetermined period of time to elapse (Step S6). After the predetermined period of time has elapsed (in a case of “YES” in the determination processing in Step S7), the CPU 106 instructs the video reels 3A to 3E to automatically stop rotating (Step S7). More specifically, the CPU 106 displays an image showing the video reels 3A to 3E stopping rotation in sequence such that the stationary symbols, which correspond to the specific combinations for providing an award determined in the aforementioned Step S4, are displayed within a display region that has a visually interactive relationship with the player. Subsequently, the CPU 106 moves the process to Step S8.

In Step S8, the CPU 106 determines whether or not a predetermined symbol combination is formed. More specifically, the CPU 106 determines the predetermined symbol combination based on the state of a flag stored in the predetermined area of RAM 110. As described above, the flag indicates the providing of an award corresponding to a specific combination in a case where a stationary symbol combination matches the specific combination. When the flag is not activated, namely when the specific combination for providing the winning is “others” (when the result is NO in Step S10), the CPU 106 decides that the specific combination for providing the winning is not achieved, and terminates the present routine. On the other hand, in a case where the flag has been activated, i.e. in a case where the symbol combination matches any one of the combinations other than the “other” combinations (in a case of a “YES” in the determination processing in Step S9), the flow proceeds to Step S9 according to the instruction from the CPU 106.

In Step S9, the CPU 106 determines whether the achieved symbol combination is a second game start combination (a winning combination is “SECOND”) by the combination determination processing in Step S6. More specifically, in a case that the specified combination is the second game start combination which provides an award (in a case of “YES” in the determination processing in Step S9), the CPU 106 advances the flow to Step S10. On the other hand, when it is not the second game start combination (when the result is NO in Step S9), the CPU 106 moves on to Step S11.

Here, the second game start combination indicates a combination in which a specific symbol “FLAG” is arranged in the first video reel and specific symbols “RACE. CHARACTER 1” and “RACE CHARACTER 2” are arranged simultaneously on the fifth video reel. A second game is started in a case where the abovementioned combination is arranged on the video reels 3A, 3B, 3C, 3D, and 3E. In addition, in this case, the symbols thus arranged on the second video reel to the fourth video reel may be any symbol.

In the following Step S10, the CPU 106 performs second game processing. Subsequently, the CPU 106 terminates the routine.

In a case where the flow has proceeded to Step S11, the CPU 106 pays out the amount of coins corresponding to the aforementioned specified combination for providing an award. More specifically, the CPU 106 refers to a payout table and calculates a payout number of coins corresponding to this specific combination. The CPU 106 reads, the credit amount stored in the predetermined memory area of the RAM 110, calculates the sum total of the credit amount thus read and the amount of payout thus calculated, and stores the sum thus calculated in the predetermined memory area of the RAM 110. The CPU 106 displays the aforementioned value thus stored on the credit amount display portion 49. Subsequently, the CPU 106 terminates the routine.

A description is given in the following of a second game with reference to FIG. 13-B.

A second game is executed in a case where a second game start combination is achieved. Therefore, the second game pays out more coins than a so-called basic game. In the second game, a bonus symbol assures a high dividend, and a wild symbol functions as any of the usual symbols when it is arranged on an active pay line. In the present embodiment, it should be noted that a bonus symbol and a wild symbol are specific symbols that a player aims to acquire on a reel used in a second game.

In Step S21, the CPU 106 performs a reel selection processing. Then, the CPU 106 advances the processing to Step S22. This processing is described later.

In the following Step S22, the CPU 106 determines whether or not the start switch 25 is in the ON state, i.e., the CPU 106 stands by until the player operates the start switch 25. Upon the player operating the start switch 25, and accordingly, upon receipt of an operation signal via the start switch 25 (in a case of “YES” in the determination processing denoted by Step S22), the CPU 106 determines that the start switch 25 has been operated, and accordingly, the CPU 106 moves the processing to Step S23.

In the following Step S23, the CPU 106 performs stationary symbol determination processing. The abovementioned stationary symbol determination processing is substantially the same as that of Step S4 in the basic game processing described with reference to FIG. 12-B, except for specific combinations for providing an award, winning probability, amount of coins to be paid out, and the like. Therefore, a detail description for the stationary symbol determination processing is abbreviated.

In the following Step S24, the CPU 106 displays an image of the five video reels 3A through 3E starting to rotate. More specifically, the CPU 106 displays an image which shows rotating the video reels 3A to 3E, in sequence or Simultaneously, based upon the symbol arrangement table stored in the aforementioned RAM 110. After the predetermined period of time has elapsed, the CPU 106 instructs the video reels 3A to 3E to automatically stop rotating (Step S25). More specifically, the CPU 106 displays an image which shows the video reels 3A to 3E stopping rotation in sequence such that the symbols when they are stationary, which correspond to the specific combinations for providing an award determined in the aforementioned Step S23, are displayed within a display region that has a visually interactive relationship with the player. Subsequently, the CPU 106 moves the process to Step S8.

In Step S26, the CPU 106 determines whether or not a predetermined symbol combination is achieved. More specifically, the CPU 106 determines the predetermined symbol combination based on the state of a flag stored in the predetermined area of RAM 110. As described above, the flag indicates providing an award corresponding to a specific combination in a case where a stationary symbol combination matches the specific combination. In a case where the flag has not been activated, i.e. in a case where the symbol combination matches any one of the “other” combinations, which are combinations other than the specified combinations for providing an award (in a case of “NO” in the determination processing in Step S26), the CPU 106 determines that the specified combination for providing an award has not been formed, and ends this routine. On the other hand, in a case where the flag has been activated, i.e. in a case where the symbol combination matches any one of the combinations other than the combination of “Others” (in a case of YES in the determination processing in Step S26), the flow proceeds to Step 11 according to the instruction from the CPU 106.

In a case where the flow has proceeded to Step S27, the CPU 106 pays out an amount of coins corresponding to the specific combination for providing the abovementioned award by way of the stationary symbol determination processing in Step S5. More specifically, the CPU 106 refers to a payout table and calculates a payout number of coins corresponding to this specific combination. The CPU 106 reads the credit amount stored in the aforementioned predetermined memory area of the RAM 110. Then, the CPU 106 calculates the sum total amount of coins to be paid out thus calculated and the credit amount thus read, and stores the sum thus calculated in a predetermined memory area of the RAM 110. The CPU 106 displays the aforementioned value thus stored on the credit amount display portion 49. Subsequently, the CPU 106 terminates the routine.

Reel selection processing is described in detail with reference to FIGS. 14-B to 17-B.

In the present embodiment, reel selection processing is performed in a second game, which has a higher payout ratio of coins and the like than a so-called basic game. Thus, the selectable reels at least include two types of reels, and includes among at least two kinds of specific symbols, a high dividend assuring bonus symbol that is a bonus symbol assuring a high dividend and a wild symbol functions as any of the normal symbols, in which a first type of reel displays a predetermined number of any one kind of specific symbols from a bonus symbol and a wild symbol, and a second type of reel displays a predetermined number of two kinds of specific symbols from a wild symbol and a bonus symbol. These reels are displayed on the sub display 40 so that either one or both the number and type of specific symbols displayed on each reel can be visually recognized.

In Step S101, the CPU 106 on the game controller 100 displays a predetermined number of reels including a bonus symbol and a wild symbol with various visual modes on the sub display 40. More specifically, the CPU 106 rewrites, for example, image data of the plurality of selectable reels stored in the video RAM 154 and displayed on the sub display 40 based on image data stored in the image ROM 156, and displays a plurality of selectable reels 401S to 407S, which is currently stored in the RAM 110, as well as symbol groups disposed thereon (see FIG. 11A-B). Subsequently, the CPU 106 moves processing to Step S102.

Here, the selectable reels 401S to 407S at least include two types of reels, and include among at least two kinds of specific symbols, a high dividend assuring bonus symbol that is a bonus symbol assuring a high dividend and a wild symbol functions as any of the normal symbols, in which a first type of reel displays a predetermined number of any one kind of specific symbols from a bonus symbol and a wild symbol, and a second type of reel displays a predetermined number of two kinds of specific symbols from a wild symbol and a bonus symbol. These reels are displayed so that either one or both the number and type of specific symbols displayed on each reel can be visually recognized.

Since the sub display 40 includes a touch panel, when the player pushes the display button H on the reel selection display screen shown in FIG. 11A-B, a signal for changing a symbol display is inputted from the touch panel 412 to the CPU 106. When the CPU 106 determines that a symbol display changing instruction has been inputted, the CPU 106 rewrites, for example, image data of the plurality of selectable reels stored in the video RAM 154 and displayed on the sub display 40 based on image data stored in the image ROM 156, and switches a display screen of the sub display 40 to a reel selection display screen in which the number of bonus symbols and wild symbols can be visually recognized (see FIG. 15A-B). Similarly, when the display button H has been pushed in tie reel selection display screen shown in FIG. 15A-B, the CPU determines that a symbol display changing instruction was inputted, and then, the CPU 106 rewrites, for example, image data of the plurality of selectable reels stored in the video RAM 154 and displayed on the sub display 40 based on image data stored in the image ROM 156 and switches the display screen of the sub display 40 to a reel selection display screen in which the presence of a wild symbol or a bonus symbol is visually recognizable (see FIG. 15B-B). Similarly, when the display button H has been pushed in the reel selection display screen shown in FIG. 15A-B, the CPU determines that a symbol display changing instruction was inputted, and then the CPU 106 rewrites, for example, image data of the plurality of selectable reels stored in the video RAM 154 and displayed on the sub display 40 based on image data stored in the image ROM 156, and switches the display screen on the sub display 40 to a normal reel selection display screen (see FIG. 11A-B).

In Step S102, the CPU 106 determines whether or not a reel selection instruction has been inputted If the judgment result is “YES,” the processing advances to Step S103, and if it is NO the processing advances to Step S104. More specifically, upon the arrow C or D on the touch panel 412 of the sub display 40 being pushed, and accordingly upon the signal from the touch panel 412 being input, the CPU 106 determines that the reel selection instruction has been inputted, and the flow proceeds to Step S103. In a case where the CPU 106 determines that the reel selection instruction was not inputted, the flow proceeds to Step S104.

In Step S103, the CPU 106 moves reels on the sub display 40 in the direction of the rotational axis so as to replace the reels. More specifically, the CPU 106 determines whether the arrow C or the arrow D has been pushed based on the input signal from the touch panel 412. In a case where the CPU 106 determines that the arrow C has been pushed, the CPU 106 rewrites the plurality of selectable reels displayed on the sub display 40 that are stored in the RAM 110, the symbol groups disposed on each of the plurality of reels, the symbol arrangement table, and the like. Then, as shown in FIG. 11B-B, the CPU causes the reels 401 to 410, which can be displayed or the sub display 40, to rotate in a clockwise direction. Thus, the selectable reels 401 to 407 move to the left side along the axial direction of the reels, and then the reel 401 disappears to the left side and the reel 408 appears on the right side of the reel 407. In addition, in a case where the CPU 106 determines that the arrow D has been pushed, the CPU 106 rewrites the plurality of selectable reels displayed on the sub display 40 that are stored in the RAM 110, the symbol groups disposed on each of the plurality of reels, the symbol arrangement table, and the like. Then, as shown in FIG. 11B-B, the CPU causes the reels 401 to 410, which can be displayed on the sub display 40, to rotate in a counterclockwise direction. Thus, the reels 401 to 407 that can be displayed move to the right side along the axial direction of the reels. Then, the reel 407 disappears to the right side and the reel 410 appears on the left side of the reel 401.

In Step S104, the CPU 106 determines whether or not the reel rotation instruction has been inputted. If the judgment result is “YES,” the processing advances to Step S105, and if it is “NO,” the processing advances to Step S106. More specifically, upon the up-pointing arrow or the down-pointing arrow on the touch panel 412 of the sub display 40 being pushed, and accordingly upon the signal from the touch panel 412 being input, the CPU 106 determines that the reel rotation instruction was inputted, and the flow proceeds to Step S105. In a case where the CPU 106 determines that the reel rotation instruction was not inputted, the flow proceeds to Step S106.

In Step S105, the CPU 106 displays the reels rotating around the rotational axis on the sub display 40. More specifically, the CPU 106 determines the up-pointing arrow or the down-pointing arrow pushed based on a signal inputted from the touch panel 412, and causes the corresponding reels to rotate. For example, when the player pushes the up-pointing arrow A of the reel 401, and accordingly the signal from the touch panel 412 is inputted, the CPU 106 rewrites the plurality of selectable reels displayed on the sub display 40 that are stored in the RAM 110, the symbol groups disposed on each of the plurality of reels, the data related to the reel 401 from the symbol arrangement table, and the like. Then, the CPU causes the reels 401 to rotate in an up direction around the rotational axis. Similarly, when the player pushes the down-pointing arrow B of the reel 401, and accordingly the signal from the touch panel 412 is inputted, the CPU 106 rewrites the plurality of selectable reels displayed on the sub display 40 that are stored in the RAM 110, the symbol groups disposed on each of the plurality of reels, the data related to the reel 401 from the symbol arrangement table, and the like. Then, the CPU causes the reels 401 to rotate in a down direction around the rotational axis.

In Step S106, the CPU 106 determines whether or not a reel viewpoint changing instruction has been inputted. If the judgment result is “YES,” the processing advances to Step S107, and if it is “NO,” the processing advances to Step S108. More specifically, upon the button L or R on the touch panel 412 of the sub display 40 being pushed, and accordingly upon the signal from the touch panel 412 being input, the CPU 106 determines that the reel viewpoint changing instruction has been inputted, and the flow proceeds to Step S107. In a case where the CPU 106 determines that the reel viewpoint changing instruction has not been inputted, the flow proceeds to Step S108.

In Step S107, the CPU 106 changes a reel viewpoint of the sub display 40. More specifically, the CPU 106 determines whether the button L or R was pushed based on the signal inputted from the touch panel 412. In a case where the CPU 106 determines that the button L was pushed, the CPU 106 rewrites, for example, image data of the plurality of selectable reels displayed on the sub display 40 that is stored in the video RAM 154 based on image data stored in the image ROM 156 and, as shown in FIG. 8A-B, displays the image data 3-dimensionally from a point of view which is substantially 45 degrees diagonally backwards to the left from the display screen. Similarly, in a case where the CPU 106 determines that the button R has been pushed, the CPU 106 rewrites, for example, image data of the plurality of selectable reels displayed on the sub display 40 that is stored in the video RAM 154 based on image data stored in the image ROM 156 and, as shown in FIG. 8B-B, displays the image data 3-dimensionally from a point of view which is substantially 45 degrees diagonally backwards to the left from the display screen.

In Step S108, the CPU 106 determines whether or not a reel setting instruction has been inputted. If the judgment result is “YES,” the processing advances to Step S109, and if it is “NO,” the processing advances to Step S102. More specifically, upon the determination button G on the touch panel 412 of the sub display 40 being pushed, and accordingly upon the signal from the touch panel 412 being input, the CPU 106 determines that the reel setting instruction was inputted, and the flow proceeds to Step S109. In a case where the CPU 106 determines that the reel setting instruction has not been inputted, the flow proceeds to Step S102. In addition, when the player pushes the determination button G after pushing the selectable reel separately, the reel is highlighted, but the CPU 106 does not determine that the reel setting instruction has been inputted, and moves the processing to Step S102. The reel highlighted remains the same location on the selection display screen even when the arrow C or D is pushed. As described above, the plurality of selectable reels 401 to 410 as shown in FIG. 11B-B are stored in the RAM 110 in a way in which each reel is adjacent to each other. However, the highlighted reel is moved outside from the circle of the selectable reels until the determination button G is pushed again. Thus, by pushing the arrow C or D while a specific reel is highlighted, the arrangement of the plurality of reels 401 to 410, which are arranged adjacent to each other and stored in the RAM 110 as well as the symbol arrangement table, can be changed.

In Step S109, the CPU 106 displays the reel selected on the main display 30. More specifically, the CPU 106 rewrites, for example, image data of the plurality of selectable reels displayed on the sub display 40 and the main display 30 that is stored in the video RAM 154 based on image data stored in the image ROM 156, and executes the following rendered effects. Firstly, as shown in FIG. 16A, the reels 401A and 407S at both ends among the selectable reel groups 401S to 407S are darkened, and the reel groups 402S to 406S, which are located at the center, are highlighted as the reels that are set. Next, the reel groups 402S to 406S located at the center are displayed to be enlarged, as shown in FIG. 16B-B. In addition, the image of the reel groups 402S to 406S are moved in a down direction, as shown in FIG. 16C-B. Then, the image of the reel groups 402S to 406S are moved from the sub display 40 to the main display 30, and displayed solely on the main display 30, as shown in FIG. 16D-B. In addition, the CPU 106 rewrites the plurality of reels stored in the RAM 110 and displayed on the main display 30, symbol groups disposed on each of the plurality of reels, a symbol arrangement table, and the like. The CPU 106 moves the processing to Step S110.

In Step S110, rendered effects are displayed on the sub display 40. More specifically, after the CPU 106 rewrites the plurality of reels displayed on the main display 30 that are stored in the RAM 110 and data related to the symbol groups disposed on each of the plurality of reels to data corresponding to the reel groups 402S to 406S, as shown in FIG. 17-B, the CPU 106 rewrites image data displayed on the main display 30 that is stored in the video RAM 154 and displays the reel groups 402S to 406S thus selected as a game screen. In addition, the CPU 106 displays rendered effects corresponding to the reel groups selected on the sub display 40 based on the rendered effects stored in the image data ROM 156. In the present embodiment, as shown in FIG. 17-B, since the player selected the reel group which includes relatively many bonus symbols and wild symbols, the rendered image displayed on the sub display 40 shows a message for trying to look for a bonus. Thus, it is preferred that data for the rendered effects stored in the image data ROM 156 is selected in relation to each reel group that the player selects. Alternatively, data for the rendered effects stored in the image data ROM 156 may be associated with each reel group that the player selects, respectively. Thus, since the player can reflect the player's will on the reels and symbols used in games, it can increase the player's interest in game playing.

Thus, according to the gaming machine 15 of the present embodiment, since a reel selection display screen is displayed on the sub display 40 and the player can select reels to be used in the games so as to reflect the player's will on the reels and symbols used in the games, it can increase the player's interest in game playing. In addition, according to the gaming machine 15 of the present embodiment, reels are displayed 3-dimensionally, and visual recognizability is increased due to being rendered 3-dimensionally, which can add various rendered effects on the symbols displayed on the reels, thereby providing more surprises and greater enjoyment.

In the present embodiment, although it is described that the number of selectable reels displayed on the reel selection display screen is greater than that of reels displayed on the game screen during a game, any number of the selectable reels displayed on the reel selection display screen may be acceptable as long as the number thereof is appropriate while selecting a reel. For example, the number may be the same as that of reels displayed on the game screen.

In addition, in the present embodiment, although a predetermined number of reels is displayed on the reel selection display screen, a plurality of reel groups available during a game may be displayed on the reel selection display screen. In the following embodiment, a case in which a plurality of reel groups available during a game is displayed on a reel selection display screen is described.

### Second Embodiment

A gaming machine of a second embodiment of the present invention is described with reference to FIGS. 18-B to 20B-B. The gaming machine of the second embodiment has substantially the same configuration and operations as those in the gaming machine of the first embodiment, other than that a plurality of reel groups available is displayed on a reel selection display screen. In the following description of a second embodiment, the same components and operations as those in the first embodiment are denoted by the same reference numerals, and descriptions thereof are omitted or simplified. FIG. 18-B shows an example of a reel selection display screen that displays a plurality of selectable reels displayed on the sub display 40. FIG. 19-B is a flowchart showing reel selection processing executed in the present embodiment. FIGS. 20A-B and 20B-B are diagrams illustrating images displayed on the sub display 40 and the main display 30 during execution of the reel selection processing.

As shown in FIG. 18-B, in the present embodiment, a plurality of selectable reel groups is displayed on the reel selection display screen displayed on the sub display 40. As with the video reels shown in FIG. 9-B, each symbol line with each code number is arranged on a reel group 40A including the video reels 401A to 405A, a reel group 40B including the video reels 401B to 405B, a reel group 40C including the video reels 401C to 405C, and a reel group 40D including the video reels 401D to 405D, which can be displayed on the sub display 40. These code numbers are converted to data in a data table so as to be stored in the abovementioned ROM 108 and the RAM 110 (see FIG. 4-B) along with the symbol arrangement table as shown in FIG. 10-B. In addition, it should be noted that image data used for displaying images corresponding to the plurality of reel groups 40A to 40D on the main display 30 and the sub display 40 is stored in the image data ROM 156 and the video RAM 154.

In addition, a display button H and a selection button I is displayed on images displaying each of the reel groups 40A to 40D, respectively. Since the sub display 40 includes a touch panel, the player can input various commands to the gaming machine 15 by pushing these buttons. As described above, upon pushing the display button H, it is switched to a reel selection display screen on the sub display 40 which a player can visually recognize the number of bonus symbols and wild symbols (see FIG. 15A-B). Upon pushing the display button H in the reel selection display screen shown in FIG. 15A-B, it is switched to a reel selection display screen on the sub display 40 in which a player can visually recognize whether a wild symbol or a bonus symbol is rearranged (see FIG. 15B-B). In a case where there is a bonus symbol or a wild symbol in the reel selection display screen shown in FIG. 15B-B, corresponding lamps are turned on, and otherwise, turned off. Upon pushing the display button H in tho display screen of FIG. 15B-B, it is switched to the reel selection display screen on the sub display 40 shown in FIG. 11A-B. In addition, upon pushing the selection button I, the player can input selection instruction for indicating selection of a reel group pushed on the touch panel of the gaming machine 15. In addition, by pushing the selection button I displayed in the image of the reel group that the player selected, it can be recognized as setting instruction for setting the reel group as the reel group used in a game by the player.

The reel selection processing of the present embodiment is described with reference to FIGS. 18-B to 20B-B.

In Step S201, the CPU 106 on the game controller 100 displays a predetermined number of reels including a bonus symbol and a wild symbol with various visual modes on the sub display 40. More specifically, the CPU 106 rewrites, for example, image data of the plurality of selectable reels stored in the video RAM 154 and displayed on the sub display 40 based on image data stored in the image ROM 156, and displays a plurality of selectable reel groups 40A to 40D which has been currently stored in the RAM 110 as well as symbol groups disposed thereon (see FIG. 18B). Here, the selectable reels 401S to 407S includes two types of reels in which the one reel displays a predetermined number of a specific symbol which is either a wild symbol or a bonus symbol, where the a bonus symbol assures a high dividend, and a wild symbol functions as any of usual symbols when it is arranged on an active pay line, and the other reel displays a predetermined number of two specific symbols which is both the wild symbol or the bonus symbol. These reels are displayed so that either one of or both the number and the type of specific symbols displayed on each reel can be visually recognized.

That is, since the sub display 40 includes a touch panel, as described in the first embodiment, when a player pushes the display button H in a reel selection display screen shown in FIG. 11A-B, it is configured to be switched to a reel selection display screen in which a player can visually recognize the number of bonus symbols and wild symbols (see FIG. 15A-B), a reel selection display screen in which a player can visually recognize whether a wild symbol or a bonus symbol is rearranged (see FIG. 15B-B), or a display screen to a normal reel selection display screen (see FIG. 11A-B). Subsequently, CPU 106 advances the process to Step S202.

In Step S202, the CPU 106 determines whether or not a reel selection instruction has been inputted. If it is a “YES” determination, the CPU advances the processing to Step S203, and if it is a “NO” determination, the CPU advances the processing to Step S204. More specifically, upon the selection button I on the touch panel 412 of the sub display 40 being pushed, and accordingly upon the signal from the touch panel 412 being input, the CPU 106 determines that the reel selection instruction was inputted, and the flow proceeds to Step S203. In a case where the CPU 106 determines that the reel selection instruction has not been inputted, the flow proceeds to Step S204.

In Step S203, a reel group selected from the reel groups on the sub display 40 is highlighted. More specifically, when the CPU 106 determines a reel group such as a reel group 40A selected based on the signal inputted from the touch panel 412, the CPU 106 rewrites for example, image data of the plurality of selectable reels displayed on the sub display 40 that is stored in the video RAM 154 based on image data stored in the image ROM 156. In addition, as shown in FIG. 20A-B, the CPU 106 darkens the reel groups 40B to 40D which have not been selected among the selectable reel groups 40A to 40D and highlights the reel group as the selected one. Subsequently, the flow proceeds to Step S204 according to the instruction from the CPU 106.

In Step S204, the CPU 106 determines whether or not a reel setting instruction is inputted. If it is a “YES” determination, the CPU advances the processing to Step S205, and if it is a “NO” determination, the CPU moves the processing to Step S202. More specifically, upon the selection button I on the touch panel 412 of the reel group 40A, which is currently highlighted, on the sub display 40 being pushed, and accordingly upon the signal from the touch panel 412 being input, the CPU 106 determines that the reel setting instruction was inputted, and the flow proceeds to Step S205. In a case where a selection button I other than that of the reel group 40A, which has been currently highlighted, on the sub display 40 is pushed again, the CPU 106 moves the processing to Step S202.

In Step S205, the CPU 106 displays the reel selected on the main display 30. More specifically, the CPU 106 rewrites, for example, image data of the plurality of selectable reels displayed on the main display 30 and the sub display 40 that is stored in the video RAM 154 based on the image data stored in the image data ROM 156 and, as shown in FIG. 20B-B, displays the image data thus selected, which is enlarged, on the sub display 40. Processing for displaying rendered effects on the sub display 40 executed in Steps S205 and S206 are similar to those described in the first embodiment with reference to FIG. 16B-B to FIG. 17-B, and are, therefore, abbreviated. Furthermore, in Step S204, the reel rotation processing and the reel viewpoint changing processing executed in Steps S104 to S106 described in the first embodiment may be performed so that the player can reconsider after displaying the image data thus selected, which is enlarged, on the sub display 40. In addition, Steps S205 and S206 may be performed after the selection button I is pushed again.

Thus, according to the gaming machine 15 of the present embodiment, since a reel selection display screen is displayed on the sub display 40 and the player can select a reel group used in the games so as to reflect the player's will on the reel groups and symbols used in the games, it can increase the player's interest in game playing. In addition, according to the gaming machine 15 of the present invention, since reels are displayed 3-dimensionally, which can adds various rendered effects on the symbols displayed on the reels, it can enhance the visibility and provide more surprises and greater enjoyment. In addition, it can perform rendered effects for enhancing amusement ability in bonus games which pay out more coins and the like than a so-called normal game. In addition, although a bonus symbol and a wild symbol are described as specific symbols, in the present invention, any symbol that a player aims to acquire on a reel such as “TREASURE BOX”, a symbol with a small prize pattern, and the like may be a specific symbol, and a bonus symbol and/or a wild symbol may not be necessarily included therewith.

In addition, in the gaming machine 15 of the abovementioned embodiments, although the main display 30 is disposed below the sub display 40, the main display 30 may be disposed above the sub display 40. Although the touch panel 412 is provided as an input device, this is not limited thereto and, for example, a selection input-only button may be provided. In addition, processing for selecting a reel group used in a game in order to change a reel group, as described in the abovementioned embodiment, is not limited to a second game, and is applicable to a basic game.

### 3. Gaming Machine Permitting Player To Select Reels After Award Is Determined

A description below is directed to a gaming machine permitting player to select reels after award is determined.

A main part of the present invention is described below. A gaming machine 15 of the invention is provided with memories 108, 110, 154 and 156 for storing image data of a plurality of reels each having a plurality of symbols arranged thereon, a main display 30 for displaying a predetermined number of reels used in a game by using part of the image data of the plurality of reels stored in these memories, a sub display 40 for displaying images by using part of the image data of the plurality of reels stored in these memories, an instruction input device 412 for inputting an instruction from a player, and a controller 100 for executing the following processing by using the image data of the plurality of reels stored in these memories (see FIGS. 2-C and 4-C).

As shown in FIG. 1-C, though a detailed description will be described later, the controller 100, when a start switch is turned on (step S100), generates images to produce rotation display of a predetermined number of reels and performs rotation display on the main display based on the images thus produced (step S200). Thereafter, the controller 100 automatically stops the predetermined number of reels (step S300), and rearranges a plurality of kinds of symbols displayed on the predetermined number of reels on a display region of the main display (step S400). The controller 100 then judges whether an award has been won (step S500) and displays on the sub display the symbols not displayed on the main display (step S600). In response to input from the instruction input device, which instructs the change of a predetermined number of reels to be displayed on the display region of the main display (step S700), the controller 100 displays a replaceable reel group on the sub display (step S800). In response to input from the instruction input device, which instructs the change into the replaceable reel group displayed on the display region of the sub display (step S900) the controller 100 displays the replaceable reel group (displayed on the sub display) on the main display (step S1000), and starts the next game (step S1100).

By the foregoing processing, the player immediately after completing the game can confirm the state of the reels including the symbols usually neither visible nor displayed, and can change them into other reels if desired. This adds unpredictability and enhances enthusiasm. Furthermore, the abovementioned configuration can reflect the player's will on the reels and symbols used in games, it can increase the player's interest in game playing.

The embodiments of the present invention are hereinafter described in detail with reference to the attached drawings.

A gaming machine 15 of a first embodiment of the present invention is described with reference to FIGS. 2-C to 13-C. FIG. 2-C is a perspective view showing an external appearance of the gaming machine 15. As shown in FIG. 2-C, the gaming machine 15 includes a cabinet 20. The cabinet 20 has a structure in which the face facing the player is open. The cabinet 20 contains various components including a game controller 100 (see FIG. 4-C) for electrically controlling the gaming machine 15, and a hopper 44 (see FIG. 4-C) for controlling the insertion, storage, and payout of coins (being one type of game media), and the like. The game media is not restricted to coins. In addition, examples of such game media include medals, tokens, electronic money or electronic value information (credits) having the same value.

The main display 30 is installed substantially in the middle of the front face of the cabinet 20, and the sub display 40 is installed in a lower side of the cabinet 20.

In the present embodiment, the main display 30 and the sub display 40 are configured as liquid crystal panels. The main display 30 and the sub display 40 realize a display device for displaying a variety of images related to the game, including produced images and the like. Such a configuration allows the player to advance the game while visually confirming various kinds of images displayed on the aforementioned main display 30.

The gaming machine 15 is made up of image reels, and five virtual reels can be displayed on the main display 30. It should be noted that the term “video reel” as used here represents a mechanism for displaying a reel on the main display 30 in the form of an image instead of a mechanical reel. Multiple kinds of symbols necessary for a game include “FLAG,” “RACE CHARACTER1,” “RACE CHARACTER2,” “BONUS,” “WILD,” “WILD,” “GOLDEN MASK,” “HOLY GRAIL,” “COMPASS & MAP,” “SNAKE,” “A,” “K,” “Q,” “J,” and “10.” With such an arrangement, the main display 30 displays these symbols with an image as if the reel were rotating.

The other liquid crystal display 40 above the liquid crystal display 30 is a display functioning as a sub display for displaying the rules of the game, demonstration screens, and the like. In the present embodiment, in addition, the sub display 40 displays a symbol sequence disposed on a back side of a reel group that cannot be shown on a game display screen immediately after a result of a winning determination is notified to a player, and displays selectable reels in a case where the player aims to replace reels.

Sound permeable openings 29a and 29b, through which sound effects emitted from a speaker 41 (see FIG. 4-C) contained inside the cabinet 20 are propagated outside the cabinet 20, are disposed on the upper right and left sides of the sub display 40, respectively. The sound transmission openings 29a and 29b generate sound effects and the like in accordance with the progress of the game. Decorative lamps 42a and 42b are disposed on the right and left sides in the middle of the gaming machine 15, respectively. The decorative lamps 42a and 42b emit light in accordance with the progress of the game.

A substantially horizontal control panel 21 is provided below the main display 30. A coin insertion slot 22 is provided on the right side of the control panel 21 to insert coins into the gaming machine 15. On the other hand, the components provided to the left side of the control panel 21 include: a bet switch 23 that allows the player to determine which lines are to be set to active pay lines among nine lines L1, L2, L3, L4, L5, L6, L7, L8, and L9, for providing an award described later (which will simply be referred to as “active pay lines” hereafter), and which allows the player to select the amount of coins as game media that are to be bet on the aforementioned active pay lines; and a spin repeat bet switch 24 that allows the player to play the game again without changing the amount of coins bet on the aforementioned active pay lines from that in the immediately prior game. Such an arrangement allows the player to set the amount of coins bet to the active pay line by performing a pushing operation on either the bet switch 23 or the spin repeat bet switch 24.

In the control panel 21, a start switch 25 for accepting per game the player's operation of starting a game is disposed on the left side of the bet switch 23. Upon performing a pushing operation on either the start switch 25 or the spin repeat bet switch 24, which serves as a trigger to start the game, the image that the aforementioned five mechanical reels 3A to 3E start to rotate is displayed.

A cash out switch 26 is provided near the coin insertion opening 22 on the control panel 21. Upon the player pushing the cash out switch 26, the inserted coins are paid out from a coin payout opening 27 provided at a lower portion of the front face. The coins thus paid out are retained in a coin tray 28.

FIG. 3-C is an enlarged top view of a display area configuring a game screen which is displayed on the main display 30 of the gaming machine 15 during a game. The game screen includes an active area for providing an award. The gaming machine 15 includes lines L1 to L9 for providing nine awards as shown in FIG. 3-C. The lines L1 to L9 for providing each award extend so as to pass through a symbol on each of the image reels 3A to 3E when the spinning images of the 5 video reels 3A to 3E come to a stop.

When the abovementioned BET switch 23 is pressed once, for example, the line L3 for providing a third award, the line L5 for providing a fifth award, and the line L7 for providing a seventh award are set to be active pay lines, and one coin is consumed as a credit medal.

Furthermore, upon pushing the aforementioned bet switch 23 twice, the line L1 for providing a first award, the line L4 for providing a fourth award, and the line L8 for providing an eighth award, are set to be active pay lines, in addition to the aforementioned three lines, and two coins are consumed as credit medals, for example.

Moreover, upon pushing the aforementioned bet switch 23 three times, the line L2 for providing a second award, the line L6 for providing a sixth award, and the line L9 for providing a ninth award are set to be active pay lines, in addition to the aforementioned six lines, and three coins are input as credit medals, for example.

The game available in the present embodiment is a game in which a predetermined set of symbols are made along the active pay lines.

In addition, it is arranged so that a payout number display portion 48, a bet number display portion 50, and a credit number display portion 49 can be displayed in this order from the left side on the upper portion of the main display 30. The payout display portion 48 is a component for displaying the amount of the coins paid out when a specific combination of the symbols for providing an award has been achieved along any one of the active pay lines. The credit number display portion 49 displays the credit amount of coins stored in the gaming machine 15. The bet number display portion 50 is a component for displaying the bet amount which is the amount of coins bet on the aforementioned active pay lines.

FIG. 4-C is a block diagram showing an electric configuration of the game controller of the gaming machine 15. Referring to FIG. 4-C, the game controller 100 of the gaming machine 15 is a microcomputer and is provided with an interface circuit group 102, an input/output bus 104, a CPU 106, ROM 108, RAM 110, an interface circuit 111 for communication, a random number generator 112 a speaker drive circuit 122, a hopper drive circuit 124, a lamp drive circuit 126, and a display/input controller 140.

The interface circuit group 102 is electrically connected with the input/output bus 104, which carries out input and output of data signals or address signals for CPU 106.

The start switch 25 is electrically connected with the interface circuit group 102. In the interface circuit group 102, a start signal generated by the start switch 25 is converted into a predetermined form of signal to be supplied to the input/output bus 1(04.

Furthermore, the bet switch 23, the spin repeat bet switch 24, and the cash out switch 26 are connected to the interface circuit group 102. Each of the switching signals output from these switches 23, 24, and 26 is also supplied to the interface circuit group 102, and is converted into a predetermined signal by the interface circuit group 102. The switching signals thus converted are supplied to the input/output bus 104.

A coin sensor 43 is also electrically connected with the interface circuit group 102. The coin sensor 43 detects coins inserted into the coin insertion slot 22, and is disposed at an appropriate position relative to the coin insertion slot 22. The sensing signal output from the coin sensor 43 is also supplied to the interface circuit group 102, and is converted into a predetermined signal by the interface circuit group 102. The sensing signal thus converted is supplied to the input/output bus 104.

The ROM 108 and the RAM 110 are connected to the input/output bus 104.

Upon acceptance of the start operation of a game by way of the start switch 25, the CPU 106 reads a game program to execute the game. The game program executes an image starting scrolling of the symbols on the five video reels is provided on the main display 30 via the display/input controller 140, and then, an image for stopping the five video reels is displayed so as to rearrange the symbols on the five video reels. If that combination of symbols stopped is displayed on the active pay lines and the combination corresponds to a specific combination for which an award is provided, the number of coins associated with the specific combination is paid out.

The ROM 108 stores a control program for governing and controlling the gaming machine 15, a program for executing routines as shown in FIG. 13-C and 14-C (hereinafter referred to as a “routine execution program”), and initial data for executing the control program, and various data tables used in decision processing. The routine execution program includes the abovementioned game program. As an example of the data tables, there is a table as shown in FIG. 10-C. The RAM 110 temporarily stores a plurality of reels and symbol groups provided on each of the plurality of reels displayed on the main display 30, a plurality of selectable reels and symbol groups provided on each of the plurality of reels displayed on the sub display 40, a data table including a symbol arrangement table, and a flag, a variable, and data used in the control program.

Furthermore, a communication interface circuit 11 is connected to the input/output bus 104. The communication interface circuit 111 is a circuit for communicating with a controller for an external control unit (not shown), etc. via the network including various types of networks.

The random number generator 112 for generating a random number is connected to the input/output bus 104. The random number generator 112 generates random numbers in a predetermined range of “0” to “65535” (the sixteenth power of two minus one), for example. Alternatively, an arrangement may be made in which the CPU 106 generates a random number by computation.

The speaker drive circuit 122 for the speakers 41 is also electrically connected with the input/output bus 104. The CPU 106 reads the sound data stored in the ROM 108, and transmits the sound data thus read to the speaker driving circuit 122 via the input/output bus 104. In this way, the speakers 41 generate predetermined sound effects.

The hopper drive circuit 124 for driving the hopper 44 is also electrically connected with the input/output bus 104. Upon reception of a cash out signal input from the cash out switch 26, the CPU 106 transmits a driving signal to the hopper driving circuit 124 via the input/output bus 104. Accordingly, the hopper 44 pays out coins such that the amount thereof is equivalent to the current number of coins remaining as credits, which is stored in a predetermined memory area of the RAM 110.

Alternatively, the payout of the coins may be performed in a mode of storing credit data in a data card or the like, instead of using physical coins. That is, the player may carry a card functioning as a recording medium, and store the data related to the credit by inserting the card into the gaming machine 15.

The lamp drive circuit 126 for driving the decorative lamps 42a and 42b is also connected with the input/output bus 104. The CPU 106 transmits the signal for driving the lamps according to the predetermined conditions based on the program stored in the ROM 108 to the lamp driving circuit 126. In this way, decorative lamps 42a and 42b blink and the like.

The display/input controller 140 is connected to the input/output controller 140. The CPU 106 creates an image display command corresponding to the state and results of the game, and outputs the image display command thus created to the display/input controller 140 via the input/output bus 104. Upon receiving the image display command input from the CPU 106, the display/input controller 140 creates a driving signal for driving the main display 30 according to the image display command thus input, and outputs the driving signal thus created to the main display 30. This results in a predetermined image displayed on the main display 30. In addition, the gaming machine 15 includes a touch panel 412 on a surface of the sub display 40. The touch panel 412 accepts an input by a player corresponding to the player's pushing location and pushing duration, and outputs the input signal generated by the player's input to the CPU 106 via the input/output bus 104. The image display instruction also contains the instructions in accordance with the payout number display portion 48, the credit number display portion 49, and the bet number display portion 50.

FIG. 5-C is a block diagram showing an electric configuration of a display/input controller 140 of the gaming machine 15. The display/input controller 140 of the gaming machine 15 is a sub-micro computer which performs image display processing and the control of input from the touch panel 412, and which has an interface circuit 142, an input/output bus 144, a CPU 146, ROM 148, RAM 150, a VDP 152, video RAM 154, ROM 156 for image data, a drive circuit 158, and a touch panel control circuit 160.

The interface circuit 142 is connected to the input/output bus 144. The image display command outputted from the CPU 106 on the came controller 100 is supplied to the input/output bus 144 via the interface circuit 142. The input/output bus 144 performs input/output of data signals or address signals to and from the CPU 146.

The ROM 148 and the RAM 150 are connected to the input/output bus 144. The ROM 148 stores a display control program under which a drive signal to be supplied to the main display 30 is generated based on the image display instruction from the CPU 106 on the game controller 100. On the other hand, the RAM 150 stores flags and variables used in the aforementioned display control program.

The VDP 152 is connected to the input/output bus 144. The VDP 152 includes a so-called sprite circuit, a screen circuit, a palette circuit, etc., and can perform various kinds of processing for displaying images on the main display 30. The video RAM 154 and the ROM 156 are connected to the VDP 152. The video RAM 154 stores image data based on the image display instructions from the CPU 106 on the game controller 100. The ROM 156 for image data stores various kinds of image data containing the abovementioned produced image data, symbols for 3-dimensional display (described later), and the like. Furthermore, the driving circuit 158 for outputting a driving signal for driving the main display 30 and the sub display 40 is connected to the VDP 152.

By reading and executing the display control program stored in the ROM 148, the CPU 146 instructs the video RAM 154 to store image data to be displayed on the main display 30 and the sub display 40 in response to the image display instruction from the CPU 106 on the game controller 100. Examples of the image display commands include various kinds of image display commands including the aforementioned image display commands for visual effects, etc.

The image data ROM 156 stores various kinds of image data including the image data that provides visual effects.

The touch panel control circuit 160 outputs the signals inputted via the touch panel 412 provided on the sub display 40 to the CPU 106 via the input/output bus 144 in the form of an input signal.

FIG. 6-C is an exploded perspective view showing a configuration of a portion of the sub display 40. The sub display 40 functions as a sub display for displaying selectable reels during selection of reels. For this reason, the sub display 40 includes: a front panel 411 having a touch panel 412 and a display plate 413; a transparent liquid crystal panel 414; a light-introducing plate 415; a reflecting film 416; fluorescent lamps 417A and 417B, which serve as a so-called white light source; and a Table Carrier Package (TCP) mounting ICs for driving the transparent liquid crystal panel. In addition, it should be noted that although not shown in FIG. 5-C, it may be possible for the TCP to include a flexible printed board (not shown) connected with terminals of the transparent liquid crystal panel 414. The touch panel 412 is formed of a transparent member. The display plate 413 is formed of a transparent member.

A method of displaying selectable reels displayed on the sub display 40 in reel display selection processing (described later) is described with reference to FIGS. 7-C, 8A-C, and 8B-C. Selectable reels are displayed 3-dimensionally on the sub display 40 in the present embodiment. FIG. 7-C is a diagram illustrating a method of displaying selectable reels 3-dimensionally on the sub display 40. Using two virtual cameras 501A and 501B, a plurality of reels 401 to 401 represented using a local coordinate system (x, y, z) are displayed on the sub display 40 in such a manner that perspective transformation is performed for a virtual 3-dimensional space on a world coordinate system (X′, Y′, Z′) and (X″, Y″, Z″) so that each axis of the local coordinate system is at a predetermined angle (in the present embodiment, substantially 45 degrees) to each axis of the world coordinate system. Examples of the 3-dimensional images thus generated are shown in FIGS. 8A-C and 8B-C. FIG. 8A-C is a display screen on the sub display 40 in which the plurality of reels 401 to 407 that the player can select are displayed 3-dimensionally with a point of view which is substantially 45 degrees diagonally backwards to the right from the display screen. FIG. 8B-C is a display screen on the sub display 40 in which the plurality of reels 401 to 407 that the player can select are displayed 3-dimensionally with a point of view which is substantially 45 degrees diagonally backwards to the left from the display screen. Accordingly, perspective transformation and a point of view from the virtual cameras are important to display the plurality of reels in three dimensions with a plurality of points of view.

A method of displaying the selectable reels in 3-dimensional is described in detail with reference to FIG. 7-C. The virtual cameras 501A and 501B disposed in the virtual 3-D space projects images of the plurality of reels with a point of view which is substantially right rear of 45 degrees from the display screen (see FIG. 8A-C) and images of the plurality of reels with a point of view which is substantially left rear of 45 degrees from the display screen (see FIG. 8B-C) on the virtual screens 510A and 510B, respectively. The positions of the virtual cameras 501A and 501B decides the points of view 503A and 503B, respectively. The directions of the virtual cameras 501A and 501B decides axes of sighting 500A and 500B, respectively. Each of the points of view 503A and 503B decides angles of sight 505A and 505B, each of which consists of two lines connecting apexes of opposing corners of the virtual screens 510A and 501B. Here, the coordinate system of the virtual screen 510A is called a point of view coordinate system (X′, Y′, Z′) and the coordinate system of the virtual screen 510B is called a point of view coordinate system (X″, Y″, Z″), and a Z′ axis and a Z″ axis in the coordinate system are in the direction of the axes of vision 500A and 500B. Here, the coordinate of the world coordinate system including the coordinate converted from the coordinate of the local coordinate system is converted to the coordinate of the point of view coordinate system, and then perspective transformation for the coordinate of the point of view coordinate system is performed. An axis of vision 404 is in the direction of a symbol located substantially at the center of each reel. In a case in which each reel is moved, the axis vision 404 may move, for example, from the direction of the positions 401a and 402a to the positions 401b and 402b so as to face the direction of the symbol located substantially at the center. It should he noted that a stereoscopic effect is enhanced further using, for example, texture mapping processing for the selectable reels displayed on the sub display 40. The image data ROM 156 stores image data thus generated in regards to the plurality of points of view for each video reel, and the CPU 106 rewrites image data of the plurality of selectable reels stored in the video RAM 154 and displayed on the sub display 40 as appropriate based on image data stored in the image data ROM 156. In addition, the method of displaying the selectable reels in 3-dimensionally used in the present embodiment is described as an example, and thus, the present invention is not limited thereto. For one skilled in the art, there may be various conceivable techniques possible that are evident. In addition, although cases of displaying on the sub display 40 at a point of view which is substantially 45 degrees diagonally backwards to the left or substantially 45 degrees diagonally backwards to the right from the display screen have been described, the number of points of view that can be displayed and the angles thereof on the sub display 40 may be varied as appropriate.

FIG. 9-C is a diagram showing symbol lines disposed on each video reel which are displayed during games on the main display 30 of the gaming machine 15 of the present embodiment. FIG. 9-C shows symbol lines on which 21 symbols arranged on each video reel 3A to 3P (see FIG. 3-C) are represented. The symbol line for the first video reel corresponds to the video reel 3A. The symbol line for the second video reel corresponds to the video reel 3B. The symbol line for the third video reel corresponds to the video reel 3C. The symbol line for the fourth video reel corresponds to the video reel 3D. The symbol line for the fifth video reel corresponds to the video reel 3E. When each video reel 3A to 3E rotates around a virtual rotational axis, these symbols appear in the corder depicted in FIG. 9-C.

As shown in FIG. 9-C, a code number of “00” to “20” is referred to for each symbol of video reels 3A to 3E. These code numbers are converted to be data in a data table so as to be stored in the aforementioned ROM 108 and RAM 110 (see FIG. 4-C).

The column of symbols is represented on the image reels 3A to 3E, respectively. More specifically, the column of symbols is made up of a “BONUS” symbol (symbol 61) (hereinafter abbreviated as “BONUS”), a “FLAG” symbol (symbol 62) (hereinafter abbreviated as “FLAG”), a “WILD” symbol (symbol 63) (hereinafter abbreviated as “WILD”), a “GOLDEN MASK” symbol (symbol 64) (hereinafter abbreviated as “GOLDEN MASK”), a “HOLY GRAIL” symbol (symbol 65) (hereinafter abbreviated as “HOLY GRAIL”), a “COMPASS&MAP” symbol (symbol 66) (hereinafter abbreviated as “COMPASS&MAP”), a “SNAKE” symbol (symbol 67) (hereinafter abbreviated as “SNAKE”), a “A” symbol (symbol 68) (hereinafter abbreviated as “A”), a “K” symbol (symbol 69) (hereinafter abbreviated as “K”) “Q” symbol (symbol 70) (hereinafter abbreviated as “Q”), a “J” symbol (symbol 71) (hereinafter abbreviated as “J”), a “10” symbol (symbol 72) (hereinafter abbreviated as “10”), a “RACE CHARACTER 1” (symbol 73) (hereinafter abbreviated as “RACE CHARACTER 1”), and a “RACE CHARACTER 2” (symbol 74) (hereinafter abbreviated as “RACE CHARACTER 2”). The columns of symbols on the image reels 3A to 3E can be moved by the display of an image where the reels 3A to 3E are spinning in a forward direction.

In the present embodiment, “BONUS”, “SECOND”, “SNAKE”, “WILD”, “GOLDEN MASK”, “HOLY GRAIL,”“COMPASS & MAP”, “A”, “K,” “Q,” “J”, and “10” are provided as hands in awarding a predetermined winning. A combination (combination data) is control information which relates credits awarded to a player (the payout amount of coins) to a combination of an award combination, and which is used for stop control of each video reel 3A through 3E, changing (shift) of a game state, providing coins, and the like.

FIG. 10-C is a diagram showing a symbol arrangement table used by the gaming machine 15 of the present embodiment. The symbol arrangement table relates the code number indicating the position of each symbol which constitutes the aforementioned symbol lines to each symbol of the respective video reels 3A to 3E, and then, registers thereof. In addition, the first video reel through the fifth video reel corresponds to the video reels 3A to 3E, respectively. In other words, the symbol arrangement table includes symbol information corresponding to the symbol position (the code number) of video reels 3A to 3E (see FIG. 3-C).

In FIG. 10-C, “MASK,” “COMPASS,” “CHARACTER 1” and “CHARACTER 2” are abbreviations for the abovementioned “GOLDEN MASK,” “COMPASS&MAP,” “CHARACTER 1,” and “CHARACTER 2,” respectively. In addition, a bonus symbol is referred to as “BONUS” and a wild symbol is referred to as “WILD” below.

A bonus is made effective when three or more “BONUS” symbols come to rest on a pay line. When a game is entitled to a bonus, the CPU 106 initiates a second game which is more advantageous than a basic game. In the second game, a bonus symbol assures a high dividend, and a wild symbol functions as any of the normal symbols when it is arranged on an active pay line. In the present embodiment, it should be rioted that a bonus symbol and a wild symbol are described as examples of specific symbols that a player aims to acquire on a reel used in a second game.

FIG. 11A-C shows an example of a reel display selection display screen that displays selectable reels displayed on the sub display 40 in reel selection processing. As described above, in the present embodiment, the number of reels displayed on the main display 30 during games is five, and the number of selectable reels displayed on the sub display 40 is seven.

FIG. 12A-C shows a reel group that can be displayed on the sub display 40 by a player's operation. In the present embodiment, the number of reels that can be displayed on the sub display 40 by a player's operation is ten. As with the video reels shown in FIG. 9-C, each symbol line with each code number is arranged on the video reels 401 to 410 that can be displayed on the sub display 40. These code numbers are converted to be data in a data table so as to be stored in the abovementioned ROM 100 and the RAM 110 (see FIG. 4-C) along with the symbol arrangement table as shown in FIG. 10-C. As shown in FIG. 12A-C, the plurality of reels are stored as data in a way that each reel is adjacent each other.

As shown in FIG. 11A-C, in reel display selection processing, up-pointing and down-pointing arrows are displayed on each of the selectable reels 401 to 407 displayed on the sub display 40. In addition, right-pointing and left-pointing arrows are displayed on the reels 401 and 407, which are located at both ends. Since the sub display 40 includes the touch panel, the player can change the images of the selectable reels 401 to 407 in the direction of the arrows by pushing the arrows on the touch panel. For example, when the player pushes an up-pointing arrow A of the reel 401, the reel 401 rotates in the up direction around the rotational axis. At this time, the symbol “J” on the reel 401 disappears aid the symbol “A” on the reel 401 appears (see FIGS. 9-C and 10-C). Similarly, when the player pushes a down-pointing arrow B of the reel 401, the reel 401 rotates in the down direction around the rotational axis. At this time, the symbol “WILD” disappears on the reel 401 and the symbol “MASK” appears on the reel 401 (see FIGS. 9-C and 10-C).

In addition, as shown in FIG. 12A-C, when the player pushes the arrow C, the reels 401 to 410 which can be displayed on the sub display 40 rotate in a clockwise direction. Thus, the reels 401 to 407 that can be displayed move to the left side along the axial direction of the reels. Then, the reel 401 disappears to the left side and the reel 408 appears on the right side of the reel 407. Similarly, when the player pushes the arrow D, the reels 401 to 410, which can be displayed on the sub display 40, rotate in a counterclockwise direction. Thus, the reels 401 to 4017 that can be displayed move to the right side along the axial direction of the reels. Then, the reel 407 disappears to the right side and the reel 410 appears on the left side of the reel 401.

In addition, a button I, shown by E, a button R shown by F, a determination button shown by G, and a display button shown by H are displayed at the lower left portion and the lower right portion of the display screen which displays the selectable reels 401 to 407 on the sub display 40. Since the sub display 40 includes a touch panel, the player can input various commands to the gaming machine 15 by pushing these buttons. When the player pushes the button L, the selectable reels 401 to 407 are displayed 3 dimensionally from a point of view which is substantially 45 degrees diagonally backwards to the right from the display screen, as shown in FIG. 8A-C. On the other hand, when the player pushes the button R, the selectable reels 401 to 407 are displayed 3-dimensionally from a point of view which is substantially 45 degrees diagonally backwards to the right from the display screen, as shown in FIG. 8B-C. When the player pushes the determination button G, a reel group, which is located at the center among the reel groups currently being displayed, is determined as a reel group used in a game.

When pushing the determination button G immediately after pushing a reel separately among the selectable reels 401 to 407, the reel is highlighted. In a case in which a reel is highlighted separately, even when the player pushes the determination button C, the reel is not determined as a reel used in a game. The reel highlighted remains as the same location on the selection display screen, even when the arrow C or D is pushed. When the player pushes the determination button G again, the reel is released from being highlighted.

With reference to FIGS. 11B-C and 121-C, a case is described in which reels are selected separately and an arrangement of reels on a reel display selection screen is changed. FIG. 11B-C shows a reel that is selected separately and highlighted in reel display selection processing. FIG. 12B-C shows a relationship between the reel selected separately and other reels. In regards to reel display selection processing, for example, upon pushing the determination button G immediately after separately pushing reel 403, reel 403 is highlighted (refer to FIG. 11). At this time, reel 403 is temporarily moved away from reel 402 and reel 404 which are adjacent to the reel 403, as shown in FIG. 12B-C. That is, the arrangement of a plurality of reels 401 to 410 which are adjacent to each other, which is stored along with a symbol arrangement table stored in RAM 110, is released. Since reel 403 is moved outside from the circle of the plurality of reels 401 to 410 which are adjacent each other, reel 403 still remains at the third position from the left on the reel selection display screen even though the other reels are moved, for example, by the operation of the arrow C or the arrow D.

For example, when a player pushes the arrow C once, reel 403 remains at the third position from the left side on the reel selection display screen. However, the other reels move by one frame in a clockwise direction (FIG. 11B-C). When the player pushes the determination button G again, highlighting of reel 403 is released, and reel 403 is located at the third position from the left on the reel selection display screen. Here, while a reel is highlighted separately, even when the player pushes the determination button G, the reels located at the center are not determined as reels to be used in a game. That is, the highlighted reels are simply released. Thus, according to the present embodiment, by pushing the determination button G, the reels located at the center or near the center among the reels 401 to 407 displayed on the reel selection display screen may be replaced collectively. Alternatively, the reels displayed on the reel selection display screen are replaced separately and then all the reels may be replaced.

Regarding the reel selection display screen shown in FIG. 11A-C, upon pushing the display button H, the sub display 40 switches to a reel selection display screen in which the number of bonus and wild symbols are visibly recognizable (see FIG. 16A-C). Upon pushing the display button H in the reel selection display screen shown in FIG. 16A-C, the sub display 40 is switched to a reel selection display screen in which a variety of wild and bonus symbols or the existence thereof are visually recognizable (see FIG. 16B-C). In a case where a bonus symbol or a wild symbol is present in the reel selection display screen shown in FIG. 16B-C, corresponding lamps are turned on, and in a case where they are not present, the corresponding lamps are turned off. Upon pushing the display button H in the display screen of FIG. 16B-C, the sub display 40 switches to the reel selection display screen shown in FIG. 11A-C.

Thus, since the abovementioned configuration can improve the visibility of reels and can reflect the player's will on the reels and symbols used in games, it can increase the player s interest in game playing.

FIG. 13-C is a flowchart showing processing operation executed by the controller 100 of the gaming machine 15. FIG. 14-C is a flowchart showing reel display selection processing in detail among the main processing operations executed by the controller 100 of the gaming machine 15. FIGS. 15-C to 18-C are a diagram illustrating images displayed on the sub display 40 and the main display 30 when the reel display selection processing is executed. A single routine shown in FIG. 13-C is equal to a single unit game.

It should be noted that the gaming machine 15 is activated in advance and the variables used in the CPU 106 on the game controller 100 are initialized to predetermined values, respectively, thereby providing a stationary state of the gaming machine 15.

Firstly, a general description of the main processing operation executed by the controller 100 of the gaming machine 15 is described with reference to FIG. 13-C.

In Step S1, the CPU 106 on the game controller 100 determines whether a certain amount of credits remains, which is the number of remaining coins inserted by the player. More specifically, CPU 106 reads the amount of credits C stored in the RAM 110, and executes processing according to the amount of credits C. When the amount of credits C equals “0” (“NO” in Step S1), the CPU 106 terminates the routine without executing any processing, since it cannot start a game. When the amount of credits C is not less than “1” (“YES” in Step S1), the CPU 106 determines that coins remain as credits, and the CPU 106 moves the processing to Step S2.

In Step S2, CPU 106 determines whether or not a pressing operation has been applied to the spin bet repeat switch 24. When the switch 24 has been pushed and the CPU 106 receives an operation signal from the switch 24 (“YES” in Step S2), the CPU 106 moves the processing to Step S4. On the other hand, when the CPU 106 does not receive the operation signal from the switch 24 after a predetermined period of time elapses (“NO” in Step S2), the CPU 106 determines that the switch 24 has not been pressed and moves the processing to Step S3.

In Step S3, the CPU 106 performs a game condition. More specifically, the CPU 106 determines the amount of coins bet on the active pay lines in this game based on the operation of the bet switch 23. At this time, the CPU 106 determines the bet amount to be bet on the active pay lines based on the number of times signals that indicate operation of the bet switch 23 have been received, and stores the bet amount thus determined in a predetermined memory area of the RAM 110. The CPU 106 reads the amount of credits C stored in a predetermined memory area of the RAM 110, and subtracts the total bet amount, which is the sum of the aforementioned bet amounts, from the amount of credits C thus read. Then, the CPU 106 stores the subtracted value in a predetermined memory area of the RAM 110. Subsequently, the CPU 106 moves the processing to Step S5.

On the other hand, when advancing from Step S2 to Step S4, the CPU 106 determines whether the credit amount C is at least the total bet amount in a previous game. In other words, the CPU 106 determines whether it can start a game in response to a pressing operation applied to the spin repeat bet switch 24. More specifically, in a case that the spin repeat bet switch 24 has been pressed, and accordingly, in a case that the operation signal has been input from the aforementioned switch 24, the CPU 106 reads the amount of credits C and the bet amount bet on each of the active pay lines L1 to L9 in the previous game stored in the predetermined memory areas of the aforementioned RAM 110. Then, the CPU 106 determines whether or not the aforementioned amount of credits C is at least the total bet amount bet in the previous game based upon the relation between the amount of credits C and the bet amount thus read. When the CPU 106 determines that the credit amount C is less than the total bet amount (“NO” in Step S4), the CPU 106 terminates the routine without any processing, since it cannot start a game. On the other hand, in a case where determination has been made that the credit amount C is at least the total bet amount bet in the previous game (in a case of “YES” in the determination processing in Step S4), the CPU 106 subtracts the total bet amount bet in the previous game from the credit amount C, and stores the subtracted value in a predetermined area of the RAM 110. Subsequently, the CPU 106 moves the processing to Step S6.

In the following Step S5, the CPU 106 determines whether the start switch 25 is ON, and then, waits for the start switch 25 to be operated. Upon the start switch 25 being operated, and accordingly, upon the operation signal being input from the start switch 25 (in a case of “YES” in the determination processing in Step S5), the CPU 106 determines that the start switch 25 has been operated, and the flow proceeds to Step S6.

In the following Step S6, the CPU 106 performs stationary symbol determination processing. A specific description is made below regarding the stationary symbol determination processing.

First, the CPU 106 selects a random number in a range of values from 0 to 255 for each of the five reels 3A to 3E by extracting a random number from the random generator 112. Next, the CPU 106 reads payout rate setting data from the ROM 108 to store in the RAM 110, refers to symbol weighting data corresponding to the payout rate setting data, and determines code numbers (see FIG. 6-C) for each of the reels 3A to 3E based on the five random numbers thus selected. The code number selected for each reel 3A to 3E corresponds to the symbol code number of the symbol which is to be rearranged along the pay line. The CPU 106 determines the code numbers for each of the reels 3A to 3E, thereby determining a winning combination. For example, in a case where the CPU 106 determines that the code numbers for each of the reels 3A to 3E are “20,” “20,” “20,” “20,” and “20,” it indicates that the CPU 106 has determined that the winning combination is “BONUS”. In addition, in a case where three or more identical symbols are rearranged on the active pay line, a winning combination corresponding to the rearranged symbol is achieved. In addition, “WILD” symbol functions as any of the normal symbols. Therefore, in a case where two identical symbols and a single “WILD” symbol are arranged on an active pay line, it is assumed that three identical symbols are arranged on an active pay line, which achieves a winning combination. Regarding “BONUS”, in a case in which at least three “BONUS” symbols are rearranged regardless of the active pay lines, the winning combination is determined as “BONUS”. In addition, even in a case where two “BONUS” symbol and at least one “WILD” symbol are rearranged, its winning combination is determined as “BONUS”.

Upon determining stationary symbols, the CPU 106 causes the specific combination data which indicates the stationary symbols thus determined to be stored in the predetermined memory area of the RAM 110. Then, the CPU 106 reads the random number value and the specific combination data stored in the predetermined memory area of the RAM 110 and determines the combination of the symbols to be displayed to be stationary based upon the random number value and the specific combination data thus read. In this stage, a symbol arrangement table stored in the ROM 108 is read by the CPU 106. The symbol arrangement table thus read is stored in a predetermined memory area of the RAM 110, and used as reference data. The CPU 106 causes the stationary symbol combination data, which indicates the stationary symbol combination thus determined, to be stored in a predetermined memory area of the RAM 110. Alternatively, it may be configured that a stationary symbol for each reel is determined using the random number table.

Upon determining the combination of the symbols when stationary with respect to the aforementioned active pay lines, the CPU 106 determines whether the combination of the symbols when they are stationary with respect to the active pay lines matches any one of the specified combinations for providing an award. In a case where the combination of the symbols when they are stationary with respect to the active pay lines matches any one of the specified combinations for providing an award, the CPU 106 activates a flag, which indicates that the player has won the award that corresponds to the kind of specified combination for providing an award, in order to provide the award that corresponds with the specified combination of symbols with respect to the active pay lines for providing the award. The activated flag, which indicates the player has won an award, is stored in a predetermined area of the RAM 110 according to the instruction from the CPU 106. On the other hand, in a case where the combination of the symbols when they are stationary with respect to the active pay lines matches any one of the other combinations, i.e. the losing combinations, the CPU 106 does not activate the flag which indicates that the player has won an award. The CPU 106 then moves the processing to Step S7.

In Step S7, the CPU 106 executes the display of an image where the image reels 3A to 3E have commenced spinning. More specifically, the CPU 106 displays an image which shows rotating the video reels 3A to 3E, in sequence or Simultaneously, based upon the symbol arrangement table stored in the aforementioned RAM 110. The CPU 106 waits until a predetermined period of time is elapsed after displaying an image where the image reels 3A to 3E have commenced spinning (Step S8). After the predetermined period of time has elapsed (in a case of “YES” in the determination processing in Step S7), the CPU 106 instructs the video reels 3A to 3E to automatically stop rotating (Step S9). More specifically, the CPU 106 displays an image showing the video reels 3A to 3E stopping rotation in sequence such that the stationary symbols, which correspond to the specific combinations for providing an award determined in the aforementioned Step S6, are displayed within a display region that has a visually interactive relationship with the player. The CPU 106 then moves the processing to Step S10.

In Step S10, the CPU 106 determines whether or not a predetermined symbol combination is achieved. More specifically, the CPU 106 determines the predetermined symbol combination based on the state of a flag stored in the predetermined area of RAM 110. As described above, the flag indicates providing an award corresponding to a specific combination in a case where a stationary symbol combination matches the specific combination. When the flag is not activated, namely when the specific combination for providing the winning is “others” (when the result is NO in Step S10), the CPU 106 decides that the specific combination for providing the winning is not achieved. Subsequently, the CPU 106 advances the processing to Step S12. On the other hand, in a case where the flag has been activated, i.e. in a case where the symbol combination matches any one of the combinations other than the combination of “Others” (in a case of “YES” in the determination processing in Step S10), the flow proceeds to Step 11 according to the instruction from the CPU 106.

In a case where the flow has proceeded to Step S11, the CPU 106 pays out the amount of coins corresponding to the aforementioned specified combination for providing an award. More specifically, the CPU 106 refers to a payout table and calculates a payout number of coins corresponding to this specific combination. The CPU 106 reads the credit amount stored in the predetermined memory area of the RAM 110, calculates the sum total of the credit amount thus read and the amount of payout thus calculated, and stores the sum thus calculated in the predetermined memory area of the RAM 110. The CPU 106 displays the aforementioned value thus stored on the credit amount display portion 49. Subsequently, the CPU 106 advances the processing to Step S12.

In Step S12, the CPU 106 performs reel display selection processing. Subsequently, the CPU 106 moves the processing to Step S1.

Reel display selection processing is described in detail with reference to FIGS. 14-C to 18-C. FIG. 15-C shows a display screen displayed on the main display 30 and the sub display 40 after a winning determination. On the display screen of the main display 30, the reels and the symbols rearranged after a winning determination are displayed. On the other hand, on the display screen of the sub symbol 40, symbols rearranged on the opposite side of the reels displayed on the display screen of the main display 30 are displayed.

In the present embodiment, reel display selection processing is performed after the reels are rearranged and winning is determined. The player tends to be highly interested in symbols which were not displayed in a case where a player did not win any award. Accordingly, in the reel display selection processing, symbols rearranged on the opposite side of the reels that are not displayed on the main display 30 are displayed first (Step S101). On the other hand, in a case where symbols arranged outside an active area (on the display screen of the main display 30 of FIG. 15-C) for providing an award can be visually recognized by the player, it is possible that the player will continue the game if the combination of symbols currently displayed in an award winning area is close to any one of specified combinations for providing an award, and it is possible that the player will hesitate to continue the game if the combination of symbols currently displayed in an award winning area is far from any one of specified combinations for providing an award. For this reason, in reel display selection processing of the present embodiment, the symbols rearranged on the opposite side of the reel used in a current game can be visually recognized by the player, and moreover, the reels can be replaced as appropriate (Steps S102 to S110).

A bonus is made effective when three or more “BONUS” symbols come to rest on a pay line. When a game is entitled to a bonus, the CPU 106 initiates a second game which is more advantageous than a basic game. In the second game, a bonus symbol assures a high dividend, and a wild symbol functions as any of the normal symbols when it is arranged on an active pay line. In the present embodiment, it should be noted that a bonus symbol and a wild symbol are specific symbols that a player aims to acquire on a reel used in a second game.

Reel selection processing is described in detail with reference to FIGS. 14-C to 18-C.

In Step S101, the CPU 106 on the game controller 100 displays, on the sub display 40, symbols rearranged on the opposite side of the reel displayed on the main display 30 upon a winning determination. More specifically, the CPU 106 reads a plurality of reels displayed on the main display 30 stored in the RAM 110, symbol groups depicted on each of the plurality of reels, and a data table including a symbol arrangement table, and also reads a reel group and symbols that are currently displayed on the main display 30, so as to specify a reel group and symbols thereof displayed on the sub display 40. Next, the CPU 106 rewrites, for example, image data displayed on the sub display 40 that is stored in the video RAM 154 based on image data stored in the image ROM 156, and displays the reel group and the symbols thus specified 3-dimensionally. A display screen displayed on the main display 30 and the sub display 40 at this time is shown in FIG. 15-C. As described above, in FIG. 15-C, the reel group and the symbols rearranged after a winning determination are shown on the display screen of the main display 30, and the symbols rearranged on the opposite side of the reels are displayed on the display screen of the main display 30.

In the present embodiment, at this time, a predetermined number of reels including a bonus symbol and a wild symbol that a player expects is displayed so as to be visually recognizable by various modes on the sub display 40. More specifically, the CPU 106 rewrites, for example, image data of the plurality of selectable reels stored in the video RAM 154 and displayed on the sub display 40 based on image data stored in the image ROM 156, and displays a plurality of reels 401 to 407, which is currently stored in the RAM 110, as well as symbol groups disposed thereon (see FIG. 15-C). Subsequently, the CPU 106 moves the processing to Step S102.

Here, the selectable reels 401 to 407 at least include two types of reels, and include among at least two kinds of specific symbols, a high dividend assuring bonus symbol that is a bonus symbol assuring a high dividend and a wild symbol that functions as any of the normal symbols, in which a first type of reel displays a predetermined number of any one kind of specific symbols from a bonus symbol and a wild symbol, and a second type of reel displays a predetermined number of two kinds of specific symbols from a wild symbol and a bonus symbol. These reels are displayed so that either one or both the number and type of specific symbols displayed on each reel can be visually recognized by the operation of the button H.

Since the sub display 40 includes a touch panel, when the player pushes the display button H on the reel selection display screen shown in FIG. 15-C, a signal for charging a symbol display is inputted from the touch panel 412 to the CPU 106. When the CPU 106 determines that a symbol display changing instruction has inputted, the CPU 106 rewrites, for example, image data of the plurality of selectable reels stored in the video RAM 154 and displayed on the sub display 40 based on image data stored in the image ROM 156, and switches a display screen of the sub display 40 to a reel selection display screen in which the number of bonus symbols and wild symbols can be visually recognized (see FIG. 16A-C). Similarly, when the display button H has been pushed in the reel selection display screen shown in FIG. 16A-C, the CPU determines that a symbol display changing instruction was inputted, and then, the CPU 106 rewrites, for example, image data of the plurality of selectable reels stored in the video RAM 154 and displayed on the sub display 40 based on image data stored in the image ROM 156, and, switches the display screen of the sub display 40 to a reel selection display screen in which the presence of a wild symbol or a bonus symbol is visually recognized (see FIG. 16B-C). Similarly, when the display button H has been pushed in the reel selection display screen shown in FIG. 16B-C, (the CPU 106 determines that a symbol display changing instruction was inputted, and then the CPU 106 rewrites, for example, image data of the plurality of selectable reels stored in the video RAM 154 and displayed on the sub display 40 based on image data stored in the image ROM 156, and switches the display screen on the sub display 40 to a normal reel selection display screen (see FIG. 15-C).

The player can determine whether to continue the game with the current arrangement of the reels or to change it by seeing the display screen. That is, in a case where the player tries to continue the game with the arrangement of the reels, the player simply pushes the determination button G. On the other hand, in a case where the player tries to change the arrangement of the reels, the player pushes the arrow C or D. Furthermore, in a case where the player tries to confirm the current arrangement of the reels in detail, the player can push the up-pointing arrow or the down-pointing arrow so as to confirm each of the symbols on the reels. More specifically, the following Steps S102 to S110 are performed.

In Step S102, the CPU 106 determines whether or not a reel selection instruction has been inputted. If the judgment result is “YES,” the processing advances to Step S103, and if it is “NO,” the processing advances to Step S1(04. More specifically, upon the arrow C or D on the touch panel 412 of the sub display 40 being pushed, and accordingly upon the signal from the touch panel 412 being input, the CPU 1(06 determines that the reel selection instruction has been inputted, and the flow proceeds to Step S103. In a case where the CPU 106 determines that the reel selection instruction was not inputted, the flow proceeds to Step S104.

In Step S103, the CPU 106 moves reels on the sub display 40 in the direction of the rotational axis so as to replace the reels. More specifically, the CPU 106 determines whether the arrow C or the arrow D has been pushed based on the input signal from the touch panel 412. In a case where the CPU 106 determines that the arrow C has been pushed, the CPU 106 rewrites the plurality of selectable reels displayed on the sub display 40 that are stored in the RAM 110 the symbol groups disposed on each of the plurality of reels, the symbol arrangement table, and the like. Then, as shown in FIG. 12A-C, the CPU causes the reels 401 to 410, which can be displayed on the sub display 40, to rotate in a clockwise direction. Thus, the selectable reels 401 to 407 move to the left side along the axial direction of the reels, and then the reel 401 disappears to the left side and the reel 408 appears on the right side of the reel 407. In addition, in a case where the CPU 106 determines that the arrow D has been pushed, the CPU 106 rewrites the plurality of selectable reels displayed on the sub display 40 that are stored in the RAM 110, the symbol groups disposed on each of the plurality of reels, the symbol arrangement table, and the like. Then, as shown in FIG. 12A-C, the CPU causes the reels 401 to 410, which can he displayed on the sub display 40, to rotate in a counterclockwise direction. Thus, the reels 401 to 407 that can be displayed move to the right side along the axial direction of the reels. Then, the reel 407 disappears to the right side and the reel 410 appears on the left side of the reel 401. Subsequently, the flow proceeds to Step S104 according to the instruction from the CPU 106.

In Step S104, the CPU 106 determines whether or not the reel rotation instruction has been inputted. If the judgment result is “YES,” the processing advances to Step S105, and if it is “NO,” the processing advances to Step S106. More specifically, upon the up-pointing arrow or the down-pointing arrow on the touch panel 412 of the sub display 40 being pushed, and accordingly upon the signal from the touch panel 412 being input, the CPU 106 determines that the reel rotation instruction was inputted, and the flow proceeds to Step S105. In a case where the CPU 106 determines that the reel rotation instruction was not inputted, the flow proceeds to Step S106.

In Step S105, the CPU 106 displays the reels rotating around the rotational axis on the sub display 40. More specifically, the CPU 106 determines the up-pointing arrow or the down-pointing arrow pushed based on a signal inputted from the touch panel 412, and causes the corresponding reels to rotate. For example, when the player pushes the up-pointing arrow A of the reel 401, and accordingly the signal from the touch panel 412 is inputted, the CPU 106 rewrites the plurality of selectable reels displayed on the sub display 40 that are stored in the RAM 110, the symbol groups disposed on each of the plurality of reels, the data related to the reel 401 from the symbol arrangement table, and the like. Then, the CPU causes the reels 401 to rotate in an up direction around the rotational axis. Similarly, when the player pushes the down-pointing arrow B of the reel 401, and accordingly the signal from the touch panel 412 is inputted, the CPU 106 rewrites the plurality of selectable reels displayed on the sub display 40 that are stored in the RAM 110, the symbol groups disposed on each of the plurality of reels, the data related to the reel 401 from the symbol arrangement table, and the like. Then, the CPU causes the reels 401 to rotate in a down direction around the rotational axis.

In Step S106, the CPU 106 determines whether or not a reel viewpoint changing instruction has been inputted. If the judgment result is “YES,” the processing advances to Step S107, and if it is “NO,” the processing advances to Step S108. More specifically, upon the button L or R on the touch panel 412 of the sub display 40 being pushed, and accordingly upon the signal from the touch panel 412 being input, the CPU 106 determines that the reel viewpoint changing instruction has been inputted, and the flow proceeds to Step S107. In a case where the CPU 106 determines that the reel viewpoint changing instruction has not been inputted, the flow proceeds to Step S108.

In Step S107, the CPU 106 changes a reel viewpoint of the sub display 40. More specifically, the CPU 106 determines whether the button L or R was pushed based on the signal inputted from the touch panel 412. In a case where the CPU 106 determines that the button L was pushed, the CPU 106 rewrites, for example, image data of the plurality of selectable reels displayed on the sub display 40 that is stored in the video RAM 154 based on image data stored in the image ROM 156 and, as shown in FIG. 8A-C, displays the image data 3-dimensionally from a point of view which is substantially 45 degrees diagonally backwards to the right from the display screen. Similarly, in a case where the CPU 106 determines that the button R has been pushed, the CPU 106 rewrites, for example, image data of the plurality of selectable reels displayed on the sub display 40 that is stored in the video RAM 154 based on image data stored in the image ROM 156 and, as shown in FIG. 8B-C, displays the image data 3-dimensionally from a point of view which is substantially 45 degrees diagonally backwards to the left from the display screen.

In Step S108, the CPU 106 determines whether or not a reel setting instruction has been inputted. If the judgment result is “YES,” the processing advances to Step S109, and if it is “NO,” the processing advances to Step S102. More specifically, upon the determination button G on the touch panel 412 of the sub display 40 being pushed, and accordingly upon the signal from the touch panel 412 being input, the CPU 106 determines that the reel setting instruction was inputted, and the flow proceeds to Step S109. In a case where the CPU 106 determines that the reel setting instruction has not been inputted, the flow proceeds to Step S102. In addition, when the player pushes the determination button G after pushing the selectable reel separately, the reel is highlighted, but the CPU 106 does not determine that the reel setting instruction has been inputted, and moves the processing to Step S102. The reel highlighted remains the same location on the selection display screen even when the arrow C or D is pushed. As described above, the plurality of selectable reels 401 to 410 as shown in FIG. 12B-C are stored in the RAM 110 in a way that each reel is adjacent each other. However, the highlighted reel is moved outside from the circle of the selectable reels until the determination button G is pushed again. Thus, by pushing the arrow C or D while a specific reel is highlighted, the arrangement of the plurality of reels 401 to 410, which are arranged adjacent to each other and stored in the RAM 110 as well as the symbol arrangement table, can be changed.

In Step S109, the CPU 106 displays the reel selected on the main display 30. More specifically, the CPU 106 rewrites, for example, image data of the plurality of selectable reels displayed on the sub display 40 and the main display 30 that is stored in the video RAM 154 based on image data stored in the image ROM 156, and executes the following rendered effects. Firstly, as shown in FIG. 17A-C, the reels 401A and 407S at both ends among the selectable reel groups 401S to 407S are darkened, and the reel groups 402S to 406S, which are located at the center, are highlighted as the reels that are set. Next, the reel groups 402S to 406S located at the center are displayed to be enlarged, as shown in FIG. 17B-C. In addition, the image of the reel groups 402S to 406S are moved in a down direction, as shown in FIG. 17C-C. Then, the image of the reel groups 402S to 406S are moved from the sub display 40 to the main display 30, and displayed solely on the main display 30, as shown in FIG. 17D-C. In addition, the CPU 106 rewrites the plurality of reels stored in the RAM 110 and displayed on the main display 30, symbol groups disposed on each of the plurality of reels, a symbol arrangement table, and the like. The CPU 106 moves the processing to Step S110.

In Step S110, rendered effects are displayed on the sub display 40. More specifically, after the CPU 106 rewrites the plurality of reels displayed on the main display 30 that are stored in the RAM 110 and data related to the symbol groups disposed on each of the plurality of reels to data corresponding to the reel groups 402S to 406S, as shown in FIG. 18-C the CPU 106 rewrites image data displayed on the main display 30 that is stored in the video RAM 154 and displays the reel groups 402S to 406S thus selected as a game screen. In addition, the CPU 106 displays rendered effects corresponding to the reel groups selected on the sub display 40 based on the rendered effects stored in the image data ROM 156. In the present embodiment, as shown in FIG. 18-C, since the player selected the reel group which includes relatively many bonus symbols and wild symbols, the rendered image displayed on the sub display 40 shows a message for trying to look for a bonus. Thus, it is preferred that data for the rendered effects stored in the image data ROM 156 is selected in relation to each reel group that the player selects. Alternatively, data for the rendered effects stored in the image data ROM 156 may be associated with each reel group that the player selects, respectively. Thus, since the player can reflect the player's will on the reels and symbols used in games, it can increase the player's interest in game playing.

In each case in which a winning combination is executed the player tends to be highly interested in symbols which are not displayed. Thus, according to the gaming machine 15 of the present embodiment, since after symbols are rearranged and a winning determination is executed, the reel selection display screen is displayed on the sub display 40, i.e. the symbols rearranged on the opposite side of the reels, which are not shown on the main display 30, are displayed on the sub display 40, a player's interest can be rewarded. On the other hand, in a case where symbols arranged outside an active area for providing an award can be visually recognized, it is possible that the player will continue the game if the combination of symbols currently displayed in an award winning area is close to any one of specified combinations for providing an award, and it is possible that the player will hesitate to continue the game if the combination of symbols currently displayed in an award winning area is far from any one of specified combinations for providing an award. Therefore, in the present embodiment, the opposite side of a reel used in a current game can be visually recognized according to a player's operation. Moreover, reels can be replaced if necessary. Consequently, since the player can reflect the player's will on the reels and symbols used in the game, the player's interest in game playing can be increased. In addition, according to the gaming machine 15 of the present invention, since reels are displayed in 3-D, which can add various rendered effects on the symbols displayed on the reels, it can provide more surprises and greater fun.

In the present embodiment, although it is described that the number of selectable reels displayed on the reel selection display screen is greater than that of reels displayed on the game screen during a game, any number of the selectable reels displayed on the reel selection display screen may be acceptable as long as the number thereof is appropriate while selecting a reel. For example, the number may be the same as that of reels displayed on the game screen.

In addition, in the present embodiment, although a predetermined number of reels is displayed on the reel selection display screen, a plurality of reel groups available during a game may be displayed on the reel selection display screen.

Thus, according to the gaming machine 15 of the present embodiment, since a reel selection display screen is displayed on the sub display 40 and the player can select a reel group used in the games so as to reflect the player's will on the reel groups and symbols used in the games, it can increase the player's interest in game playing. In addition, according to the gaming machine 15 of the present invention, since reels are displayed in 3-D, which can add various rendered effects on the symbols displayed on the reels, it can provide more surprises and greater fun. In addition, it can perform rendering that enhances amusement properties in bonus games, which have a higher payout ratio of coins and the like than a so-called basic game. In addition, although a bonus symbol and a wild symbol are described as specific symbols, in the present invention, any symbol that a player aims to acquire on a reel such as “TREASURE BOX” and the like may be a specific symbol, and a bonus symbol and/or a wild symbol may not be necessarily included therewith.

In addition, in the gaming machine 15 of the abovementioned embodiments, although the main display 30 is disposed above the sub display 40, the main display 30 may be disposed below the sub display 40. Although the touch panel is provided as an input device, this is not limited thereto and, for example, a selection input-only button may be provided.

What is claimed is:

1. A gaming machine, comprising:
a memory for storing image data of a plurality of reels each having a plurality of symbols arranged thereon;
a display for displaying the image data of a plurality of reels stored in the memory;
an instruction input device for causing the outside to select one or more of the plurality of reels displayed by using the image data of the plurality of reels stored in the memory; and
a controller for, by using the image data of the plurality of reels selected by the instruction input device, carrying out a slot game.

2. A gaming machine, comprising:
a memory for storing image data of a plurality of reels each having a plurality of symbols arranged thereon;
a first display for displaying a first reel group by using part of the image data of the plurality of reels stored in the memory, said first reel group being selectable;
a second display for displaying a second reel group used in a game by using part of the image data of the plurality of reels stored in the memory;
an instruction input device for inputting an instruction from a player; and
a controller for, by using the image data of the plurality of reels stored in the memory, carrying out the following processing of:
(a) displaying the first reel group on the first display;
(b) judging whether a reel replacement instruction has been inputted by the instruction input device;
(c) replacing at least some reels of the first reel group displayed on the first display with other reels by using the image data of the plurality of reels stored in the memory if it is judged that the reel replacement instruction has been inputted by the instruction input device;
(d) setting, in response to a setting instruction inputted through the instruction input device, as the second reel group, at least some reels of the first reel group displayed on the first display; and
(e) displaying, as the second reel group, at least some reels of the first reel group displayed on the first display set in the processing (d), on the second display, and entering into a game.

3. A gaming machine comprising:
a memory for storing image data of a plurality of reels each having a plurality of symbols arranged thereon;
a main display for displaying a predetermined number of reels used in a game by using part of the image data of the plurality of reels stored in the memory;
a sub display for displaying images;
an instruction input device for inputting an instruction from a player; and
a controller for executing the following processing by using the image data of the plurality of reels stored in the memory:
(a) generating, in response to a game start signal inputted from the instruction input device, to produce images indicative of the rotation display of the predetermined number of reels and displaying the predetermined number of reels rotating on the main display based on the images thus produced;
(b) automatically stopping the predetermined number of reels from rotating, and rearranging a plurality of kinds of symbols displayed on the predetermined number of reels on a display region of the main display;
(c) judging whether a combination of symbols rearranged and displayed in an award winning area on the main display matches any one of specified combinations for providing an award;
(d) displaying on the sub display at least symbols not displayed on the main display when the plurality of symbols of the plurality of reels are rearranged and partly displayed in a display region on the main display in the processing (b);
(e) reading, in response to an input signal from the instruction input device, which instructs a change o(f the predetermined number of reels to be displayed on the display region of the main display, image data indicative of one or more reels each having a plurality of symbols different in symbol arrangements from any one of the predetermined number of reels currently displayed on the display region on the main display, and displaying the one or more reels in a display region of the sub display as a replaceable reel group based on the image data thus read;
(f) replacing, in response to an input signal from the instruction input device, which instructs a change to the replaceable reel group displayed on the sub display, the predetermined number of reels in the display area on the main display with the replaceable reel group; and
(g) starting, in response to a game start signal inputted from the instruction input device, a next game with a predetermined number of reels thus replaced by the replaceable reel group.

4. A gaming machine comprising:
a memory for storing image data of a plurality of reels each having a plurality of symbols arranged thereon;
a first display for displaying a first reel group by using part of the image data of the plurality of reels stored in the memory, the first reel group being selectable;
a second display for displaying a second reel group used in a game by using part of the image data of the plurality of reels stored in the memory;
an instruction input device for inputting an instruction from a player; and
a controller for executing the following processing by using the image data of the plurality of reels stored in the memory:
(a) judging, in a basic game, whether a combination of symbols displayed on the second display corresponds to a predetermined combination representing a winning of the game;
(b) starting a second game when it is judged that the combination of symbols displayed on the second display corresponds to the predetermined combination representing the winning of the game;
(c) displaying on the first display, in the second game, a predetermined number of reels including at least two kinds of reels, one of which is a reel displaying a predetermined number of one of two specific symbols consisting of a bonus symbol promising a high payout and a wild symbol serving a almighty symbol playing roles of other symbols and the other of which is a reel displaying a predetermined number of the bonus symbol and the wild symbol, so that one of the number and the kind or both of the number and the kind of the two specific symbols displayed on the respective reels are visible by using the image data of the plurality of reels stored in the memory;
(d) judging whether a reel replacement instruction has been inputted through the instruction input device;
(e) replacing at least some reels of the first reel group displayed on the first display with other reels by using the image data of the plurality of reels stored in the memory if it is judged that the reel replacement instruction has been inputted by the instruction input device;
(f) setting, in response to a setting instruction inputted through the instruction input device, as the second reel group, at least some reels of the first reel group displayed on the first display; and
(g) displaying, as the second reel group, at least some reels of the first reel group displayed on the first display set in the processing (f), on the second display, and entering into a game.
